(19) United States
(12) Patent Application Publication
(10) Pub. No.: US 2026/0187928 A1
(43) Pub. Date: Jul. 2, 2026

(54) ACCELERATED RENDERING USING PRECOMPUTED COMPRESSED MEMORY BLOCK LAYOUTS

(71) Applicant: NVIDIA CORPORATION, Santa Clara, CA (US)

(72) Inventors: Eric Alan Haines, Somerville, MA (US); David Augustus Hart, Salt Lake City, UT (US); Eric Enderton, Berkeley, CA (US); Steven Parker, Draper, UT (US); Jesse Dylan Lacewell, Fremont, CA (US); Manuel Kraemer, San Jose, CA (US); Eleni Vasiou Sivvopoulou, Salt Lake City, UT (US)

(21) Appl. No.: 19/082,274

(22) Filed: Mar. 18, 2025

Related U.S. Application Data
(63) Continuation of application No. 19/082,261, filed on Mar. 18, 2025.

(30) Foreign Application Priority Data
Jan. 2, 2025 (GR) 20250100001

(51) Int. Cl. G06T 17/20; G06T 15/00; G06T 17/00

(52) U.S. Cl. CPC G06T 17/20; G06T 15/005; G06T 17/005; G06T 2210/12; G06T 2210/52

(57) ABSTRACT

In various examples, optimized cluster templates (e.g., template triblock data, template CLASes or some portion thereof such as template range data, etc.) are precomputed for various patterns of triangle clusters (e.g., regular grids and/or irregular meshes of various edge resolutions) and corresponding compression levels. For example, optimized triblock layouts may be computed for triangle patterns with designated parameters by iteratively generating candidate triblock layouts using different strategies, evaluating each candidate triblock layout using a designated metric (e.g., minimizing the number of triblocks used, rotating triblock patterns to a variety of angles and averaging their axis-aligned bounding box (AABB) areas), and tracking the best (e.g., optimized) triblock layout (or top N) for each pattern. As such, a triblock layout may be iteratively optimized for each supported pattern of triangles and corresponding compression level, and may be used to generate a corresponding cluster template.

### CROSS-REFERENCE TO RELATED APPLICATIONS

This application is a continuation of and claims priority from U.S. application Ser. No. 19/082,261, filed Mar. 18, 2025, which claims priority to Greek application No. 20250100001, filed on Jan. 2, 2025. The contents of each of the foregoing applications are hereby incorporated by reference in their entirety.

### BACKGROUND

Ray tracing is a rendering technique that simulates the way light interacts with objects in a scene to produce highly realistic lighting, shadows, and reflections. It traces the paths of rays as they travel through a three-dimensional (3D) space, checking for intersections with objects to determine how light behaves.

A Ray Tracing Texel eXtreme (RTX) graphics processing unit (GPU) is a type of GPU designed by NVIDIA to accelerate real-time ray tracing and artificial intelligence (AI) operations, such as those used in gaming, 3D rendering, and scientific simulations. Processors like GPUs typically include different types of hardware processing units or cores that can independently execute instructions. The NVIDIA ray tracing (RT) core (also referred to as a tree-traversal unit (TTU)) is a special function sub-unit of the RTX GPUs that accelerates ray tracing on fixed-function hardware by performing ray intersection tests on acceleration data structures (also known as acceleration structures) that represent the geometry of a 3D scene. For example, the geometry in a scene may be processed into a hierarchical tree data structure such as a bounding volume hierarchy (BVH) that organizes primitives, objects, or other parts of scene into a hierarchy of bounding volumes such as nested axis-aligned bounding boxes (AABBs). Given a 3D ray in space, intersections between the ray and the geometry in a 3D scene may be identified by traversing the BVH and testing bounding volumes for intersections with the ray. As such, this acceleration structure may be used to facilitate efficient spatial queries such as collision detection or ray-object intersection tests by progressively narrowing down the areas in space that need to be checked.

In an example BVH format, the root node identifies a bounding volume that encloses all the primitives in the hierarchy (e.g., all the primitives in the entire scene). Each intermediate or interior node may identify a bounding volume that encloses a corresponding branch or treelet in the hierarchy, and each leaf or terminal node may identify a bounding volume that encloses a corresponding set or range of primitives. The intermediate or interior nodes may be referred to as compressed treelets (or “complets” for short), and the leaf or terminal nodes may be referred to as ranges. These ranges may represent the actual geometry or primitive data that will be intersected by the ray (e.g., triangles or custom primitives). The primitives may be stored contiguously in blocks of memory (called triangle blocks or “triblocks” for short when storing triangles), and these memory blocks may be sized to correspond to a single cache line (the smallest unit of data the processor cache can load from the main memory at once, e.g., 128 bytes). As such, the data stored in memory blocks may be used to perform hardware-accelerated intersection tests for supported types of hardware-enabled geometric primitives (e.g., triangles; linear, surface, and spline (LSS) primitives), or may be used to identify and pass custom primitives for testing using an intersection function written in GPU-accelerated computing (e.g., Compute Unified Device Architecture (CUDA)) software on general-purpose hardware (e.g., a streaming multiprocessor (SM) of a CUDA core).

In a typical example, a BVH traversal begins by checking for ray intersections with the bounding volume in the root node, which may represent the entire scene. If there is an intersection, the traversal proceeds down the tree through child complets, checking their bounding volumes in turn. When a traversal reaches a range, the hardware performs the intersection test between the ray and the geometry inside the range (e.g., triangles stored in triblocks). If the ray intersects with the geometry, that part of the scene is considered hit, and shading and lighting effects may be calculated based on the intersection. Example applications that use BVH traversals include video games, real-time rendering engines, physics simulations, computer aided design (CAD) software, architectural visualization tools, film industry rendering, robotics simulations, and virtual reality (VR) environments.

BVHs are typically built during scene or model loading in real-time applications like video games or simulations, where one of the goals is usually to optimize performance by reducing the number of intersection tests required. However, it may be desirable to support building a BVH dynamically during rendering. For example, in dynamic scenes (e.g., with moving characters and/or viewpoints, deformable objects, destructible environments, real-time physics simulations), new BVHs may be needed to reflect changes in the scene. Some content developers may want to build new BVHs every frame to support rendering millions of animated triangles per frame in real time. However, building a BVH for ray tracing over a set of triangle meshes (e.g., that represent the surface of a more complex 3D object) is costly enough that it is often the bottleneck for games and real-time scenarios, especially for modern scenes that can include millions or even hundreds of millions of unique triangles. As a result, conventional techniques for building BVHs are substantially too slow to support the desired frame rate (e.g., on the order of 100 times too slow).

Accordingly, there is a need for improved techniques to support faster ray tracing and rendering.

### SUMMARY

Embodiments of the present disclosure relate to precomputing acceleration structures of triangle clusters such as optimized memory block layouts or node assignments, accelerated rendering using the precomputed acceleration structures, transcoding into precomputed memory block layouts, and/or an interface for accelerated rendering using the precomputed acceleration structures.

In some embodiments, an application running on a host (e.g., a CPU) may use tessellation to subdivide surfaces into small triangles to create smoother surfaces for rendering, use the tessellation process to identify clusters of triangles that form supported patterns, and issue command(s) for a device (e.g., a GPU) to build BVH-subtrees over corresponding clusters of triangles using precomputed cluster templates (e.g., indicating how to partition or group the triangles or triangle vertices in a supported pattern of triangles into corresponding triblocks and/or ranges). Precomputing cluster templates for corresponding BVH sub-trees over clusters of common or anticipated triangle configurations and using the cluster templates (e.g., instead of partitioning or grouping the triangles and/or generating corresponding triblock and/or range data) during the online BVH build process lowers the computational complexity and reduces the amount of work needed during the BVH build. As such, the application may issue command(s) for the device to build a BVH (e.g., a bottom-level acceleration structure (BLAS), a top-level acceleration structure (TLAS), etc.) over these BVH sub-trees, and perform ray tracing and render each frame using the BVH.

In some embodiments, a supported pattern of triangles may be associated with multiple cluster templates that represent optimized triblock layouts with different levels of compression. In some embodiments, the application may specify an applicable compression level for a cluster of triangles (e.g., the number of unique bits used to represent the vertex positions, the number of truncated or discarded bits used to compress the vertex positions), or the device may identify one (e.g., by inspecting the vertex positions on the fly). As such, the device may look up a set of cluster templates associated with a specified pattern of triangles, identify the cluster template associated with the applicable compression level (e.g., by looking up a template index by number of unique or discarded bits, sequentially testing successively more compressed triblock layouts to identify the most compressed triblock layout that would be able to fit the vertex positions using an identified level of compression, etc.), and copy that cluster template into allocated memory for the cluster. As such, the device may copy or transcode the vertex positions in the cluster into a precomputed triblock layout represented by the cluster template, and build BVH-subtrees over the cluster of triangles using a precomputed range assignment represented by the cluster template.

In some embodiments, the device may be associated with an application programming interface (API) (e.g., an API of the driver, firmware, or other hardware interface software associated with the device) which the application may use to manage or control generation of BVHs (CLASes) over clusters of triangles. For example, the application may issue a first type of API call that identifies a supported pattern of triangles (e.g., using an ID number or tag describing the pattern), and the API (or some other component of the hardware interface software) may look up and return a corresponding identifier for a set of one or more cluster templates associated with that pattern and an anticipated or maximum memory size or cache lines needed for that cluster of triangles. As such, the application may allocate the (e.g., maximum) memory size or cache lines needed for that cluster of triangles (e.g., by issuing a command for the device to create a buffer of that size using a corresponding API), and the application may issue a second type of API call that includes the identifier for the applicable cluster template (or set of cluster templates), a list of vertex positions in the cluster, a reference or pointer to the location of the allocated memory for the cluster, and (optionally) a representation of the compression level of the vertex positions. Accordingly, the device may look up the applicable cluster template, copy the cluster template into the allocated memory (e.g., instantiate the cluster with a precomputed triblock layout and/or precomputed range assignment), copy the vertex positions into the precomputed triblock layout in the allocated memory, and write one or more parent nodes forming a BVH-sub-tree (which may eventually serve as complets or intermediary nodes in a BVH such as a BLAS or TLAS) over the precomputed ranges in the allocated memory.

In some embodiments, an offline precomputation phase may be performed to precompute optimized cluster templates (e.g., template triblock data, template CLASes or some portion thereof such as template range data, etc.) for various patterns of clusters (e.g., regular grids and/or irregular meshes of various edge resolutions) and corresponding compression levels. For each supported pattern of micro-triangles (e.g., an 11×11 rectangular grid of quads) and corresponding compression level, the precomputation phase may include a (e.g., first) phase that solves for a partitioning or grouping of the triangles in the pattern into an optimized layout of triblocks, and a (e.g., second) phase that solves for a partitioning or grouping of the triangles in the pattern into an optimized range assignment.

In some embodiments, optimized triblock layouts may be computed for triangle patterns with designated parameters by iteratively generating candidate triblock layouts using different strategies, evaluating each candidate triblock layout using a designated metric (e.g., minimizing the number of triblocks used, rotating triblock patterns to a variety of angles and averaging their axis-aligned bounding box (AABB) areas), and tracking the best (e.g., optimized) triblock layout (or top N) for each pattern. In some embodiments, an optimized triblock layout for each supported pattern and compression level may be used to generate a corresponding optimized range assignment indicating how to partition or group the triangles represented by the pattern into corresponding ranges. Range assignments may be computed by iteratively generating candidate range assignments using different strategies, evaluating each range assignment using a designated metric (e.g., a cost that estimates, models, approximates, or otherwise quantifies the anticipated time cost of traversal), and tracking the best (e.g., optimized) range assignment (or top N) for each optimized triblock layout. As such, a triblock layout and/or range assignment may be iteratively optimized for each supported pattern of triangles and corresponding compression level, and may be used to generate a corresponding cluster template.

Accordingly, the techniques described herein may be used to build BVH sub-trees (CLASes) for any number of clusters of triangles (e.g., over the whole scene, some portion of a scene, some mesh, etc.). Using precomputing cluster templates instead of building the BVH sub-trees over those clusters online eliminates online sorting, substantially accelerating BVH builds.

### BRIEF DESCRIPTION OF THE DRAWINGS

The present systems and methods for precomputing acceleration structures such as optimized memory block layouts or node assignments for triangle clusters, accelerated rendering using the precomputed acceleration structures (e.g., compressed memory block layouts), and/or an interface for accelerated rendering using the precomputed acceleration structures are described in detail below with reference to the attached drawing figures, wherein:

FIG. 1 is a block diagram of an example ray tracing pipeline, in accordance with some embodiments of the present disclosure;

FIG. 2 illustrates some example regular grids and irregular meshes, in accordance with some embodiments of the present disclosure;

FIG. 3 illustrates some example triangle patterns, in accordance with some embodiments of the present disclosure;

FIG. 4 illustrates an example hierarchical tree structure, in accordance with some embodiments of the present disclosure;

FIG. 5 illustrates some example triangle block patterns, in accordance with some embodiments of the present disclosure;

FIG. 6 illustrates some example techniques for evaluating triangle block layouts patterns, in accordance with some embodiments of the present disclosure;

FIG. 7 illustrates an example technique for partitioning a triangle pattern representing a regular grid into a triangle block layout, in accordance with some embodiments of the present disclosure;

FIG. 8 illustrates some example triangle block layouts for some example regular grids, in accordance with some embodiments of the present disclosure;

FIG. 9 illustrates example techniques for shifting and swapping triangles in a triangle block layout, in accordance with some embodiments of the present disclosure;

FIGS. 10A-10H illustrate an example technique for partitioning a triangle pattern representing an irregular mesh into a triangle block layout, in accordance with some embodiments of the present disclosure;

FIG. 11 illustrates an example technique for favor filling crevices while partitioning a triangle pattern, in accordance with some embodiments of the present disclosure;

FIG. 12 illustrates an example technique for shifting triangles to remove crevices in a triangle block layout, in accordance with some embodiments of the present disclosure;

FIGS. 13A-13C an example technique for recursively growing triangle blocks in a triangle block layout, in accordance with some embodiments of the present disclosure;

FIG. 14 illustrates an example triangle block ordering, in accordance with some embodiments of the present disclosure;

FIG. 15 illustrates example triangle orderings, in accordance with some embodiments of the present disclosure;

FIG. 16 illustrates an example range assignment when the number of triangle blocks is less than the number of available ranges, in accordance with some embodiments of the present disclosure;

FIG. 17 illustrates an example range assignment for a rectangular grid when the number of triangle blocks is greater than the number of available ranges, in accordance with some embodiments of the present disclosure;

FIG. 18 illustrates an example range assignment for a triangular grid, in accordance with some embodiments of the present disclosure;

FIG. 19 illustrates an example cluster template, in accordance with some embodiments of the present disclosure;

FIG. 20 is a flow diagram illustrating a method of generating one or more hierarchical tree structures based at least on one or more precomputed acceleration structures associated with the one or more clusters of triangles, in accordance with some embodiments of the present disclosure;

FIG. 21 is a flow diagram illustrating a method of generating one or more hierarchical tree structures based at least on one or more precomputed memory block layouts identified based at least on one or more compression levels, in accordance with some embodiments of the present disclosure;

FIG. 22 is a flow diagram illustrating a method of generating one or more hierarchical tree structures based at least on one or more API calls that identify one or more precomputed cluster templates, in accordance with some embodiments of the present disclosure;

FIG. 23 is a flow diagram illustrating a method of generating one or more optimized memory block layouts, in accordance with some embodiments of the present disclosure;

FIG. 24 is a flow diagram illustrating a method of generating one or more optimized node assignments, in accordance with some embodiments of the present disclosure;

FIG. 25 illustrates a parallel processing unit, in accordance with some embodiments of the present disclosure;

FIG. 26A illustrates a general processing cluster within the parallel processing unit of FIG. 25, in accordance with some embodiments of the present disclosure;

FIG. 26B illustrates a memory partition unit of the parallel processing unit of FIG. 25, in accordance with some embodiments of the present disclosure;

FIG. 27A illustrates the streaming multi-processor of FIG. 26A, in accordance with some embodiments of the present disclosure;

FIG. 27B is a conceptual diagram of a processing system implemented using the PPU of FIG. 25, in accordance with some embodiments of the present disclosure;

FIG. 27C illustrates an example system in which the processing system of FIG. 27B may be implemented, in accordance with some embodiments of the present disclosure;

FIG. 28 is a block diagram of an example computing device suitable for use in implementing some embodiments of the present disclosure; and

FIG. 29 is a block diagram of an example data center suitable for use in implementing some embodiments of the present disclosure.

### DETAILED DESCRIPTION

Systems and methods are disclosed related to precomputing acceleration structures such as optimized memory block layouts or node assignments for triangle clusters, accelerated rendering using the precomputed acceleration structures (e.g., compressed memory block layouts), and/or an interface for accelerated rendering using the precomputed acceleration structures. For example, optimized memory block layouts and portions (e.g., range assignments) of a hierarchical tree data structure (e.g., a BVH) representing supported patterns of clusters of triangles in a scene may be precomputed offline and used to dramatically accelerate online BVH build speeds.

In some embodiments, BVHs may be built over clusters of common or anticipated triangle configurations. Clusters may be formed by spatially grouping triangles into regular grids (e.g., a subdivision of a simple shape like a rectangle or triangle into a pattern of tiled micro-triangles) or irregular meshes (e.g., an arbitrary or ad-hoc grouping of micro-triangles with no simple or predefined structure to the group). Precomputing cluster templates (e.g., representing a partitioning or grouping of the triangles or triangle vertices in a particular cluster into corresponding triblocks and/or ranges) for corresponding BVH sub-trees over clusters of common or anticipated triangle configurations and using the cluster templates (e.g., instead of partitioning or grouping the triangles and/or generating corresponding triblock and/or range data) during the online BVH build process lowers the computational complexity and reduces the amount of work needed during the BVH build. A BVH over the set of triangles in a single cluster may be referred to as CLuster Acceleration Structure (CLAS). Taking an example cluster of 100 triangles, precomputing a CLAS over that cluster results in approximately 100 times less work for the BVH builder to consider a single cluster than to handle the 100 individual triangles.

Taking an example rectangular or triangular grid of micro-triangles and using and a consistent triangle and vertex order within the cluster, a precomputed CLAS over this example cluster of micro-triangles may be reused as a template during the BVH build for any other cluster with the same pattern of micro-triangles (e.g., same shape and number of micro-triangles) and compression level. Since the surface modeled by a single cluster of triangles (e.g., a small subdivision of a subdivision surface) is likely to be very small, idealized two-dimensional (2D) cluster patterns (e.g., regular 2D grids, irregular 2D meshes) may be used to precompute corresponding cluster templates (e.g., template CLASes), and the precomputed cluster template may be applied to any mesh (e.g., whether 2D or 3D) that matches the topology of a corresponding cluster pattern to model some or all of the scene. With a limited number of supported patterns and a large number of clusters in a typical scene, there will often be a very high degree of reuse, which substantially speeds up the BVH build for the scene.

In some embodiments, an offline precomputation phase may be performed to precompute optimized cluster templates (e.g., template triblock data, template CLASes or some portion thereof such as template range data, etc.) for various patterns of clusters (e.g., regular grids and/or irregular meshes of various edge resolutions), or pairs of patterns and corresponding compression levels. For example, an optimization strategy may seek to maximize traversal speed by increasing vertex reuse within triblocks, minimizing the surface area of bounding volumes of ranges, minimizing the number of triblocks in a cluster, and/or otherwise. In some embodiments, the optimization strategy may be tailored to the architecture of the processor that will be performing the ray tracing. For example, some processor architectures may be optimized for triangle ranges containing a designated number of triangles (e.g., two, four, eight, etc.). In some implementations, ranges may be allowed to span triblock boundaries (e.g., an individual range may represent triangles that occupy multiple triblocks in memory), although loading multiple triangle blocks during traversal may negatively impact performance, so there may be incentive to limit ranges to a single triblock in certain circumstances. Some processors may require triangle ranges that span a triblock boundary to only span triblocks that are consecutive in memory, may require all triangles in a range to be consecutive in memory, or may support (e.g., lossless) compression of the vertex coordinates. These are just a few examples of possible constraints, and others may be implemented within the scope of the present disclosure.

In some embodiments, the precomputation phase may generate optimized cluster templates for patterns of triangle clusters (e.g., regular rectangular or triangular grids, irregular triangular meshes) with a variety of edge resolutions (e.g., all possible edge resolutions up to a designated maximum edge resolution) or other types of meshes (e.g., objects like a shark, a blade of grass, a coffee cup, etc.—with or without exterior edges) and a variety of compression levels. The maximum edge resolution may be selected to balance performance gains against memory usage and diminishing returns from oversized clusters. By way of nonlimiting example, a single cluster may be limited to some number of triangles (e.g., 256 triangles), which supports a rectangular grid of quadrilaterals (with 2 triangles per “quad”) with a maximum edge resolution of 11×11 quads.

For each supported pattern of micro-triangles (e.g., an 11×11 rectangular grid of quads) and corresponding compression level, the precomputation phase may include a (e.g., first) phase that solves for a partitioning or grouping of the triangles in the pattern into an optimized layout of triblocks, and a (e.g., second) phase that solves for a partitioning or grouping of the triangles in the pattern into an optimized range assignment. In some embodiments, the partitioning is independent of the locations of the vertices (e.g., to facilitate reuse anywhere in the scene), and the optimized triblock and/or range partitioning may be represented using list(s) of vertex indices (e.g., per-triblock lists, per-range lists) and/or locations of triblock and/or range boundaries or divisions in the list(s) of vertex indices.

Taking partitioning into an optimized layout of triblocks as an example, some embodiments may seek to minimize the number of triblocks used to store the triangles in a particular pattern of micro-triangles. The size of a triblock may correspond to size of cache line, so minimizing the number of triblocks for a particular pattern may serve to minimize the number of cache line loads and therefore speed up the traversal speed. The number of triangles that fit into a particular triblock may depend on various factors such as the size of the triblock (e.g., 128 bytes), the data format for storing the triangle data (e.g., the vertex position precision), a supported compression level, and/or the spatial arrangement of the triangles in the cluster. For example, adjacent triangles typically share vertices, so the additional data required to include an additional triangle in a block of memory may depend on how many edges the additional triangle shares with the triangle(s) that are already allocated to the block of memory.

As such, triblock layouts may be computed for triangle patterns with designated parameters such as edge resolutions, data formats, maximum number of triangles/vertices of a designated data format that fit into a triblock of a designated size, compression levels, and/or other parameters, for example, by iteratively generating candidate triblock layouts (e.g., sequentially filling up triblocks using a triangle ordering that keeps consecutive triangles spatially near each other; tiling regular grids with designated triblock shapes using symmetry and/or tessellation strategies; tiling irregular meshes by sequentially filling triblocks with random triangles, favoring isolated triangles with no unassigned neighbors, corner triangles with only one unassigned neighbor, or edge triangles with two unassigned neighbors; adjusting triangle assignments or triblock boundaries from previously generated triblock layouts, etc.), evaluating each layout using a designated metric (e.g., minimizing the number of triblocks used, rotating 2D triblock patterns to a variety of angles and averaging their axis-aligned bounding box (AABB) areas), and tracking the best (e.g., optimized) triblock layout (or top N) for each pattern. As such, some embodiments may generate an optimized triblock layout for each supported pattern of triangles.

Taking rectangular grids as an example, some embodiments may generate an optimized triblock layout for multiple (e.g., all possible) rectangular grid sizes (e.g., from 1×1 up to a maximum edge resolution such as 11×11), including non-square grid sizes (e.g., 3×8 or 9×7). By way of nonlimiting example, the precomputation phase may generate layouts for all possible rectangular grid sizes from 1×1 up to 11×11 including non-square grid sizes, resulting in different triblock layouts for 121 unique patterns for rectangular grids. Layouts may additionally or alternatively be generated for other types of cluster patterns (e.g., triangular grids, irregular triangular meshes, etc.).

In some embodiments, each supported pattern of triangles may be used to generate one or more optimized triblock layouts corresponding to a supported compression level for the vertex positions, such as triblock layout that can represent uncompressed vertex positions and one or more triblock layouts that are more compressed and use fewer triblocks. To generate triblock layouts that use fewer total triblocks than the uncompressed cluster (and more vertices per triblock than the uncompressed cluster), the precomputation phase may attempt to compute a triblock layout with other possible unique triblock counts (e.g., every possible unique triblock count though a designated maximum—such as a maximum of 16 vertices and/or 16 triangles per triblock—which may be imposed by the size of a memory block and/or the processor in which the data will be stored). For example, if the triblock layout for the uncompressed cluster of triangles uses 4 triblocks total and has 8 vertices per triblock, the precomputation phase may be able to compute a compressed triblock layout with 3 triblocks and 12 vertices per triblock, and an even more compressed triblock layout with 2 triblocks and 16 vertices per triblock. In this example, a triblock layout with 1 triblock would not be possible since the supported maximum of 16 vertices per triblock has already been achieved. As such, each supported pattern of triangles may be associated with one or more triblock layouts, which may be selected during the online BVH build based on how compressible the vertex positions in a corresponding cluster are (as explained in more detail below).

In some embodiments, each triblock layout (e.g., the top N optimized triblock layouts) for each supported pattern (e.g., and compression level) may be used to generate a corresponding partitioning or grouping of the triangles represented by the pattern into an optimized range assignment. Generally, the assignment of triangles to certain ranges (or leaf nodes) of a BVH can significantly influence the time it takes to traverse the BVH during ray intersection tests. The more efficiently the triangles in a cluster are grouped into spatially coherent leaf nodes, the faster unnecessary regions can be culled during traversal, reducing the number of nodes and triangles that need to be checked for intersection. The less efficiently the triangles are assigned to ranges (e.g., assigning triangles that span large or scattered areas to a single range or leaf node), the larger or more irregular the bounding volume that encloses them becomes, which forces traversal to test the dispersed triangles even if a ray only passes through a small part of the bounding volume, effectively increasing the number of bounding volume checks and subsequent ray-triangle intersection tests. Essentially, poor spatial coherence within a single range (e.g., scattered triangles represented by a single leaf node) leads to a more extensive traversal through the hierarchy and less efficient culling. As such, spatially compact range assignments should minimize traversal time and improve intersection performance.

To meet the objectives of minimized traversal time and improved intersection performance, one or more embodiments of the present disclosure include generating different types of candidate range assignments (as explained in more detail below), and evaluating candidate range assignments using a cost that estimates, models, approximates, or otherwise quantifies the anticipated time cost of traversal (e.g., the anticipated traversal time, how long it will take to render, etc.). For example, a cost for a candidate may be quantified based on estimates of the relative probability that the range is accessed (e.g., the ratio of the area of the triangles in the range to the area of the triangles in the cluster, averaged through some number of rotations to estimate or otherwise account for the average spatial coverage of the triangles and favor more rounded triangle ranges), the anticipated number of cache line loads needed to test the range (e.g., which may correspond to the number of triblocks used to store the triangles assigned to the range), the number of anticipated iterations in a ray intersection test on the triangles in the candidate range (e.g., which may be based on a hardware limit on the number of triangles that can be simultaneously tested per warp or thread group during a ray intersection test on that range, such that the number of anticipated iterations may correspond to an integer division of the number of triangles in a candidate range by the hardware limit on the number of triangles that can be simultaneously tested per warp or thread group), and/or otherwise. Other ways of assigning costs to candidate range assignments (e.g., by testing and measuring the traversal time of candidate range assignments for the triangles in a triblock layout) may be implemented within the scope of the present disclosure. As such, the cost of each range in a candidate range assignment may be quantified and summed over all ranges to generate a cost for that candidate range assignment.

A variety of techniques may be used to generate candidate range assignments for the triangles represented by a triblock layout. In some embodiments, the manner in which candidate range assignments are generated depends on the relationship between the number of triblocks in a triblock layout and the number of available or target ranges to fill (e.g., a designated maximum number of ranges (leaf nodes) for a BVH or CLAS over a cluster of triangles—or a designated maximum number of ranges supported by each complet (intermediate node) of a BVH—such as 10 or 12).

For example, if there are fewer triblocks than available ranges, a candidate range assignment may assign one triblock per range (assign the triangles represented by each triblock to a corresponding range), or may split the triangles represented by a triblock into multiple ranges. In some embodiments, a baseline candidate range assignment that assigns one triblock per range may be generated and evaluated (e.g., using a cost metric that quantifies the anticipated time cost of traversal), candidate modifications to the baseline candidate range assignment that split each triblock into all its possible groupings of two sets of triangles may be generated and evaluated (e.g., using the cost metric that quantifies the anticipated time cost of traversal), the cost of each candidate modification (representing a candidate split of a triblock) may be compared to the cost of the (unsplit) baseline candidate range assignment, and the candidate modification that maximizes the reduction in cost may be used as the (e.g., subsequent baseline) candidate range assignment. The process may be repeated to split multiple triblocks (e.g., until the number of triblocks in a range assignment equals the number of available ranges). In a nonlimiting example implementation, if there are 9 triblocks and 12 ranges, at most three triblocks may be split, if each split reduces that triblock's estimated time cost to test the triangles in separate ranges as opposed to in a single range. Some implementations may limit triblock splits to some designated maximum number of ranges (e.g., do not split individual triblocks into three or more ranges, in favor of keeping some empty ranges when there are more than twice as many triblocks as available ranges, which may serve to limit the number of cache line loads and therefore may encourage candidate range assignments that minimize or reduce traversal time). As such, various candidate range assignments may be generated and evaluated, and the optimized candidate range assignment that results in the lowest time cost (or measured time) may be identified and tracked over any number of iterations.

If there are the same number of triblocks in a triblock layout as there are available ranges, an optimized range assignment may be generated by assigning one triblock per range (assigning the triangles represented by each triblock in an optimized triblock layout to a corresponding range).

If there are more triblocks in a triblock layout than there are available ranges (e.g., meaning at least one range will span a triblock boundary, so some hardware may require that range to only span triblocks that are consecutive in memory), an optimized range assignment may be generated by creating an ordered list of triblocks, testing candidate range assignments that divide the ordered list of triblocks into ranges without splitting triblocks, and identifying and tracking an optimized range assignment that results in the lowest time cost (or measured time). The triblock ordering may be generated in various ways (e.g., using the order in which the triblocks were sequentially filled with triangles; generating candidate triblock merges, merging pairs of triblocks that minimize a cost that quantifies the spatial coverage such as the average surface area of axis-aligned bounding boxes of rotated triblock patterns)), and using the resulting order of triblocks sets, which favors triblocks in different ranges being next to each other; ordering triblocks along a path that approximates a spiral or that minimizes path traveled to the triblock centroids; ordering triblocks in an inwards or outwards spiral order; ordering triblocks in a scan line order; ordering triblocks according to a sequence defined by a space-filling curve; zigzagging; etc.). Taking a candidate triblock ordering for example, the ordered list of triblocks may be divided into ranges (without splitting triblocks) by iteratively generating and evaluating candidate range assignments that group neighboring pairs of triblocks in the ordered list (e.g., using a cost metric that quantifies the anticipated time cost of traversal), grouping neighboring triblocks that reduce or minimize the time cost, and tracking the optimized range assignment that results in the lowest time cost (or measured time) for the candidate triblock ordering.

In some embodiments, optimized range assignments may be adjusted (e.g., by shifting triblocks or individual triangles of triblocks from one range to another), and using adjusted range assignments that reduce the time cost (or measured time) as a corresponding optimized range assignment. As such, various candidate triblock orderings and candidate range assignments may be generated and evaluated, and the optimized candidate range assignment and triblock ordering that results in the lowest time cost (or measured time) may be identified and tracked over any number of iterations.

As such, a triblock layout and/or range assignment may be iteratively optimized for each supported pattern of triangles (e.g., rectangular grids of quads/right triangles, regular triangular grids of equilateral triangles, regular triangular grids of right triangles, irregular triangular grids of irregular triangles, any of the forgoing with multiple supported edge resolutions), or for each supported pattern paired with a corresponding supported compression level. The optimized triblock layout and/or range assignment for a supported pattern (e.g., and compression level) may be used to generate a corresponding cluster template for that pattern (e.g., and compression level). Generally, a cluster template may be represented in any suitable manner, and may include precomputed template triblock data. Template triblock data may include, for example and without limitation: a triblock header, a representation of the topology of the triangles in the cluster (such as an index buffer or ordered list of vertex indices that defines how the vertices in the triblock are connected to form triangles), an ordered list of vertex indices per triblock (or other representation of a partitioning of the triangles in the cluster to corresponding triblocks), the number of vertices used per triblock, the maximum memory size or number of triblocks or cache lines needed per cluster, etc.), a template CLAS or some portion thereof such as template range or tree data (e.g., an ordered list of vertex indices per range or other representation of a partitioning of the triangles in the cluster to corresponding ranges, backed tri-range data indicating the number of triangles in each range, etc.), and/or otherwise. In some embodiments, the cluster templates may be aggregated and stored in one or more lookup tables (“LUTs”), and may be indexed by an identifier or other representation of the pattern of triangles (e.g., an ID number, a tag describing the pattern such as “5×5 rectangular grid”) and optionally a representation of a corresponding compression level (e.g., the number of bits used to represent vertex positions, a quantification of the amount of bit reduction such the number of bits discarded or truncated during compression, etc.). The cluster templates may be packaged or bundled with a driver, firmware, or other hardware interface software associated with the processor (e.g., GPU) that will be performing the BVH build or ray tracing (e.g., baked or embedded directly into the driver's code as static data) and may be delivered and/or installed using any known technique. As such, the cluster template for a given pattern of triangles may be looked up and copied (e.g., when instantiating a triblock for the cluster of triangles). Baking the cluster templates for these patterns offline eliminates most or even all online triangle sorting.

For example, in some embodiments, an application (e.g., a video game, real-time rendering engine, physics simulation, CAD software, architectural visualization tool, film industry rendering, robotics simulation, AR or VR environment, etc.) running on a host (e.g., a CPU) may manage and update a 3D scene and issue commands to a device (e.g., a GPU) to render frames based on the 3D scene. Some real-time rendering applications use tessellation or mesh refinement techniques to generate clusters of regular grids or irregular meshes each frame in order to optimize performance or visual quality. For example, many tessellation processes used in computer graphics and animation break down surfaces into small triangles to create smoother surfaces for rendering. As such, these existing tessellation or mesh refinement techniques may be leveraged to identify the triangle clusters for a BVH build. Accordingly, the application may use (e.g., by executing, or by commanding the device to use) any suitable tessellation technique (e.g., uniform tessellation, adaptive tessellation, subdivision surfaces, etc.) to identify clusters of triangles that form supported patterns, and may issue command(s) for the device to build corresponding BVHs (e.g., CLASes) over these clusters of triangles using corresponding cluster templates. Using these precomputed cluster templates—and by leveraging existing techniques that already identify triangle clusters—the BVH build process no longer needs to sort the triangles within each cluster. As such, the application may issue command(s) for the device to build a BVH (e.g., a bottom-level acceleration structure (BLAS), a top-level acceleration structure (TLAS), etc.) over these CLASes, and perform ray tracing and render each frame using the BVH.

In an example implementation, the device may be associated with an application programming interface (API) (e.g., an API of the driver, firmware, or other hardware interface software associated with the device) which the application may use to manage or control generation of BVHs (CLASes) over clusters of triangles. For example, any known tessellation technique may be used to identify clusters of triangles in supported patterns, and taking an example supported pattern, the application may issue a first type of API call that identifies the supported pattern (e.g., using an ID number or tag describing the pattern), and the API (or some other component of the hardware interface software) may look up and return a corresponding identifier for a set of one or more cluster templates associated with that pattern and an anticipated or maximum memory size or cache lines needed for that cluster of triangles.

In some embodiments, any given supported pattern may be associated with multiple cluster templates suitable for different compression levels. As such, in some embodiments, the first type of API call identifies the supported pattern, and the API looks up or otherwise identifies and returns the maximum memory size or cache lines needed for any of the cluster templates associated with that pattern (e.g., the cluster template for uncompressed vertex positions). In some embodiments, the first type of API call may support an argument that identifies a representation of the compression level of the vertex positions for the cluster (e.g., the number of bits used to represent vertex positions, a quantification of the amount of bit reduction such the number of bits discarded or truncated during compression, etc.), and the API (or some other component of the hardware interface software) may use the compression level to lookup and return the memory size or cache lines needed for the cluster template for that compression level. In some embodiments, the first type of API call may support an argument that identifies a representation of a bounding box that encloses the cluster of triangles, and the API (or some other component of the hardware interface software) may use the bounding box to determine whether any bits may be discarded or truncated based on the position of the bounding box (e.g., sign or exponent bits may be discarded or truncated, for example, if the size of the bounding box is between zero and one). Accordingly, a corresponding minimum compression level may be identified, and the maximum memory size or cache lines needed for the cluster template for that compression level may be looked up and returned.

As such, the application may allocate the (e.g., maximum) memory size or cache lines needed for that cluster of triangles (e.g., by issuing a command for the device to create a buffer of that size using a corresponding API), and the application may issue a second type of API call that includes the identifier for the applicable cluster template (or set of cluster templates), a list of vertex positions in the cluster, a reference or pointer to the location of the allocated memory for the cluster, and (optionally) a representation of the compression level of the vertex positions. The API may pass these arguments to the device, and the device may look up the applicable cluster template, may copy the cluster template into the allocated memory (e.g., instantiate the cluster with a precomputed triblock layout and/or precomputed range assignment, for example, by copying template triblock data such as precomputed lists of vertex indices into corresponding triblocks, copying template range data such as precomputed ranges (leaf nodes) and/or corresponding precomputed lists of vertex indices into the allocated memory), may copy the vertex positions into the precomputed triblock layout in the allocated memory (e.g., mapping a designated vertex order such as a scan order to a predetermined order associated with the cluster template, transcoding using a designated compression level or a compression level determined from the vertex positions on the fly), and may write one or more parent nodes forming a CLAS (which may eventually serve as complets or intermediary nodes in a BVH such as a BLAS or TLAS) over the precomputed ranges in the allocated memory (e.g., computing and writing bounding boxes for each child (e.g., in parallel) using the cluster vertex positions and precomputed per-range lists of vertex indices, filling in a reference or pointer to each child and its bounding box, etc.).

In some embodiments (e.g., if the application does not provide a representation of the compression level), the device may determine an appropriate compression level for the cluster by examining the positions of the vertices in the cluster, may use the determined compression level to look up or otherwise identify and copy the appropriate cluster template for that compression level, and may use the determined compression level to transcode the vertex positions on the fly. Generally, the device may examine and compare all vertex positions in the cluster (e.g., in parallel) to discover how many bits are unique across the cluster. The number of unique bits may be calculated separately for each of the positional dimensions (e.g., x, y, z). Taking x-values as an example, x-values may be stored in binary form, often as floating-point numbers. For example, in 32-bit floating-point format, each x-value is represented by a 32-bit sequence that includes 1 sign bit (positive/negative), 8 exponent bits, and 23 mantissa (fraction) bits. If the x-values are stored in compressed formats, the bit pattern may be different (e.g., 16-bit floats, integers, or other encodings). In some embodiments, the device may inspect the x-values and identify whether and how many of the bits are identical (e.g., on either end of a floating-point number). For example, if the user has truncated their data (which squeezes bits from the mantissa end), the bottom N bits should all be zero. Bits on the top end of a float-point number may be identical when the range of x-values is constrained to a corresponding region in space (e.g., the sign bit should not change when the x-values in the cluster are all positive or negative, some exponent bits should not change when the x-values in the cluster fall within a relatively narrow range).

As such, the number of identical bits may be used to determine the corresponding number of unique bits for each positional dimension, which may be summed and used to determine the most compressed template triblock layout the vertex positions would fit into using that level of compression (e.g., the most compressed template triblock layout with a corresponding number of vertices per triblock that fit into a triblock using the identified number of unique bits). For example, the number of unique bits in the positions of the vertices in a cluster of triangles may be summed over the three positional dimensions to identify the number of bits needed to represent a vertex, may be multiplied by the number of vertices per triblock used by a template triblock layout associated with a corresponding pattern (e.g., and combined with the size of any applicable metadata) to derive the number of bits needed to store the vertex positions from that cluster in a single triblock using the identified compression level (e.g., number of unique bits, number of discarded or truncated bits, etc.). As such, the number of bits needed for a single triblock using the identified compression level may be compared to the number of bits available in a single triblock to determine whether the vertex positions would fit into the template triblock layout using that compression level (or the number of bits available in a single triblock may be divided by the number of bits needed to represent a vertex and compared to the number of vertices per triblock). There may be multiple cluster templates (with corresponding template triblock layouts) for different compression levels (e.g., indexed by some representation of the level of compression, such as number of triblocks, number of vertices/triangles per triblock, number of unique bits, number of discarded or truncated bits, etc.). For example, a supported pattern of triangles may be associated with a template triblock layout for uncompressed vertex positions (e.g., 32 bits for each dimension, 96 bits total, which may correspond to 9 triblocks) and a template triblock layout for one or more increased levels of compression (e.g., with 8 triblocks, 7 triblocks, etc.). In some embodiments, the cluster templates (template triblock layouts) for the different compression levels may be sequentially tested starting from least compressed (e.g., uncompressed), and sequentially testing successively more compressed triblock layouts to identify the most compressed triblock layout the vertex positions would fit into using an identified level of compression.

As such, the identified compression level for a cluster of triangles may be used to look up or otherwise identify and copy the appropriate cluster template for that compression level (and triangle pattern) into the allocated memory (e.g., instantiating the cluster with a precomputed triblock layout), and the vertex positions may be transcoded into the precomputed triblock layout using the identified compression level by discarding or truncating the non-unique (e.g., unused or redundant) bits (e.g., squeezing off outer bits down into the middle of the bit sequence).

As such, instead of the application simply sending the device a list of (e.g., millions of triangles) and the device (e.g., a BVH builder of a GPU) sorting the triangles and building a BVH over the all triangles, in some embodiments, the application sends the device some representation of clusters of (e.g., around 100) triangles in supported patterns and a representation of their topology (e.g., an identifier of the pattern such as 5×5 rectangular grid), and the device may use precomputed acceleration structures (cluster templates, template triblock data, template range data) to accelerate copying the vertex data to the device and building BVH sub-trees (CLASs) for the clusters. Generally, the cluster templates may represent a palette of optimized triblock layouts and/or range assignments for different patterns of triangle clusters (e.g., rectangular or triangular grids of triangles, irregular triangular meshes of triangles, different edge resolutions, etc.). As such, a precomputed cluster template for a designated pattern of a cluster of triangles may be identified, and a memory copy may be performed to copy the precomputed cluster template into the allocated memory blocks and then fill in the vertex positions identified by the application.

In some embodiments, the user allocates and writes their vertex positions into global memory, the (e.g., driver) API of the device may take as input a buffer of global memory of user data, and the device (e.g., CLAS build kernel) reads vertices from their global memory buffer and writes the data (e.g., in compressed form) into the triangle blocks. Additionally or alternatively, the API may allow the user tessellation code to be embedded inside and compiled into the device (e.g., CLAS build kernel). For example, each (e.g., CUDA) warp or thread group may invoke the user code to write the vertices for one cluster into shared memory, and then the native (e.g., driver) portion of the CLAS build kernel may take over and copy/transcode the vertex positions from shared memory into triangle blocks in global memory. This avoids the need to have the user write vertices into global memory before the CLAS build kernel runs. One benefit of this approach is avoiding the round trip to global memory (the process of reading data from global memory and writing data back to global memory). Another major benefit is that the user does not need to allocate a buffer for their uncompressed vertices at all, potentially saving a substantial amount of memory. This approach essentially allows users to write into driver-controlled memory on the device in a proprietary format that the users do not know. This is different from what graphics APIs normally do, which is take as input a buffer of global memory of user data (located off-chip), and then copy whatever is needed (on-chip). Since shared memory is localized to thread blocks and is like cache memory (which is much faster than global memory), it should substantially speed up the copy process compared to conventional techniques that rely on a round trip to global memory. Other variations are possible (e.g., in which the vertex data is handed off using registers rather than shared memory, which would be even more direct and avoid using either global or shared memory).

As such, the application may use the device to leverage precomputed cluster templates to accelerate a BVH subtree (CLAS) build over a specified cluster of triangles. There are a number of possible variations. For example, the application may make the first type of API call for a particular cluster of triangles and then make the second type of API call to build a CLAS over that cluster. In some embodiments, the application may identify a repeating pattern that applies to multiple clusters of triangles, and issue the second type of API call for each of those clusters. Additionally or alternatively, the application may issue the first type of API call any number of times to return identifiers for different types of supported patterns, and may issue the corresponding second type of API calls in any suitable order. In some embodiments, the application may provide a reference or pointer to the allocated memory for each cluster of triangles, or may provide a reference or pointer to an aggregate buffer for multiple clusters and the device may fill in the aggregate buffer and return references or pointers to the locations where each cluster is stored (e.g., and corresponding sizes). In some implementations, asynchronous command submission, command buffers, and/or parallel execution may be used to issue multiple commands to build multiple CLASes without waiting for the device to complete execution of a previous command. As such, the application may issue commands to lookup identifiers for cluster templates and/or to build different CLASes in parallel, and the device may process them concurrently or in a defined order (e.g., defined by a command buffer).

Accordingly, the techniques described herein may be used to build BVH sub-trees (CLASes) for any number of clusters of triangles (e.g., over the whole scene, some portion of a scene, some mesh, etc.). In some embodiments, once each cluster has a CLAS, the application may issue one or more commands for the device to build a BVH over some or all of the CLASes (e.g., for the whole scene, a portion of the scene, an individual mesh, etc.). Any known technique may be used to build a BVH (e.g., top-down, bottom-up) on top of a set of clusters identified by the application, but using the CLASes (computed during the previous step using precomputed cluster templates) at the bottom level of the BVH instead of building them online. The present techniques may be used to substantially accelerate BVH builds. For example, using precomputing cluster templates instead of building the BVH sub-trees over those clusters online eliminates online sorting. Sorting triangles generally follows an O (N log N) time complexity, where N is the number of triangles. Simplifying the relationship to linear for the sake of illustration, processing clusters that each have some average number of triangles such as 100, instead of processing all the triangles, should make the process that number of times faster (e.g., 100 times). For example, processing 10,000 clusters of 100 triangles each should reduce the complexity and speed up the process by a factor of about 100. As such, the present techniques may be used to support building new BVHs every frame to support rendering millions of animated triangles per frame in real time.

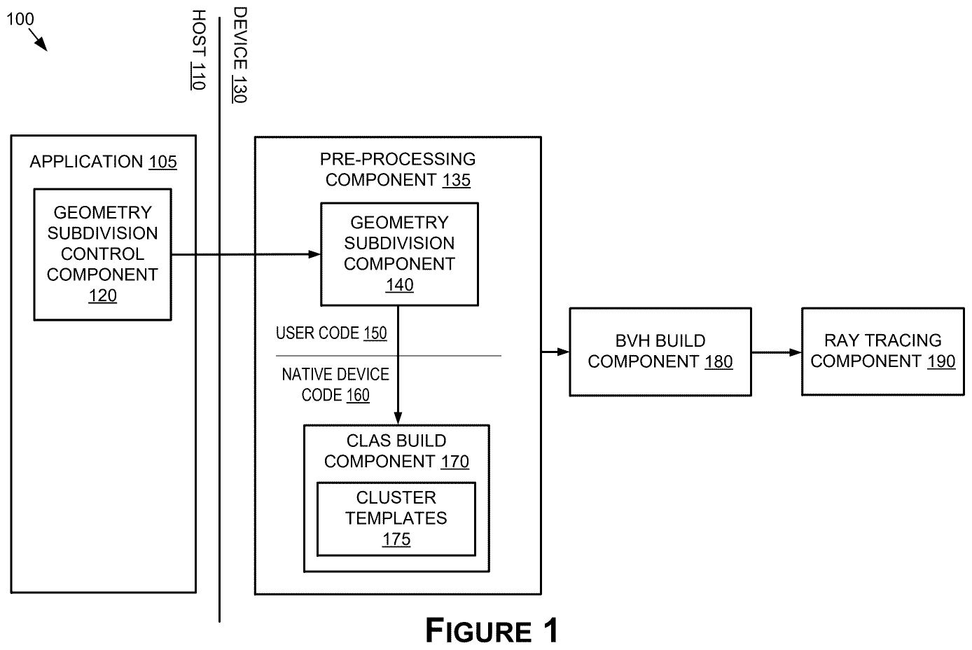

With reference to FIG. 1, FIG. 1 is an example ray tracing pipeline 100, in accordance with some embodiments of the present disclosure. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

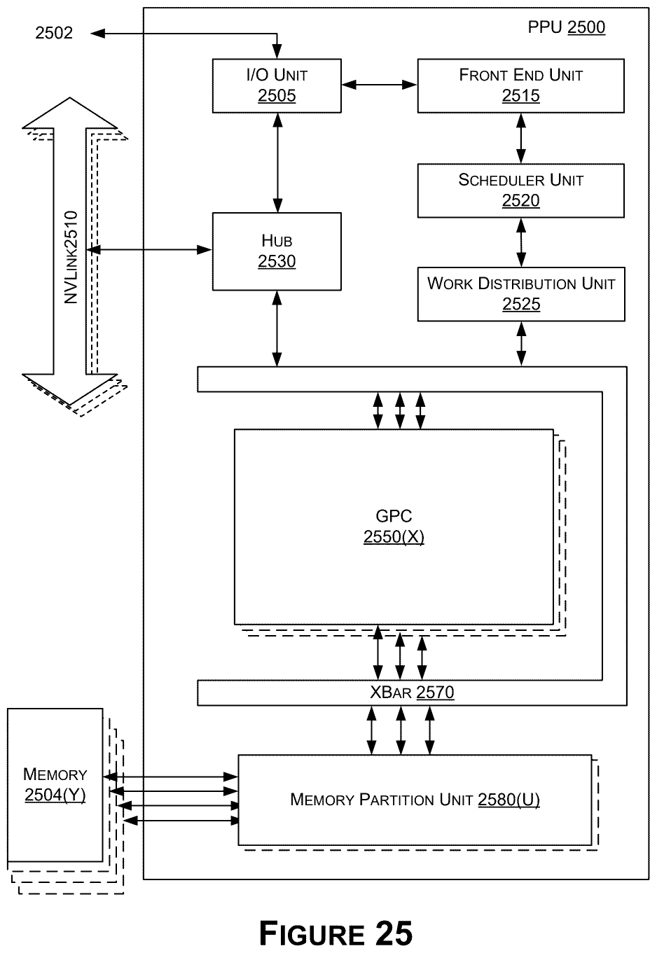

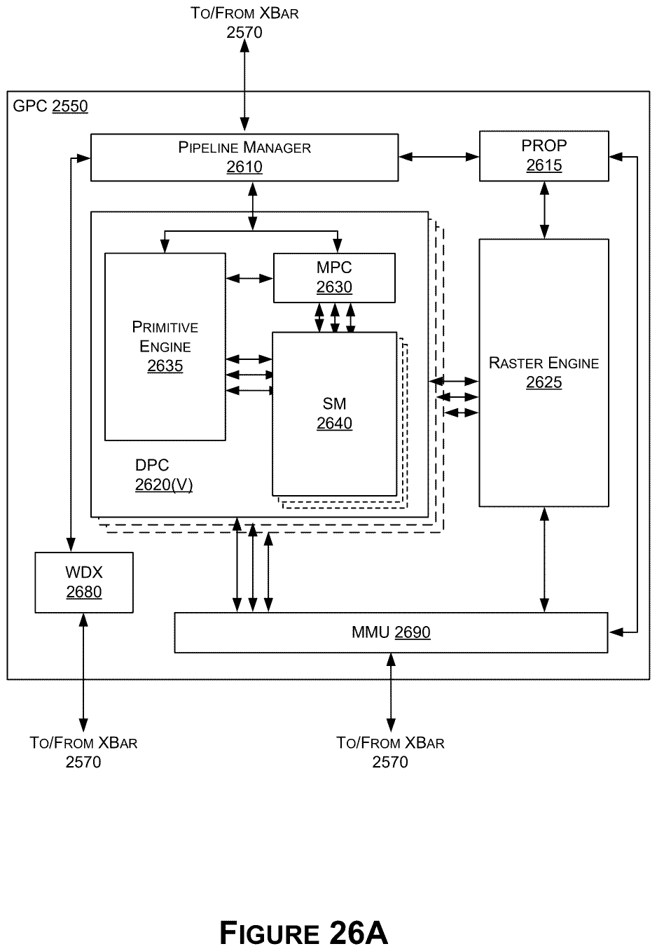

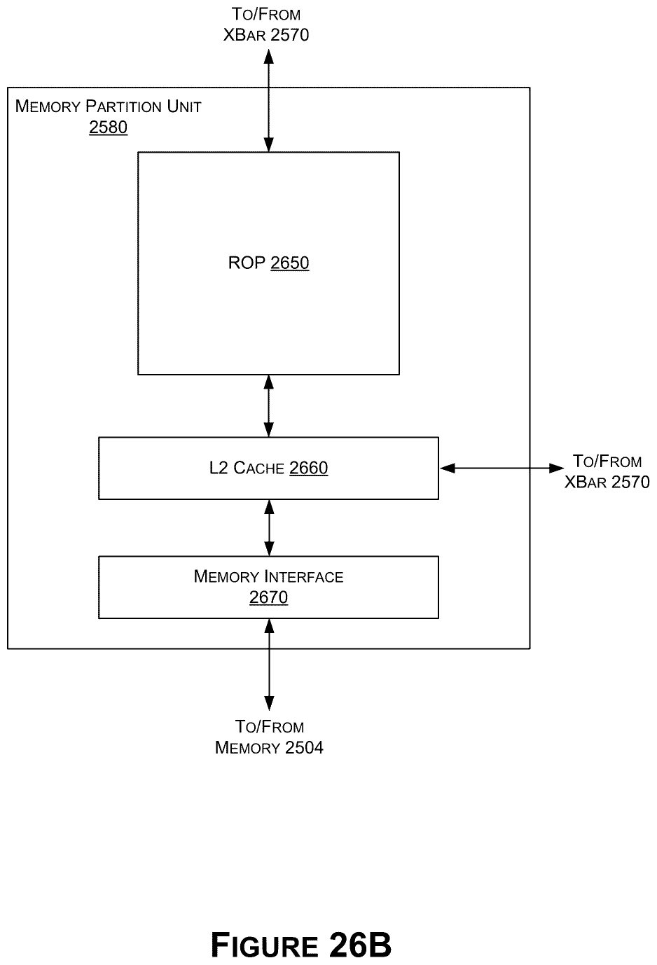

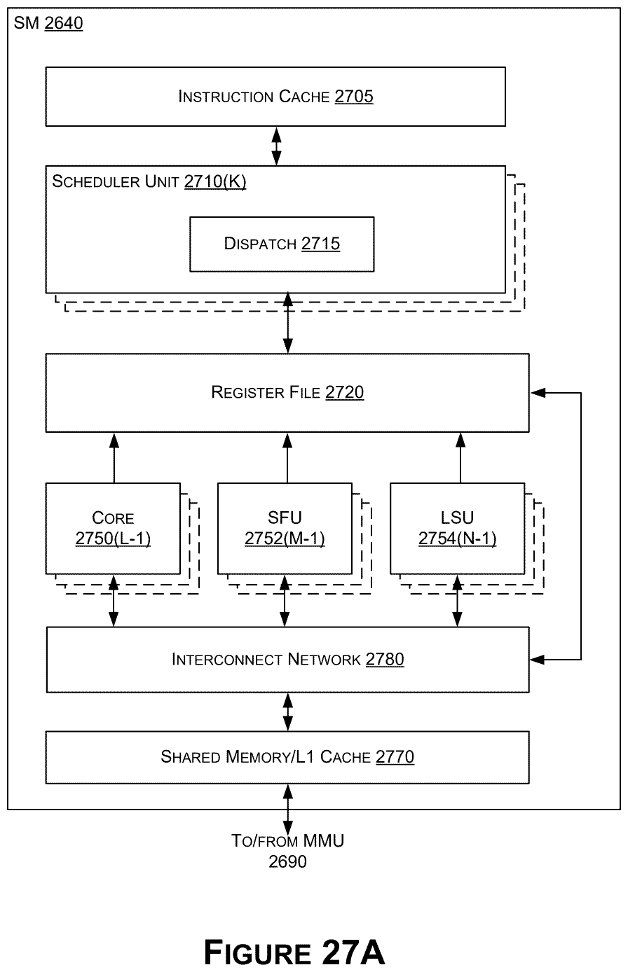

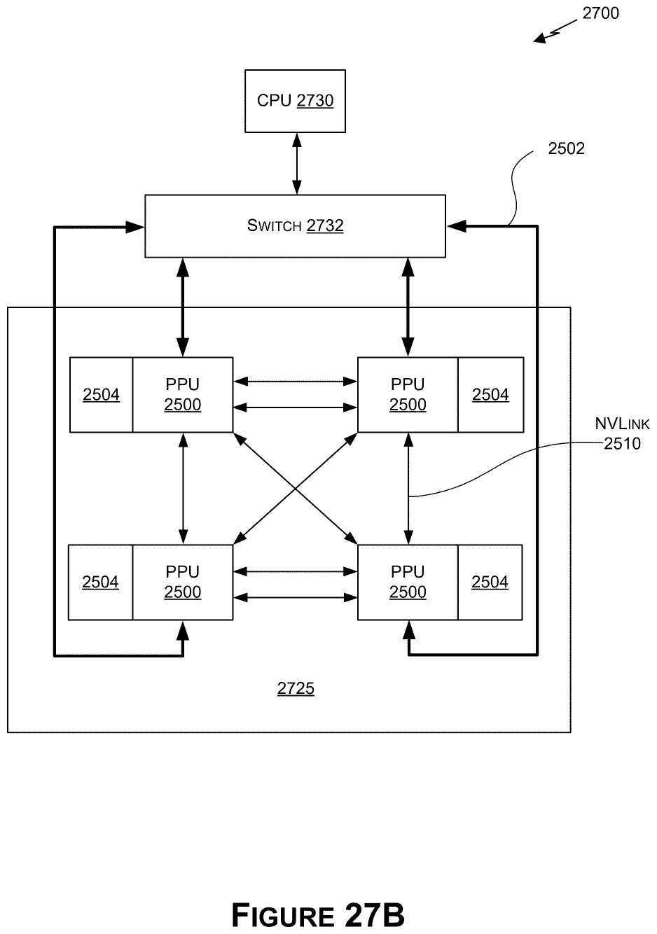

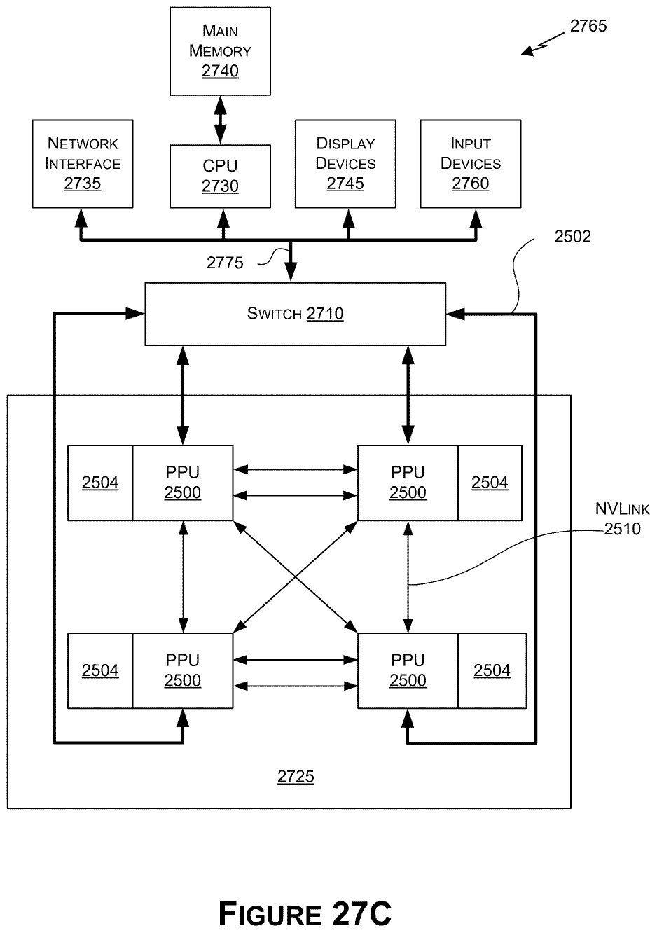

In FIG. 1, the ray tracing pipeline 100 may be implemented via an application 105 executed by a host 110 (e.g., a central processing unit (CPU) that runs application logic and coordinates task execution with a device 130 (e.g., a parallel processor (e.g., the PPU 2500 of FIG. 25) such as a GPU), which may be optimized for parallel processing and high-performance tasks like rendering, shading, and ray tracing. In this example, the device 130 includes user code 150 such as custom program(s) that may be written by a developer in a shading language (e.g., OpenGL Shading Language (GLSL), High-Level Shading Language (HLSL)) to execute specific tasks on the device 130. By contrast, the native device code 160 typically represents built-in or configurable functions provided by the manufacturer of the device 130, and may operate a lower level (e.g., embedded within drivers, built-in libraries, firmware, etc.). The device 130 may include one or more multi-threaded processors (e.g., a streaming multiprocessor (SM) such as the SM 2640 of FIG. 26A) that run the user code 150 (e.g., on general-purpose core(s) which may correspond to the cores 2750 of FIG. 27A) and/or the native device code 160 (e.g., on special function core(s) such as the special function unit(s) 2752 of FIG. 27A).

Generally, the application 105 may be any type of application that defines, updates, manages, and/or coordinates rendering a 3D scene (e.g., a video game, real-time rendering engine, physics simulation, CAD software, architectural visualization tool, film industry rendering, robotics simulation, AR or VR environment, etc.). At a high level, the application 105 may use any known technique to define and/or update (e.g., animate) the scene, and may coordinate with the device 130 to execute various stages of the ray tracing pipeline 100, such as pre-processing (e.g., tessellation and construction of BVH sub-trees over clusters of triangles, executed by a pre-processing component 135), BVH construction (e.g., over the BVH sub-trees, executed by a BVH build component 180), and/or ray tracing (e.g., executed by a ray tracing component 190).

In an example implementation (e.g., every frame, every N frames, etc.), the application 105 may initiate a geometry subdivision control component 120 that identifies objects or parts of the scene (e.g., terrain, characters, objects, etc.) and sends commands to the device 130 to tessellate the identified geometry based on specified tessellation parameters (e.g., levels of detail), and the device 130 may run a geometry subdivision component 140 (e.g., in the form of tessellation shader(s)) to subdivide the input geometry into finer detail. In the process of tessellating the specified geometry, the geometry subdivision component 140 may identify one or more clusters of triangles in designated patterns supported by the device 130 (e.g., with corresponding precomputed, optimized cluster templates 175). As such, the geometry subdivision component 140 may provide instruction(s)—or the geometry subdivision component 140 may return a representation of the cluster(s) and/or corresponding designated patterns to the geometry subdivision control component 120, which may provide instruction(s)—(e.g., via hardware interface software such as a driver associated with the device 130) that trigger the CLAS build component 170 to build a BVH sub-tree (CLAS) over the identified cluster(s) of triangles. The process may repeat over some or all of the scene. As such, the application 105 may instruct the device 130 to build (e.g., via the BVH build component 180) a BVH over the BVH sub-trees (CLASes), and the application 105 may coordinate ray tracing by assigning ray generation and shading tasks to the device 130, which the device 130 (e.g., the ray tracing component 190) may execute on special function core(s) to handle the BVH traversal and ray intersection calculations. Throughout this process, the application 105 and/or user code on the device 130 (e.g., the user code 150) may interact with the device 130 via any number of API calls to manage the data flow through the ray tracing pipeline 100 (e.g., from geometry subdivision to ray tracing). This allocation of functionality among the application 105, user code (e.g., the user code 150) on the device 130, and native device code (e.g., whether running on the device 130 or on the host 110) is meant simply as an example, and variations may be implemented within the scope of the present disclosure.

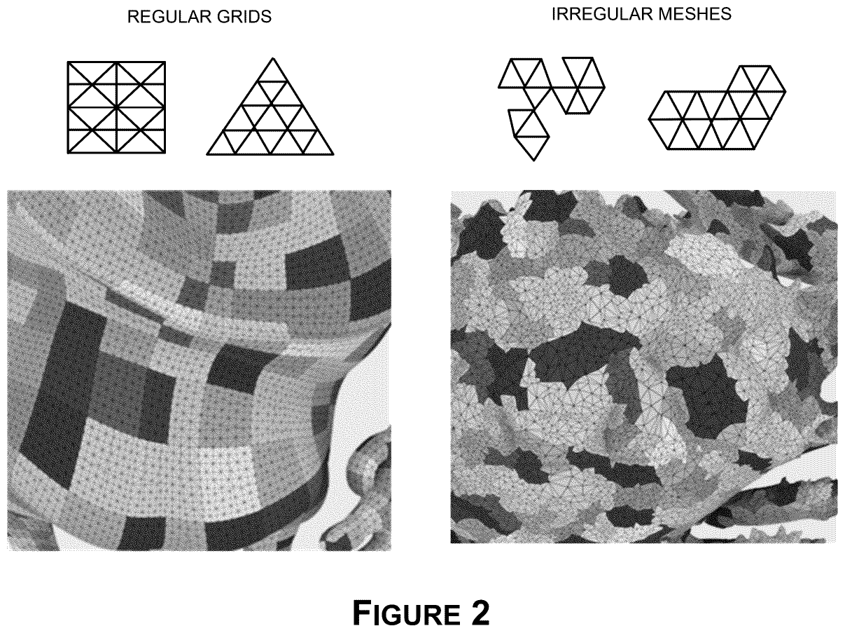

Generally (e.g., every frame, every N frames, etc.), the geometry subdivision control component 120 and/or the geometry subdivision component 140 may use any known tessellation technique as a pre-processing step to increase the geometric detail of one or more 3D models (e.g., meshes) representing objects or parts of the scene and/or create smoother surfaces before ray tracing. In some embodiments, the geometry subdivision control component 120 and/or the geometry subdivision component 140 may use the tessellation technique to identify clusters of triangles that form supported pattern(s), such as regular grids or irregular meshes. FIG. 2 illustrates some example regular grids and irregular meshes. In FIG. 2, the lower images represent example subdivision surfaces, which may be generated by the geometry subdivision control component 120 and/or the geometry subdivision component 140. For example, a 3D model or mesh such as an object or a character may be subdivided using any suitable tessellation technique, for example, iteratively subdividing the 3D model or mesh into successively fine levels of detail. The left image illustrates an example in which a tessellation technique (e.g., uniform tessellation) subdivides a 3D model or mesh into clusters of triangles that form regular grids, and the right image illustrates an example in which a tessellation technique (e.g., adaptive tessellation) subdivides a 3D model or mesh into clusters of triangles that form irregular meshes.

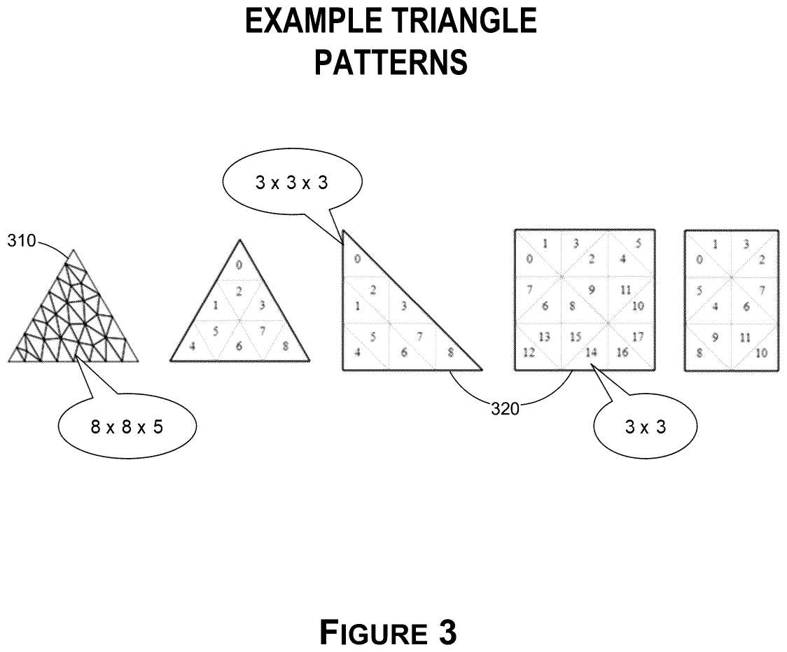

As such, the tessellation process may serve to identify various clusters of triangles. In some embodiments, the geometry subdivision control component 120 and/or the geometry subdivision component 140 may identify clusters that form corresponding supported patterns of triangles. For example, the device 130 may include or be associated with (e.g., a driver that contains) cluster templates 175 representing precomputed (e.g., optimized) acceleration structures for certain patterns of triangles, so the geometry subdivision control component 120 and/or the geometry subdivision component 140 may be programmed to identify those patterns in the scene geometry. FIG. 3 illustrates some example triangle patterns, including an irregular mesh 310 and some regular grids (e.g., grids 320). Generally, the patterns may use any number of triangles, edge resolution, shape, etc. In some embodiments, the patterns are associated with corresponding identifiers (e.g., ID numbers, tags describing the patterns) such that the geometry subdivision control component 120 and/or the geometry subdivision component 140 may identify the patterns to the device 130 using corresponding identifiers. For example, the irregular mesh 310 might be identified with an identification number or an alphanumeric tag describing the pattern (e.g., “irregular 8×8×5”). In some embodiments, edge resolutions may be used to identify patterns that fit into a polygon (with or without edges). For example, rectangular meshes may be identified using the number of triangles on each of their two sides (e.g., 3×3), triangular meshes (whether regular or irregular) may be identified using the number of triangles on each of their three sides (e.g., 8×8×5), etc.

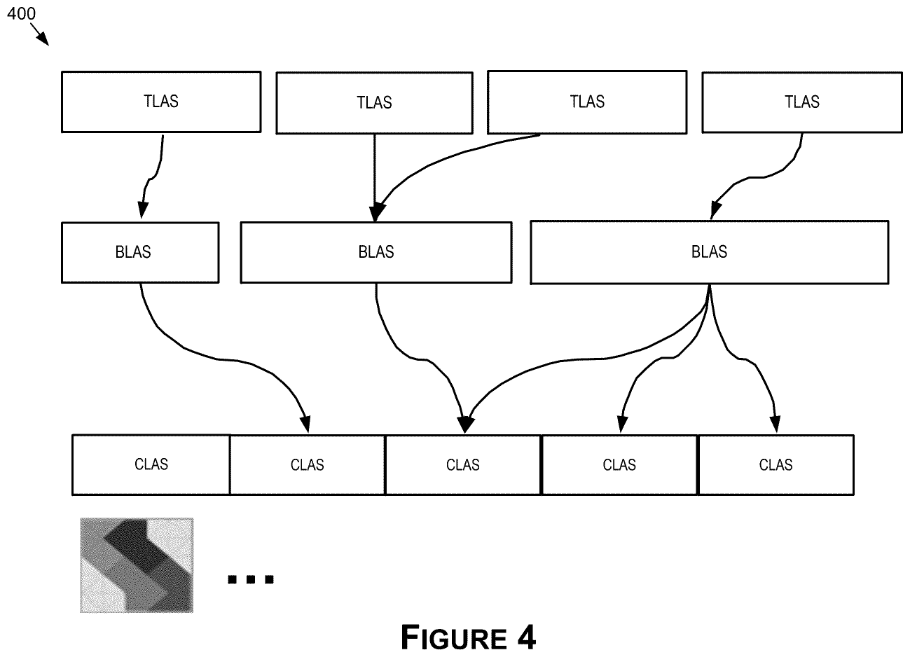

In an overview of an example online process, the geometry subdivision control component 120 and/or the geometry subdivision component 140 may issue command(s) instructing the device 130 (e.g., via an API that triggers the CLAS build component 170) to build a BVH (a CLAS) over each of one or more identified clusters using a corresponding one of the cluster templates 175. For example, the geometry subdivision control component 120 and/or the geometry subdivision component 140 may identify and provide a representation of a supported pattern of triangles and a cluster of triangles to the native device code 160, which may instruct the CLAS build component 170 to look up a corresponding one of the cluster templates 175 for that pattern and use the cluster template to build a BVH (CLAS) over the cluster. As such, the geometry subdivision control component 120 and/or the geometry subdivision component 140 may issue command(s) for the device 130 to build a BVH (CLAS) over any number of clusters (e.g., all clusters in an object mesh, the 3D scene, some portion thereof, etc.), and may issue command(s) for the device 130 to build a BVH (e.g., a bottom-level acceleration structure (BLAS), a top-level acceleration structure (TLAS), etc.) over these CLASes. FIG. 4 illustrates an example hierarchical tree structure 400 that includes multiple TLASes, BLASes, and CLASes.

Generally, the cluster templates 175 may be represented in any suitable manner. For example, a cluster template for a particular pattern of triangles may include precomputed template triblock data (e.g., a triblock header, a representation of the topology of the triangles in the cluster such as an index buffer or ordered list of vertex indices that defines how the vertices in the triblock are connected to form triangles, an ordered list of vertex indices per triblock or other representation of a partitioning of the triangles in the cluster to corresponding triblocks, the number of vertices used per triblock, the maximum memory size or number of triblocks or cache lines needed per cluster, etc.), a template CLAS or some portion thereof such as template range or tree data (e.g., an ordered list of vertex indices per range or other representation of a partitioning of the triangles in the cluster to corresponding ranges, backed tri-range data indicating the number of triangles in each range, etc.), and/or otherwise. In some embodiments, the cluster templates 175 may be aggregated and/or stored in one or more lookup tables, and may be in indexed by an identifier or other representation of the corresponding pattern of triangles (e.g., an ID number, a tag describing the pattern such as “5×5 rectangular grid”), a representation of a corresponding compression level (e.g., the number of bits used to represent vertex positions, a quantification of a supported or applied amount of bit reduction such the number of bits that were or may be discarded or truncated, etc.), and/or otherwise indexed. The cluster templates 175 may be packaged or bundled with a driver, firmware, or other hardware interface software associated with the device 130 (e.g., whether on the host 110 or the device 130).

In an example implementation, the device 130 is associated with an API (e.g., of a driver, firmware, or other hardware interface software associated with the device 130), and the geometry subdivision control component 120 and/or the geometry subdivision component 140 issues command(s) via API calls to manage or control generation of BVHs (CLASes) over clusters of triangles. Generally, the geometry subdivision control component 120 and/or the geometry subdivision component 140 may issue any number and/or type of API calls that identify one or more supported triangle patterns of one or more identified clusters of triangles, and the device 130 may look up and use one or more corresponding cluster templates 175 to layout the cluster vertices in memory (e.g., using precomputed, optimized triblock layouts) and/or build a BVH (CLAS) over each cluster (e.g., using precomputed, optimized range assignments).

For example, the geometry subdivision control component 120 and/or the geometry subdivision component 140 may issue one or more initial API calls (e.g., using a first type of API call) identifying a supported pattern (e.g., using an ID number or tag describing the pattern) formed by a cluster of triangles, and the API (or some other component of the hardware interface software or native device code 160) may use the identifier to look up and return a corresponding identifier for a set of one or more of the cluster templates 175 that are associated with that pattern (identifier). In some embodiments, the API (or other component) may look up a corresponding anticipated or maximum memory size or cache lines needed for that cluster of triangles. As such, the geometry subdivision control component 120 and/or the geometry subdivision component 140 may allocate a corresponding amount of memory and issue one or more subsequent API calls (e.g., using a second type of API call) identifying (e.g., including the identifier for) the applicable cluster template (or set of cluster templates), a list of vertex positions in the cluster, a reference or pointer to the location of the allocated memory for the cluster, and/or a representation of the compression level of the vertex positions. The API (or some other component of the hardware interface software or native device code 160) may look up the applicable cluster template, and the CLAS build component 170 may copy the cluster template into the allocated memory (e.g., instantiate the cluster with a precomputed triblock layout and/or precomputed range assignment, for example, by copying template triblock data such as precomputed lists of vertex indices into corresponding triblocks, copying a template CLAS structure and/or template range data such as precomputed ranges (leaf nodes) and/or corresponding precomputed lists of vertex indices into in the allocated memory). As such, the CLAS build component 170 may copy the vertex positions into the precomputed triblock layout in the allocated memory (e.g., mapping a designated vertex order such as a scan order to a predetermined order associated with the cluster template, transcoding using a designated compression level or a compression level determined from the vertex positions on the fly), and may write one or more parent nodes forming a CLAS (which may eventually serve as complets or intermediary nodes in a BVH such as a BLAS or TLAS) over the precomputed ranges in the allocated memory (e.g., computing and writing bounding boxes for each child (e.g., in parallel) using the cluster vertex positions and precomputed per-range lists of vertex indices, filling in a reference or pointer to each child and its bounding box, etc.).

As such, the geometry subdivision control component 120 and/or the geometry subdivision component 140 may issue command(s) that trigger the CLAS build component 170 to leverage precomputed cluster templates 175 to accelerate a BVH subtree (CLAS) build over a specified cluster of triangles. Depending on the implementation, any number, type, and order of API calls may be used to build CLASes over any number of clusters of triangles. For example, the geometry subdivision control component 120 and/or the geometry subdivision component 140 may make a first type of API call(s) for a particular cluster of triangles and then make a second type of API call(s) to build a CLAS over that cluster. In some embodiments, the geometry subdivision control component 120 and/or the geometry subdivision component 140 identify a repeating pattern that applies to multiple clusters of triangles, and may issue the second type of API call(s) for each of those clusters. Additionally or alternatively, the geometry subdivision control component 120 and/or the geometry subdivision component 140 may issue the first type of API call(s) any number of times to return identifiers for different types of supported patterns, and may issue the corresponding second type of API calls in any suitable order. In some embodiments, the geometry subdivision control component 120 and/or the geometry subdivision component 140 may provide a reference or pointer to the allocated memory for each cluster of triangles, or may provide a reference or pointer to an aggregate buffer for multiple clusters, and the CLAS build component 170 may fill in the aggregate buffer and return references or pointers to the locations where each cluster is stored (e.g., and corresponding sizes). In some implementations, the geometry subdivision control component 120 and/or the geometry subdivision component 140 may use asynchronous command submission and/or command buffers to issue multiple commands to build multiple CLASes, and the CLAS build component 170 may build the CLASes concurrently or in a defined order (e.g., defined by a command buffer).

In some embodiments, any given supported pattern may be associated with multiple cluster templates 175 suitable for different compression levels. As such, in some embodiments, the compression level of the vertex positions in the cluster may be identified in an API call (e.g., based on a specified number of unique bits, number of discarded or truncated bits), and the API (or some other component of the hardware interface software or native device code 160) may look up a corresponding cluster template (e.g., indexed by the number of unique bits, or the number of discarded or truncated bits). In some embodiments, the API (or other component) may use a specified (or otherwise identified) number of unique, discarded, or truncated bits to identify an appropriate cluster template by looking up the set of cluster templates 175 associated with a specified pattern and testing one or more cluster templates in the set to determine whether the vertex positions in the cluster would into a corresponding triblock layout. For example, the API (or other component) may look up one of the cluster templates in the set which may be further indexed by some other representation of the level of compression and/or which may otherwise be associated with metadata indicating the number of vertices/triangles per triblock. As such, the number of bits needed for a single triblock may be computed (e.g., based on the number of bits needed to represent a vertex using the number of unique bits—which may be computed based on the number of discarded or truncated bits—and the number of vertices/triangles per triblock) and the number of bits needed for a single triblock may be compared to the number of bits available in a single triblock to determine whether the vertex positions would fit into the template triblock layout using that compression level (or the number of bits available in a single triblock may be divided by the number of bits needed to represent a vertex and compared to the number of vertices per triblock). As such, the API (or other component) may identify a cluster template that is associated with the identified pattern and identifies a triblock layout the vertex positions would fit into using that compression level (e.g., by sequentially testing successively more compressed triblock layouts to identify the most compressed triblock layout the vertex positions would fit into using an identified number of unique bits).

In some embodiments, an API call may identify a supported pattern (e.g., using an ID number or tag describing the pattern) formed by a cluster of triangles without identifying a corresponding compression level, and the API (or other component) may use the identifier to look up a set of one or more of the cluster templates 175 that are associated with that pattern (identifier) and may be used for vertex positions with different levels of compression. In some embodiments, the API (or other component) looks up the maximum memory size or cache lines needed to use any of the cluster templates 175 that are associated with that pattern (e.g., the one for compressed vertex data), so the geometry subdivision control component 120 and/or the geometry subdivision component 140 may allocate a corresponding amount of memory. In some embodiments, an API call may identify a supported pattern formed by a cluster of triangles and identify a corresponding compression level, so the API (or other component) may look up and return the memory size or cache lines needed to use the cluster template with the specified compression level. In some embodiments, the geometry subdivision control component 120 and/or the geometry subdivision component 140 may determine a bounding shape (e.g., bounding box) that encompasses a cluster of triangles, and may include a representation of the bounding shape in an API call. As such, the API (or some other component of the hardware interface software) may use the bounding box to determine whether any bits may be discarded or truncated based on the position of the bounding box (e.g., discarding or truncating sign or exponent bits based on the positions of the vertices or edges of a bounding box), may identify a minimum compression level associated with the number of bits that may be discarded or truncated, and may identify and return the maximum memory size or cache lines needed for the cluster template using that compression level.

As such, the geometry subdivision control component 120 and/or the geometry subdivision component 140 may allocate (and specify the location of) an appropriate amount of memory for each cluster of triangles, and may issue one or more subsequent API call(s) that trigger the CLAS build component 170 to copy the vertex positions of the cluster and/or build a CLAS over the cluster in the allocated memory. In some embodiments, the API call(s) identify the (e.g., location(s) of) the vertex positions, the applicable pattern, and the compression level, and the CLAS build component 170 (or other component) may look up and use the corresponding template for that pattern and compression level. In some embodiments, the API call(s) do not specify the compression level, and the CLAS build component 170 (or other component) may read and inspect the vertex positions to determine the compression level on the fly, and look up and use the corresponding template for that pattern and compression level. For example, the CLAS build component 170 (or other component) may examine and compare all vertex positions in the cluster (e.g., in parallel) to discover how many bits are unique across the three dimensions (x, y, z) of the positions of the vertices in the cluster, may use the number of unique bits to determine how many bits are needed to represent a single vertex, how many vertices fit into a triblock, and which cluster template associated with that pattern fits that number of vertices.

As such, the CLAS build component 170 may copy the applicable cluster template into the allocated memory (e.g., instantiating precomputed triblock layouts assigning the triangles in the cluster to corresponding triblocks, instantiating precomputed range assignments), may copy the vertex positions (or transcode the vertex positions using a corresponding compression level) into the triblock layout in the allocated memory, and may write one or more parent nodes forming a CLAS over the precomputed ranges in the allocated memory (e.g., computing and writing bounding boxes for each child (e.g., in parallel) using the cluster vertex positions and precomputed per-range lists of vertex indices, filling in a reference or pointer to each child and its bounding box, etc.). Accordingly, the CLAS build component 170 may build any number of CLASes over any number of corresponding clusters of triangles using the cluster templates 175.

Depending on the implementation, the BVH build component 180 may use any known technique to build a BVH (e.g., top-down, bottom-up) on top of a set of clusters of triangles, but using the CLASes at the bottom level instead of building them online, and the ray tracing component 190 may use any known technique to render a frame using the BVH. For example, the ray tracing component 190 may cast rays into the scene through each pixel. For each ray, the ray tracing component 190 may traverse the BVH to identify intersections with objects in the scene, apply lighting effects to represent intersections, and calculate pixel values by aggregating color, lighting, and/or shading effects from the intersected objects and light sources. Example techniques for generating intermediate and upper levels of a BVH and ray tracing using a BVH are described in more detail in U.S. Pub. No. 2024/0087211, entitled “Generation and Traversal of Partial Acceleration Structures for Ray Tracing,” the contents of which are hereby incorporated by reference in their entirety.

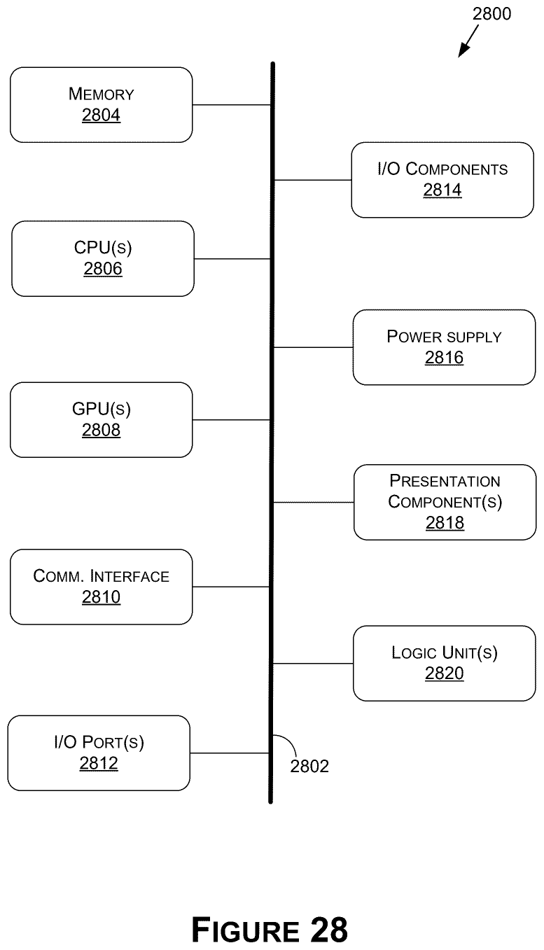

Precomputation of Cluster Templates. The following sections describe some example techniques for precomputing cluster templates (e.g., the cluster templates 175 of FIG. 1). The techniques described below may be implemented by a cluster optimization solver executed on any number or type of processors, such as a CPU (e.g., the CPU(s) 2806 of FIG. 28) and/or a GPU (e.g., the PPU 2500 of FIG. 25, the GPUs 2808 of FIG. 28).

More specifically, the cluster optimization solver may precompute one or more optimized cluster templates (e.g., template triblock data, template CLASes or some portion thereof such as template range data, etc.) for one or more patterns of triangles (e.g., regular grids and/or irregular meshes of various edge resolutions), or pairs of patterns and corresponding compression levels. In an example overview, the solver may generate an optimized cluster template offline, which may be leverage during an online BVH build process to accelerate the process of instantiating a corresponding cluster of triangles in memory (e.g., configuring a triblock layout and/or range assignment) and filling in instance-specific cluster information into the cluster template (e.g., copying the vertex positions in the cluster into the triblock layout, computing bounding boxes for the ranges of vertices grouped according to the range assignment). As such, for each designated pattern of micro-triangles (e.g., an 11×11 rectangular grid of quads) and corresponding compression level for the triangles in the cluster, the solver may perform a first optimization to solve for a partitioning or grouping of the triangles in the pattern into an optimized layout of triblocks (e.g., iteratively generating and evaluating candidate triblock layouts to minimize the number of triblocks used and/or the average surface area of axis-aligned bounding boxes of rotated triblock patterns), and the solver may perform a second optimization to solve for a partitioning or grouping of the triangles in the pattern into an optimized range assignment (e.g., iteratively generating and evaluating candidate range assignments to minimize the surface area of axis-aligned bounding boxes of rotated triangle ranges). In some embodiments, the partitioning is independent of the locations of the vertices (e.g., to facilitate reuse anywhere in the scene), and the optimized triblock and/or range partitioning may be represented using list(s) of vertex indices (e.g., per-triblock lists, per-range lists) and/or locations of triblock and/or range boundaries or divisions in the list(s) of vertex indices. Cluster templates may be generated for any number or type of pattern of triangles (e.g., regular grids or irregular meshes with a corresponding edge resolution) and a variety of compression levels.

Taking partitioning into an optimized layout of triblocks as an example, some embodiments may seek to minimize the number of triblocks used to store the triangles in a particular pattern of micro-triangles. The number of triangles that fit into a particular triblock may depend on various factors such as the size of the triblock (e.g., 128 bytes, one cache line), the data format for storing the triangle data, a supported compression level, and/or the spatial arrangement of the triangles in the cluster. With respect to data format, an example memory block may represent a set of triangles by storing the vertex positions of the triangles in the cluster and metadata such as a header, triangle IDs, and/or vertex IDs, etc. In some embodiments, a compressed triangle format may represent multiple elements (e.g., vertex positions for multiple vertices, triangle IDs for multiple triangles) using a base value and an array of offsets. In some embodiments, a full precision representation of the vertex positions may correspond to one supported compression level, and a lossless compression scheme that truncates or discards non-unique bits (which may vary from cluster to cluster depending on the vertex data) may correspond to one or more supported compression levels.

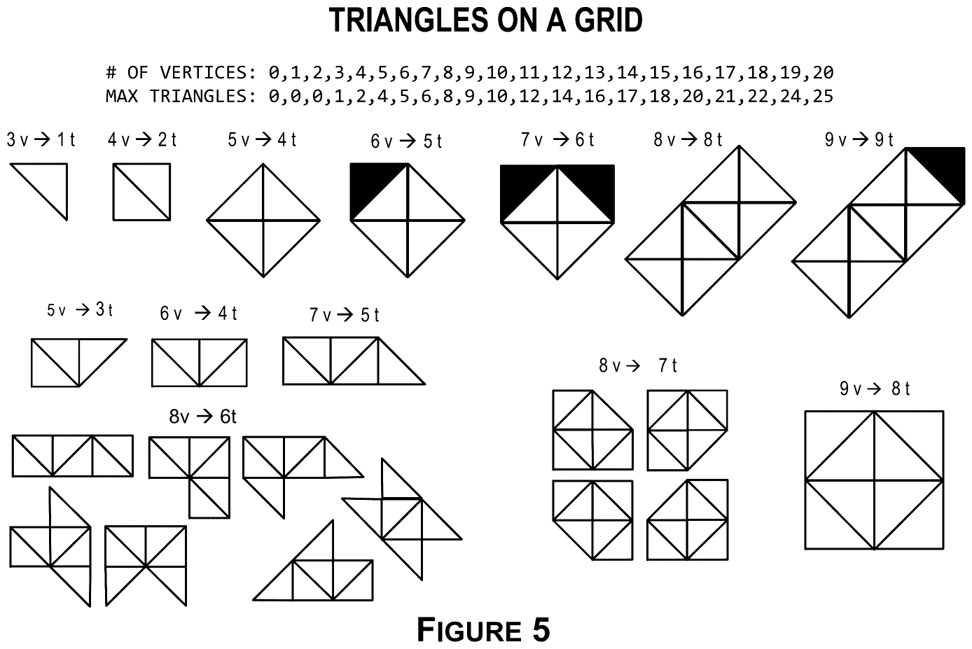

As such, depending on the designated parameters for a given implementation, the number of triangles and/or vertices that may fit into a memory block (triblock) of a designated size may be identified. Since adjacent triangles typically share vertices, the additional data required to include an additional triangle in a triblock will often depend on how many extra vertices the additional triangle uses, and the pattern formed by the triangles in a triblock may be grown by adding triangles that form preferred spatial arrangements that minimize the additional data (e.g., the number of additional vertices) required. FIG. 5 illustrates some example triblock patterns that may be used to store corresponding numbers of vertices and triangles. For example, the pattern at the top left represents a three vertex/one triangle (3v->1t) pattern, and moving left to right, the illustrated patterns represent example arrangements of triangles (and corresponding vertices) that may be used to store an increasing number of vertices and triangles.

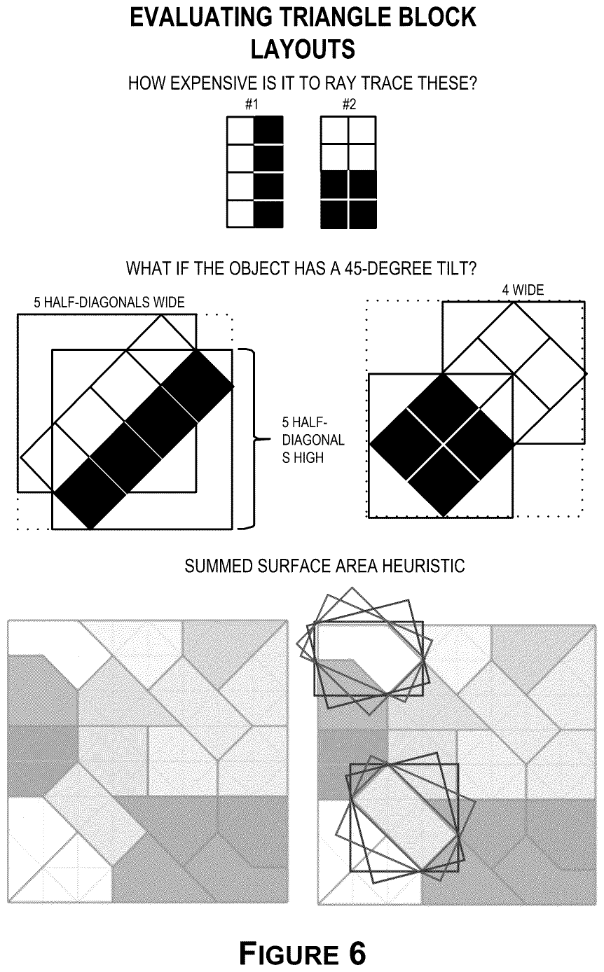

Although these patterns should minimize the size of the memory footprint for a given number of vertices and triangles, another possible optimization goal may be to minimize or reduce the traversal time. One possible way to model the traversal time for a pattern of triangles in a triblock is based on its surface area. FIG. 6 illustrates an example technique that may be used (e.g., by the solver) to evaluate a pattern of triangles in a triblock and/or a corresponding triblock layout with multiple triblocks based on surface area. In FIG. 6, the triblock patterns labeled #1 and #2 illustrate two possible ways of partitioning a group of sixteen triangles (eight quads in a 4×2 pattern) into corresponding a triblock pattern of eight triangles (four quads in a 1×4 and a 2×2 pattern, illustrated in black). During ray tracing, depending on the dynamics of the scene, the cluster of triangles (e.g., a mesh on a surface of an object or some other part of the scene) may move or rotate, so the area of its axis-aligned bounding box may change. Generally, the more circular-shaped a triangle (e.g., triblock) pattern is, the greater its area coverage within its axis-aligned bounding box (AABB), and the more likely it is to be hit by a ray that hits its AABB, thereby minimizing total ray/triblock intersection testing costs.

To model this relationship, the solver may apply one or more 2D or 3D rotations to rotate a given triblock pattern to various angles and compute the surface area of the resulting axis-aligned bounding boxes. By way of nonlimiting example, quadrilateral and right-angle triangular meshes may be rotated to and evaluated at some number of 2D rotation or tilt angles (e.g., four rotation angles, such as 0, 22.5, 45, and 67.5 degrees), and equilateral triangular meshes may be rotated to and evaluated at the same or a different number of rotation or tilt angles, and may use the same or different rotation or tilt angles (e.g., six rotation angles, such as 0, 15, 30, 45, 60, and 75 degrees). The number of angles is typically a cost/accuracy tradeoff, with more angles giving a slightly more accurate cost function but providing diminishing improvements in the resulting triblock layouts.

By way of illustration, FIG. 6 illustrates the axis-aligned bounding boxes that would result from rotating triblock patterns #1 and #2 to 45 degrees. At this rotation angle, the surface area of the axis-aligned bounding box for triblock pattern #2 (four half-diagonals wide) is smaller than the surface area of the axis-aligned bounding box for triblock pattern #1 (five half-diagonals wide). As such, the solver may evaluate a triblock pattern using a summed surface area heuristic or metric computed by rotating the triblock pattern to a variety of rotational angles (e.g., four) and combining (e.g., averaging) the surface areas of the resulting axis-aligned bounding boxes. In some embodiments, the solver may normalize the combined (e.g., averaged) surface areas by dividing by the area of the AABB enclosing the group of triangles being partitioned per tilt. Continuing with the 45 degree tilt example, the relative surface area of the AABB of triblock pattern #1 to the group of sixteen triangles may be computed as (5×5+5×5)/(6×6)=1.38, and the relative surface area of the AABB of triblock pattern #2 to the group of sixteen triangles may be computed as (4×4+4×4)/(6×6)=0.88. Summing over the 0- and 45-degree tilts, the summed surface area metric for triblock pattern #1 may be computed as 1.0+1.38=2.38, and the summed surface area metric for triblock pattern #2 may be computed as 1.0+1.11=1.88. As a result, in this example, triblock pattern #2 may be preferred. In some embodiments, the solver may evaluate a candidate triblock layout formed by multiple triblock patterns by computing and combining (e.g., averaging) the summed surface area metric for each of the triblock patterns in the candidate triblock layout.

As such, the solver may compute an optimized triblock layout for any given triblock pattern by iteratively generating candidate triblock layouts, evaluating each layout based on one or more metrics (e.g., based on the number of triblocks used and/or the summed surface area metric), and tracking the triblock layout (or top N) that optimizes the one or more metrics (e.g., minimizes the number of triblocks used, minimizes the combined summed surface area metric for the triblock patterns in the triblock layout). In some embodiments, the solver evaluates each candidate triblock layout by determining whether it has fewer triblocks than the current optimized solution for a given pattern (and compression level), and if a candidate triblock layout uses fewer triblocks, the solver designates and tracks the candidate triblock layout as the new optimized solution for that pattern (and compression level). If a candidate triblock layout uses the same number of triblocks as the current optimized solution, the solver may place axis-aligned boxes around all triblocks in each layout, and if a summed surface area metric (e.g., sum of the areas of these boxes, the average of the summed areas of the boxes rotated to various tilt angles) for the candidate triblock layout is less than the current optimized solution, the solver may designated and track the candidate block layout as the new optimized solution for that pattern (and compression level).

In some embodiments, the solver may iteratively generate candidate triblock layouts that partition or group triangles in the pattern into corresponding triblocks in any number or type of ways. In an example technique, the solver may generate candidate triblock layouts by sequentially filling up triblocks using a triangle ordering that keeps consecutive triangles spatially near each other (e.g., a random walk of neighboring triangles). For example, starting with a pattern of triangles to be partitioned, the solver may select a corner triangle as a seed triangle, and the solver may perform a random walk of neighboring triangles to create a triblock. In some embodiments, if there is a choice of triangles, the solver may add the triangle that adds the least vertices. Once a triblock is full, the solver may start a new triblock (e.g., selecting a seed triangle next to the previous triblock, if possible, otherwise the lowest ID in the cluster).

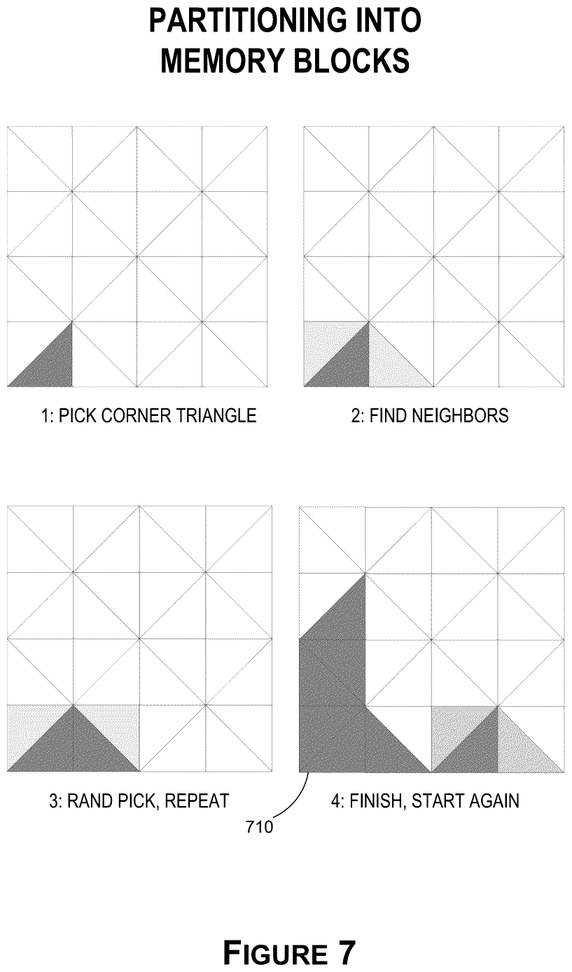

FIG. 7 illustrates an example technique that may be used (e.g., by the solver) for partitioning a triangle pattern into a triblock layout. At step 1, a corner triangle is selected. At step 2, the neighboring triangles to the triblock being grown are identified, and at step 3, one of the neighboring triangles is selected (e.g., randomly), and steps 2-3 are repeated until the triblock 710 is finished, at which point, at step 4, the process starts over, and the process is repeated until the pattern is filled with triblock patterns forming a candidate triblock layout.

In some embodiments, the solver may generate candidate triblock layouts by tiling regular grids with designated triblock shapes using symmetry and/or tessellation strategies, such as testing out possible reflections and/or rotations of triblock patterns onto unassigned triangles in the pattern formed by a cluster of triangles. For example, the solver may form a representation of triblock using any suitable triblock pattern, rotate or reflect the triblock pattern using one or more types of symmetry (e.g., based on the edge resolution of the pattern of triangles being partitioned), and translate the rotated or reflected triblock pattern to one or more positions in the pattern to determine whether it fits any unassigned triangles. Example types of symmetry include symmetry along the vertical or horizontal axis, along both vertical and horizontal axes, along one diagonal axis, along both diagonals, four-fold (all four of the foregoing axes), and radial (e.g., repeated triblock patterns in diagonally opposite corners, repeated triblock patterns in all four corners). By way of motivation, if a triblock pattern results in a relatively low traversal cost, it may be beneficial to use the same triblock pattern for other parts of the cluster. Conversely, if a triblock pattern results in a relatively high traversal cost and gets reused in a symmetric pattern, the symmetric pattern should accumulate relatively higher traversal costs and fail more quickly during the evaluation stage.

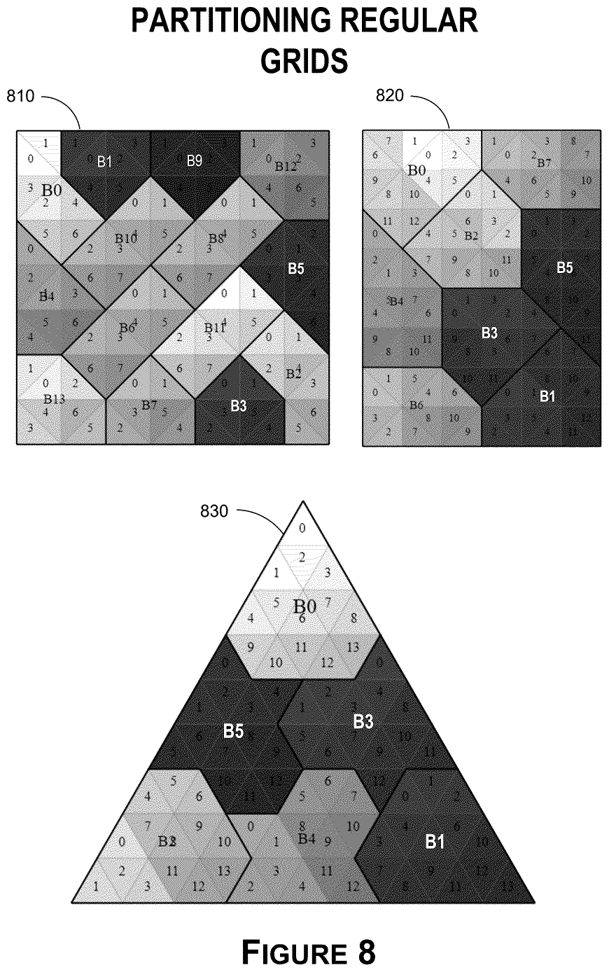

FIG. 8 illustrates some example triangle block layouts 810, 820, 830 that may be generated (e.g., by the solver) using symmetry. In these examples, triblock layout 810 is a rectangular 7×7 grid of right triangles, triblock layout 820 is a rectangular 8×6 grid of right triangles, and triblock layout 830 is a triangular 9×9 grid of equilateral triangles. Each of these layouts is illustrated with triblocks labeled B0, B1, B2, etc., with the triangles in each triblock numbered from 0-N. Taking triblock layout 810 as an example, triblock B13 may be formed (e.g., first), and radial symmetry may be used to form triblock B12 from triblock B13 (e.g., rotating triblock B13 around the center of the grid to the opposite corner). Corresponding symmetries may be used to translate triblock B4 into triblock B5, to translate triblock B0 into triblock B2, to translate triblock B1 into triblocks B9, B3, and B7, etc., continuing the process to fill up some or all of the triblock layout 810.

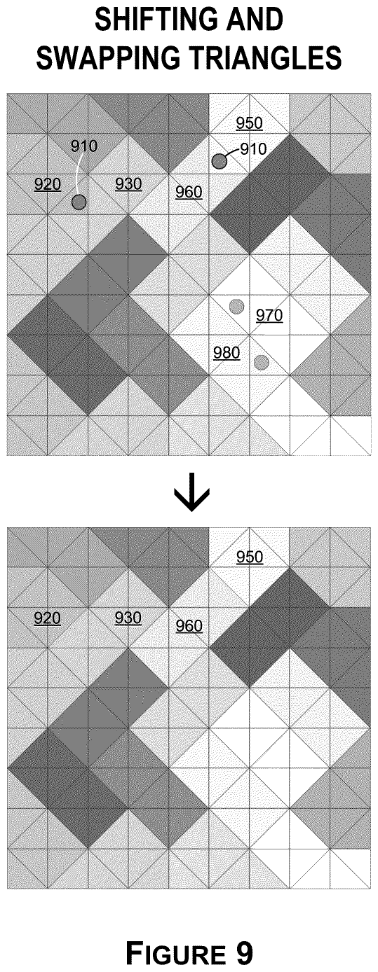

In some embodiments, the solver may generate candidate triblock layouts by adjusting triangle assignments or triblock boundaries from previously generated triblock layouts. For example, the solver may identify and evaluate one or more candidate modifications that shift or swap triangles between triblocks and determine whether they improve on a currently tracked optimized solution. A triangle shift may move one or more triangles from one triblock to another triblock with sufficient space for the additional triangle(s). By way of nonlimiting example, a pair of triblocks that have 10 and 6 vertices assigned, respectively, may evaluate better by shifting a triangle to reallocate the vertices to 8 and 8, respectively. A triangle swap may exchange triangles between triblocks, such that each triblock gives and gets one triangle from the other (e.g., in right-angle triangular triangle meshes). FIG. 9 illustrates an example in which triangle 910 is shifted from triblock 920 to triblock 930 (illustrated with corresponding shades of grey), and triangle 940 is shifted from triblock 950 to triblock 960 (illustrated with corresponding shades of grey). FIG. 9 also illustrates two triblocks 970 and 980 that include triangles (denoted with the corresponding circle) that may be swapped to form another candidate triblock layout. These are just examples, and other variations may be implemented within the scope of the present disclosure.

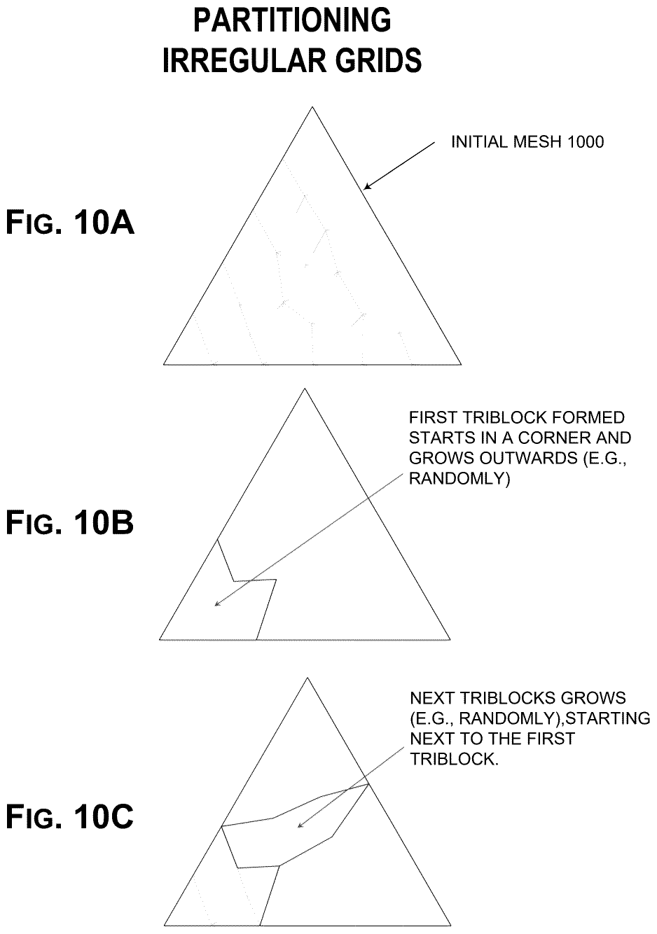

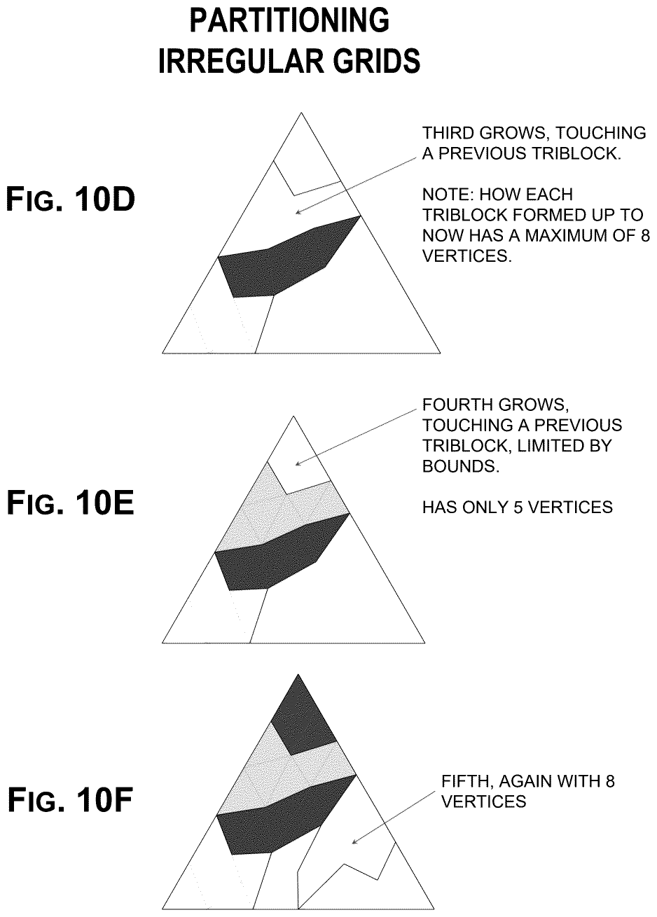

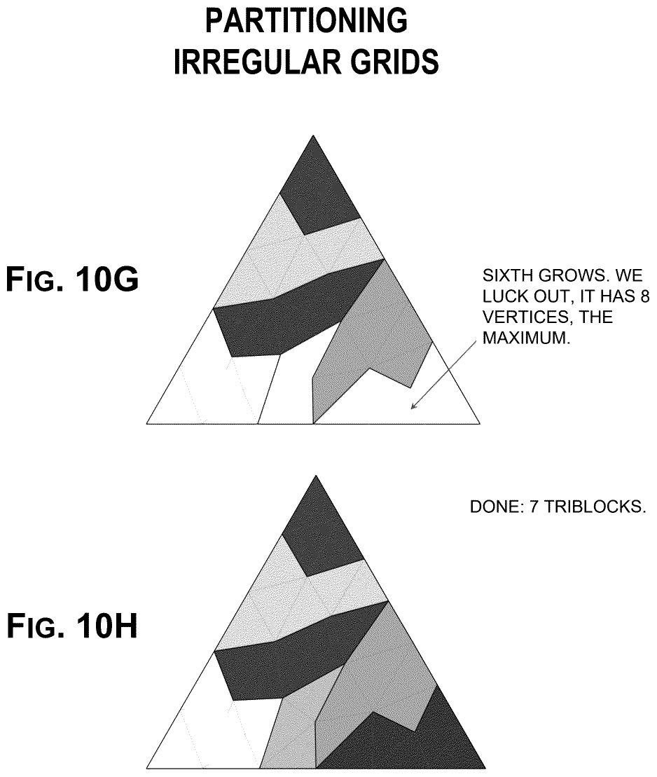

In some embodiments, the solver may generate candidate triblock layouts by tiling irregular meshes of triangles. For example, the solver may tile an irregular mesh by sequentially filling or growing triblocks with random triangles (e.g., favoring isolated triangles with no unassigned neighbors, then corner triangles with only one unassigned neighbor, then edge triangles with two unassigned neighbors). FIGS. 10A-10H illustrate an example technique that may be used (e.g., by the solver) to partition a triangle pattern representing an irregular mesh into a triblock layout. FIG. 10A illustrates the initial mesh 1000 to be partitioned. Any suitable technique may be used to select a seed triangle for a triblock (e.g., one with the fewest edges touching other triangles, a corner triangle of the mesh 1000, etc.). In some embodiments, when starting a triblock, if there are multiple neighboring triangles to choose from, the solver may select one of the neighboring triangles as a seed triangle for the new triblock randomly and/or favoring one or more classes of triangles (e.g., isolated triangles with no unassigned neighbors, corner triangles with one unassigned neighbor, edge triangles with two unassigned neighbors).

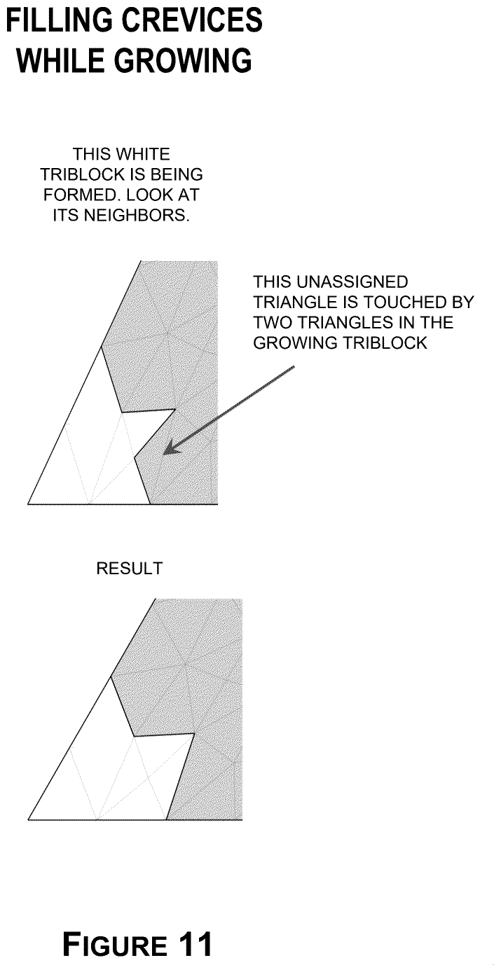

FIG. 10B illustrates an example triblock formed using a seed triangle in the corner of the mesh 1000. The solver may grow a triblock from a seed triangle, for example, by iteratively adding a triangle that borders the triblock. Triangles may be selected in any suitable way (e.g., randomly, favoring triangles that border the current triblock on two edges). FIG. 11 illustrates a potential benefit from favoring triangles that border the current triblock on two edges, which amounts to filling in a crevice. In this scenario, adding a triangle that shares two edges with the triblock being grown does not increase the number of vertices in the triblock, so depending on the data format used to represent the triangles, the triangle may be included with little to no impact on the memory footprint, so it should be more efficient to ray trace the resulting triblock layout. As such, a triblock may be grown from a seed triangle until the triblock reaches a designated maximum (e.g., number of vertices) or runs out of unassigned neighbors.

Returning to FIG. 10B, once the first triblock is filled, the solver may select a new seed triangle (e.g., touching the completed triblock, or any previous triblock in subsequent steps) and a corresponding triblock may be grown (e.g., as illustrated in FIG. 10C). As such, the process may continue, sequentially growing successive triblocks. FIG. 10D illustrates the third triblock, and FIG. 10E illustrates the fourth. Note that the fourth triblock filled up before reaching its memory capacity. FIG. 10F illustrates the fifth triblock, FIG. 10G illustrates the sixth triblock, and FIG. 10H illustrates the final triblock and the resulting candidate triblock layout.

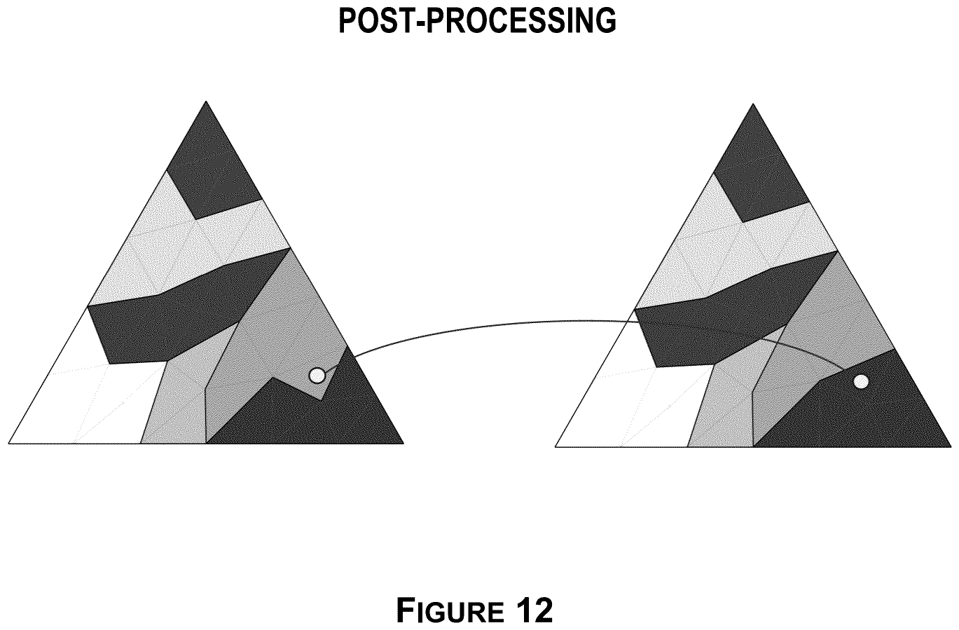

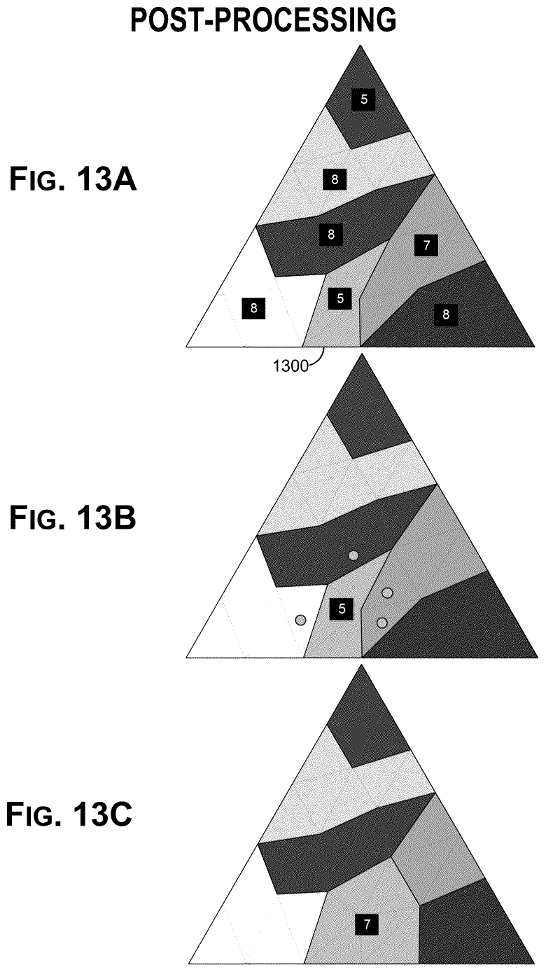

FIGS. 12 and 13 illustrate example techniques that may be used (e.g., by the solver) to generate candidate triblock layouts by adjusting triangle assignments or triblock boundaries from the triblock layout illustrated in FIG. 10H. More specifically, in some embodiments, the solver may perform post-processing to check a candidate triblock layout for any crevices and determine whether a triangle forming a crevice in a triblock pattern may be shifted to the adjacent triblock to fill in the crevice. FIG. 12 illustrates such an example in which the triangle illustrated with the circle is shifted to the adjacent triblock to fill in a crevice.

Additionally (e.g., after filling in crevices) or alternatively, the solver may perform post-processing to determine whether a candidate triblock layout includes any unfilled triblocks that could grow, and may recursively grow and test unfilled triblocks to determine whether the modification improves the (e.g., expected) traversal time. FIGS. 13A-13C illustrate an example technique that may be used (e.g., by the solver) for recursively growing triangle blocks in a triangle block layout. FIG. 13A represents a candidate triblock layout with different triblocks illustrated with different shades of grey and the number of vertices in each triblock. Notice how triblock 1300 has five allocated vertices, which is less than the designated maximum of 8 in this example. As such, the solver may recursively identify and evaluate one or more modifications that grow the triblock 1300 and determine whether any modification improves the traversal time. FIG. 13B illustrates adjacent triangles (illustrated with corresponding circles) that could be shifted to triblock 1300. As such, the solver may select (e.g., randomly) one of the neighbors, evaluate the resulting updated triblock (or corresponding triblock layout), and if it does not improve the traversal time, the solver may identify and evaluate another candidate modification shifting a second neighbor into the triblock 1300, repeating the process (e.g., until reaching the maximum number of vertices, a designated number of iterations, a designated number of vertex or triangle swaps, etc.). FIG. 13C illustrates an example in which the triblock 1300 consumed two neighboring triangles and added two vertices. The process may be repeated to recursively grow any triblock with less than the maximum number of vertices (e.g., including cannibalized triblocks). These are meant simply as examples, and other variations may be implemented within the scope of the present disclosure.

As such, the solver may generate and evaluate any number of candidate triblock layouts, and may track the top N optimized triblock layouts for each designated pattern and corresponding compression level. For example, the solver may iteratively generate candidate triblock layouts using different strategies in a stochastic process (e.g., that uses some random or probabilistic decision making), running in a loop for a designated number of iterations to generate different candidate triblock layouts. As such, the solver may track and identify the triblock layout that results in the lowest cost as the optimized triblock layout for a given pattern of triangles and corresponding compression level. Taking rectangular grids as an example, some embodiments may generate an optimized triblock layout for multiple (e.g., all possible) rectangular grid sizes (e.g., from 1×1 up to a maximum edge resolution such as 11×11), including non-square grid sizes (e.g., 3×8 or 9×7). Generally, layouts may be generated for any type of cluster pattern (e.g., rectangular grids, triangular grids, irregular triangular meshes, meshes with irregular shapes, etc.) and corresponding compression level.

In some embodiments, the solver may use each triblock layout (e.g., the top N optimized triblock layouts) for each supported pattern (e.g., and compression level) to generate a corresponding optimized range assignment partitioning or grouping the triangles represented by the pattern into ranges (or leaf nodes) of a BVH. More specifically, the solver may compute an optimized range assignment by iteratively generating candidate range assignments, evaluating each range assignment based on one or more metrics that estimate, model, approximate, or otherwise quantify the anticipated traversal time, and tracking the candidate range assignment (or top N) that optimizes the one or more metrics.

For example, the solver may compute a cost for a candidate range assignment based on estimates of the relative probability the range is accessed (e.g., the ratio of the area of the triangles in the range to the area of the triangles in the cluster, averaged through some number of rotations to estimate or otherwise account for the average spatial coverage of the triangles), the anticipated number of cache line loads needed to test the range (e.g., which may correspond to the number of triblocks used to store the triangles assigned to the range), the number of anticipated iterations in a ray intersection test on the triangles in the candidate range (e.g., which may be based on a hardware limit on the number of triangles that can be simultaneously tested per warp or thread group during a ray intersection test on that range, such that the number of anticipated iterations may correspond to an integer division of the number of triangles in a candidate range by the hardware limit on the number of triangles that can be simultaneously tested per warp or thread group), and/or otherwise.

In an example embodiments, the cost of a candidate range assignment may be computed as:

$${\sum }_{r} P ( r ) * [ {IC}_{k} ( r ) + β * M C ( r ) ]$$

where r represents ranges, P(r) represents the relative probability the range is accessed, ICₖ(r) represents an integer division of the number of triangles in a candidate range by the hardware limit on the number of triangles that can be simultaneously tested per warp or thread group, MC(r) represents the anticipated number of cache line loads needed to test the range (e.g., or the number of triblocks used to store the triangles assigned to the range), and β is an interpolant between IC and MC. Another way to think of this equation is that it effectively quantifies a memory (or load) cost and weights it (in some embodiments) by a surface area heuristic.

For example, the solver may assign each range a cost of the number of groups of 4 (or 8, 12, 16, depending on the applicable hardware limit) triangles assigned to that the range (ICₖ, where k is 4) plus the number of triblocks the range spans (MC times some β such as 1), added together and multiplied by the area of the axis-aligned bounding box for the range. The cost of each of the (e.g., 12, 10, etc.) ranges may be summed to get an overall cost, which may be divided or normalized by the total area of the cluster of triangles represented by the pattern (effectively modeling the relative probability P(r) the range will be accessed. Taking an example range that spans two triblocks, has 13 triangles, and fits in a 3×3 box in a 10×10 grid, MC(r) may be set to 2 (for two triblocks), ICₖ(r) may be set to 4 (an integer division or using the ceiling function to divide 13/4), and P(r) may be set to (3×3)/(10×10)=0.09. Setting β to 1, an example cost for this range may be computed as 0.09*(4+1.0*2)=0.09*6=0.54. The process may be repeated for all (e.g., 12) ranges and summed to generate a representation of much time the ranges will take to evaluate. This is meant simply as an example, and other ways of assigning costs to candidate range assignments (e.g., by testing and measuring the traversal time of candidate range assignments for the triangles in a triblock layout) may be implemented within the scope of the present disclosure. As such, the solver may generate candidate range assignments (as described in more detail below), and the solver may compute the cost of each range in a candidate range assignment and sum over all ranges to generate a cost for that candidate range assignment.

As explained in more detail below, in some embodiments, the solver may order the triangles in a corresponding optimized triblock layout using a candidate triangle ordering, the solver may order a candidate range assignment according to the candidate triangle ordering, and the solver may generate and evaluate candidate modifications that shift triblocks or individual triangles of triblocks from one range to an adjacent one in the list to identify any modifications that improve the one or more metrics, and the process may be repeated using any number and type of candidate triangle orderings. Accordingly, in some embodiments (e.g., that shift triblocks or individual triangles of triblocks from one range to an adjacent one in an ordered list of ranges), the order of triangles may impact the efficiency of the optimization routine. For example, since adjusting the locations of the partition boundaries or divisions in the list of ranges should serve to spatially regroup the triangles that are assigned to corresponding ranges, it may be desirable to use a triangle ordering that keeps consecutive triangles spatially near each other such that shifting triangles across adjacent ranges is likely to maintain a closer spatial grouping of triangles and help the optimization routine identify better range assignments faster. Nevertheless, some triangle orderings may end up yielding optimal range assignments, so a variety of triangle orderings may be generated and evaluated.

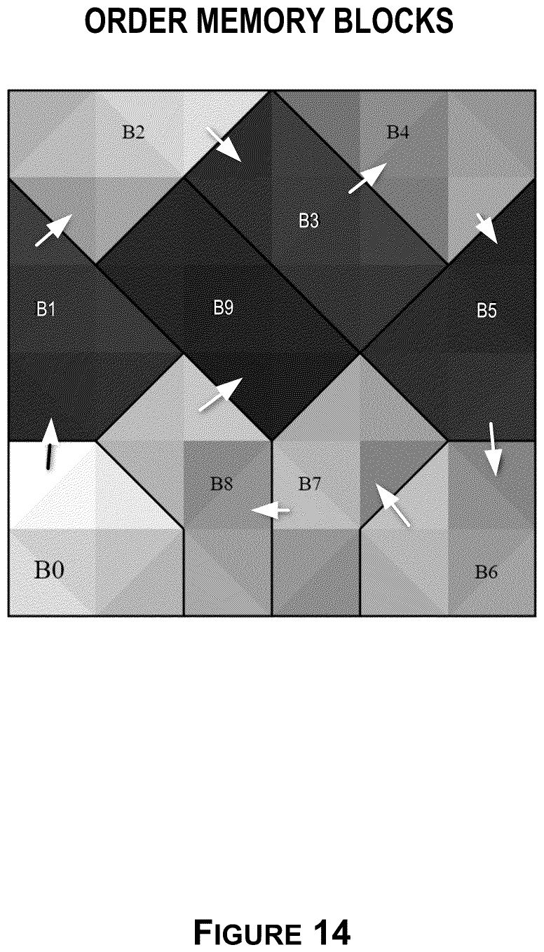

As such, taking an example optimized triblock layout, the solver may order the triblocks in that layout in any suitable way (e.g., ordering triblocks in the order in which they were grown, ordering triblocks along a path that minimizes the path traveled to the triblock centroids, ordering triblocks in an inwards or outwards spiral order, ordering triblocks in a scan line order, ordering triblocks according to a sequence defined by a space-filling curve, zigzagging, etc.). FIG. 14 illustrates an example triangle block ordering staring at triblock B0 and following a path along the illustrated arrows an inwards spiral order. In some embodiments, the solver may generate a triangle ordering by expanding the triblock ordering to include an ordering of the triangles in each triblock. The triangles in any given triblock may be ordered in any suitable way (e.g., ordering the triangles in the order in which they were added to the triblock, ordering triangles along a path that minimizes the path traveled to the triangle or triblock centroids, ordering triangles in an inwards or outwards spiral order, ordering triangles in a scan line order, ordering triangles according to a sequence defined by a space-filling curve, zigzagging, etc.).

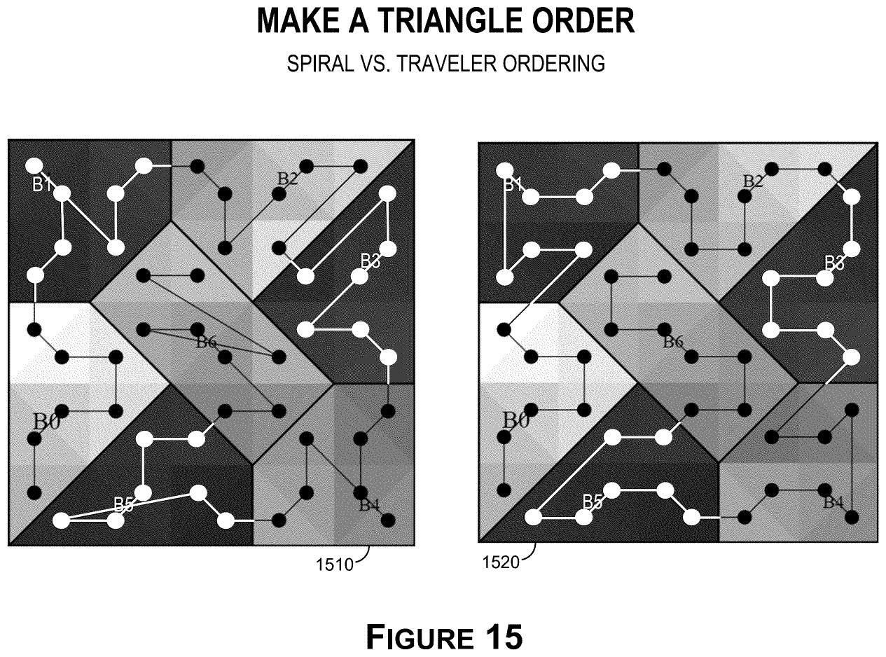

FIG. 15 illustrates example triangle orderings, including a spiral ordering 1510 and a traveler ordering 1520 (that minimizes the path traveled to the triangle centroids, also known as the traveling salesmen). Taking the spiral ordering 1510 as an example, for each triangle in a triblock, the solver may use its centroid to calculate its distance from the centroid of the previous and next triblock in the order. The solver may place the triangles in the triblock in two groups, either closer to the previous or next triblock, and then sort the triangles in each group by distance. Taking the traveler ordering 1520 as an example, the solver may walk each triblock in some number of different orders (e.g., left-to-right in a row, then the next row up goes right-to-left; starting right-to-left, then up; starting left-to-right, then down; four other possible corresponding column-major orders), and may select the order that minimizes the path traveled from the last triangle in the previous triblock to any neighboring triangle in the next triblock.

In some embodiments, the solver may generate and evaluate one or more candidate modifications to a candidate triangle ordering. For example, chains (e.g., four nodes) in a candidate triangle ordering may be swapped and used when the swap shortens the path. In some embodiments, each quad in a grid may be examined, and if the quad's two triangles are both in the same triblock, the solver may evaluate a candidate modification that swaps the order of these two triangles and determine if the path through this quad would be shortened by swapping the order of the two triangles.

As such, the solver may associate one or more candidate triblock orderings and/or candidate triangle orderings with an optimized triblock layout, and may use the candidate ordering(s) in various ways during the optimization (e.g., as explained in more detail below).

In some embodiments, the solver may use a variety of techniques to generate candidate range assignments for the triangles represented by a triblock layout. In some embodiments, the manner in which candidate range assignments are generated depends on the relationship between the number of triblocks in a triblock layout and the number of available or target ranges to fill (e.g., a designated maximum number of ranges (leaf nodes) for a BVH or CLAS over a cluster of triangles—or a designated maximum number of ranges supported by each complet (intermediate node) of a BVH—such as 10 or 12).

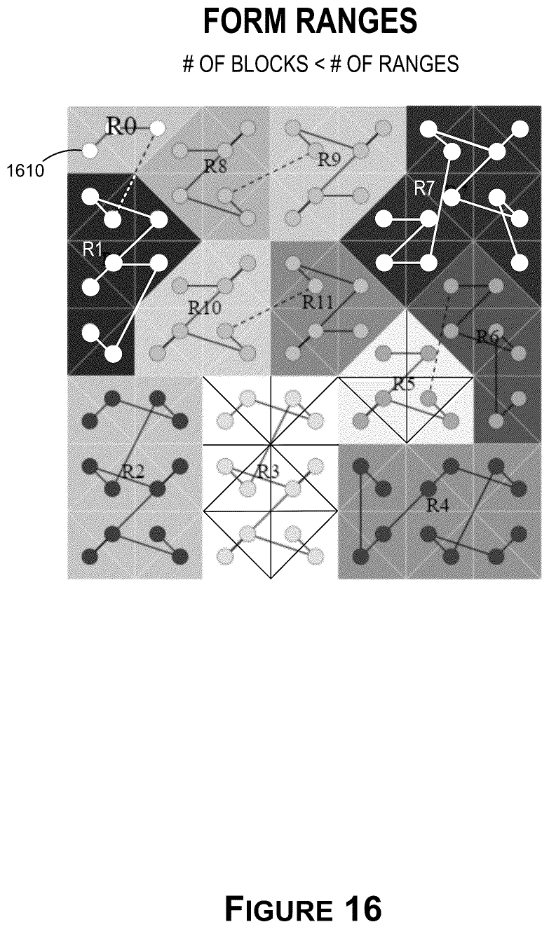

For example, if there are fewer triblocks than available ranges, the solver may generate a candidate range assignment that assigns one triblock per range (assign the triangles represented by each triblock to a corresponding range), or may split the triangles represented by a triblock into multiple ranges. In some embodiments, the solver may generate and evaluate a baseline candidate range assignment that assigns one triblock per range (e.g., using a cost metric that quantifies the anticipated time cost of traversal), may generate and evaluate candidate modifications to the baseline candidate range assignment that split each triblock into all its possible groupings of two sets of triangles, may compare the cost of each candidate modification (representing a candidate split of a triblock) to the cost of the (unsplit) baseline candidate range assignment, and identify the candidate modification that maximizes the reduction in cost as the (e.g., subsequent baseline) candidate range assignment. The process may be repeated to split multiple triblocks (e.g., until the number of triblocks in a range assignment equals the number of available ranges). In some embodiments, the solver may limit triblock splits to some designated maximum number of ranges (e.g., do not split individual triblocks into three or more ranges, in favor of keeping some empty ranges when there are more than twice as many triblocks as available ranges). FIG. 16 illustrates an example range assignment using 12-vertex-max triblocks on a 7×7 grid, where there are fewer triblocks (8) than ranges (12). Ranges are shown by background shading and labeled “R#”, triblocks by shading of dots representing triangles connected in a single path, and dashed lines for where a triblock is split into two ranges (e.g., triblock 1610 is split between R0 and R1). As such, the solver may generate and evaluate various candidate range assignments, and may identify and track the optimized candidate range assignment that results in the lowest time cost (or measured time) any number of iterations.

If there are the same number of triblocks in a triblock layout as there are available ranges, the solver may generate an optimized range assignment by assigning one triblock per range (assigning the triangles represented by each triblock in an optimized triblock layout to a corresponding range).

If there are more triblocks in a triblock layout than there are available ranges (e.g., meaning at least one range will span a triblock boundary), the solver may generate an optimized range assignment by iteratively creating a candidate ordered list of triblocks, testing candidate range assignments that divide the candidate ordered list of triblocks into ranges without splitting triblocks, and identifying and tracking an optimized range assignment (and triblock ordering) that results in the lowest time cost (or measured time).

The solver may generate triblock ordering in various ways. In some embodiments, the solver may generate a candidate triblock ordering for an optimized triblock layout (e.g., using any of the techniques described herein), may associate the candidate triblock ordering with a corresponding pattern of triangles and compression level, and may divide or partition a representation of the candidate triblock ordering into corresponding ranges. In some embodiments, the solver may use a candidate triblock ordering corresponding to the order in which the triblocks were sequentially filled with triangles in a corresponding optimized triblock layout, along a path that minimizes the path traveled to the triblock centroids, in an inwards or outwards spiral order, in a scan line order, according to a sequence defined by a space-filling curve, along a zigzagged path, and/or otherwise.

In some embodiments, the solver identifies a candidate triblock ordering using a clustering technique to merge or cluster pairs of triblocks that minimize a designated cost. More specifically, the solver may identify candidate triblock merges of pairs of sets of triblocks, and may merge pairs of sets of triblocks that minimize a cost that quantifies the spatial coverage (e.g., the average surface area of axis-aligned bounding boxes of rotated triblock patterns) or a change in the spatial coverage. For example, the solver may identify every possible unique pair of sets of triblocks starting with one triblock per set (e.g., taking an example triblock layout with N triblocks, by making an N×N matrix where each row and column represents a corresponding triblock), computing a cost to merge each possible pair of triblock sets (e.g., populating the entries in half of the matrix with the computed cost to merge the pair of triblocks represented by a corresponding row and column), merging the pair with the lowest cost, and repeating (e.g., up to some designated limit such as 20 attempts, cycling through supported ordering strategies so different triblock orders are generated and tested, etc.).

The solver may assign a cost to a given candidate triblock merge based on the spatial coverage of the unmerged triblocks, the spatial coverage of the merged triblocks, the number of triblocks in the candidate triblock merge, and/or otherwise. For example, the solver may assign a cost to a candidate triblock merge that quantifies the spatial coverage of the merged triblocks (e.g., the average surface area of axis-aligned bounding boxes of the triangle pattern in the merged triblocks rotated to various angles), such that the solver identifies candidate triblock merges that minimize the spatial coverage of the merged triblocks. In some embodiments, the solver assigns a cost to a candidate triblock merge that computes the spatial coverage (e.g., average surface area of rotated axis-aligned bounding boxes) of the merged triblocks, multiplies by the number of triblocks combined, and divides by the sum of the computed spatial coverages (e.g., average surface area of rotated axis-aligned bounding boxes) of the unmerged triblocks (or subtracts a weighted sum of the spatial coverages of the unmerged triblocks), such that the solver identifies candidate triblock merges that minimize the change in spatial coverage resulting from merging the triblocks.

As such, the solver may compute costs for each possible pair of sets of triblocks and merge the pair with the lowest cost (e.g., using a random selection as a tie-break), and the process may be repeated (replacing the unmerged triblock sets with the merged triblock set and identifying and executing merges of pairs of triblock sets) until the number of sets equals the number of ranges. Accordingly, the solver may generate a representation of the resulting triblock ordering.

In some embodiments, the solver identifies a candidate triblock ordering using a traveling salesmen approach. For example, the solver may generate a path from triblock to nearest triblock, minimizing the path traveled. In some embodiments, the solver may minimize the path traveled, favoring triblocks that border the exterior of the pattern of triangles, or favoring these as a tie-break when two or more triblock distances are within a designated threshold interval. The solver may vary the starting corner, so different triblocks are used. In some embodiments, the solver may generate and evaluate one or more candidate modifications to a candidate triangle ordering. For example, chains (e.g., four nodes) in a candidate triangle ordering may be swapped and used when the swap shortens the path.

As such, the solver may iteratively generate candidate triblock orderings, divide the candidate triblock orderings into ranges (without splitting triblocks), group neighboring triblocks that reduce or minimize the time cost, and track the optimized range assignment that results in the lowest time cost (or measured time) for the candidate triblock ordering. Taking a candidate triblock ordering, the solver may identify each possible pair of neighboring triblocks in the ordered list of triblocks, evaluate each pair using a cost metric that quantifies the anticipated time cost of traversal, identify the pair of neighboring triblocks that results in the lowest cost, and group them into a common range. The solver may repeat the process until the number of groups of triblocks equals the number of ranges, and may generate a representation of the resulting candidate or optimized range assignment.

In some embodiments, the solver may adjust a candidate or optimized range assignment by identifying a corresponding ordered list of triblocks (or triangles) that was divided into ranges, shift triblocks or individual triangles of triblocks from one range to a neighboring range in the ordered list, evaluate each candidate adjustment (e.g., using a cost metric that quantifies the anticipated time cost of traversal), and track and identify an adjusted range assignment that lowers the cost as the optimized range assignment for a given optimized triblock layout. For example, when there are 13-23 triblocks and 12 ranges, the solver may assign either 1 or 2 triblocks in a range, or when there are with 37-47 triblocks, 3 or 4 triblocks in a range. By shifting a triblock, the solver's search may be widened to include the possibility of 2 to 5 triblocks in a range when there are with 37-47 triblocks. In some embodiments, the solver may test shifting one triangle to a neighboring range, then two, then three, etc. The solver may try shifting triangles that neighbor any of the triangles in a neighboring range (in space), triangles that neighbor any shifted triangle, or triangles that neighbor a range in an ordered list.

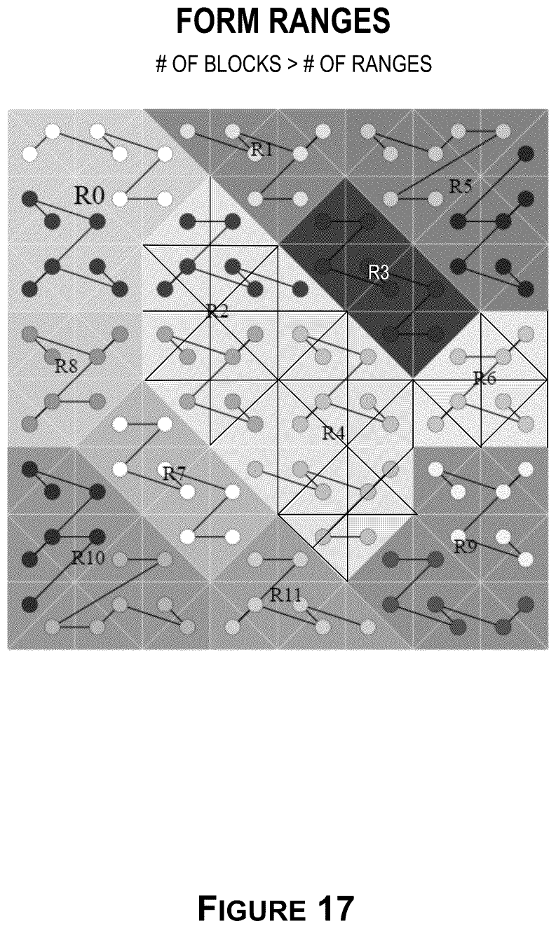

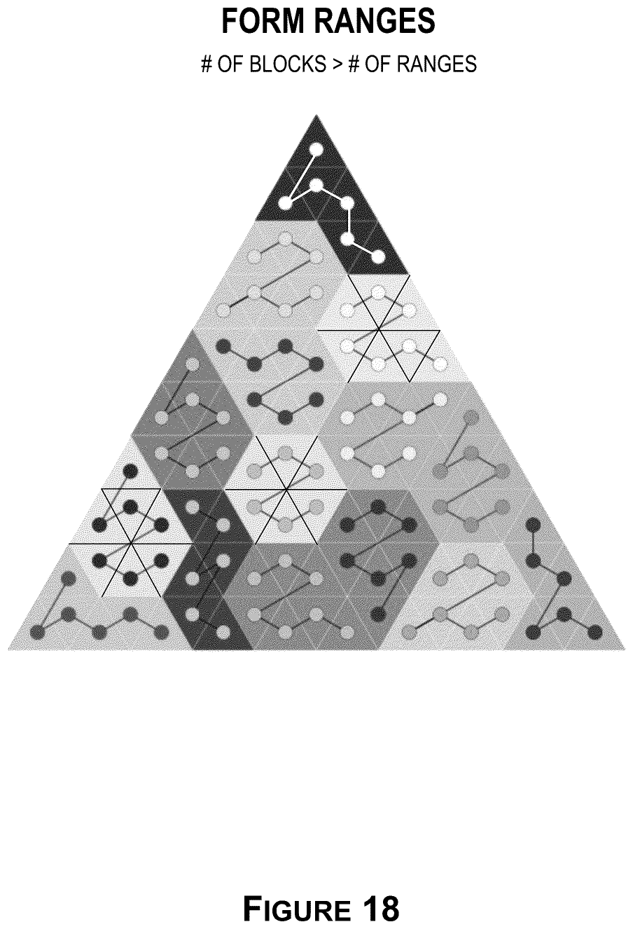

As such, the solver may iteratively generate candidate range assignments using different strategies (e.g., triblock orderings, costs, etc.) in a stochastic process (e.g., that uses some random or probabilistic decision making), for example, running in a loop for a designated number of iterations to generate different candidate range assignments. The solver may track and identify the candidate range assignment that results in the lowest cost as the optimized range assignment for a given optimized triblock layout. FIG. 17 illustrates an example range assignment for a rectangular grid when the number of triangle blocks is greater than the number of available ranges, and FIG. 18 illustrates an example range assignment for a triangular grid.

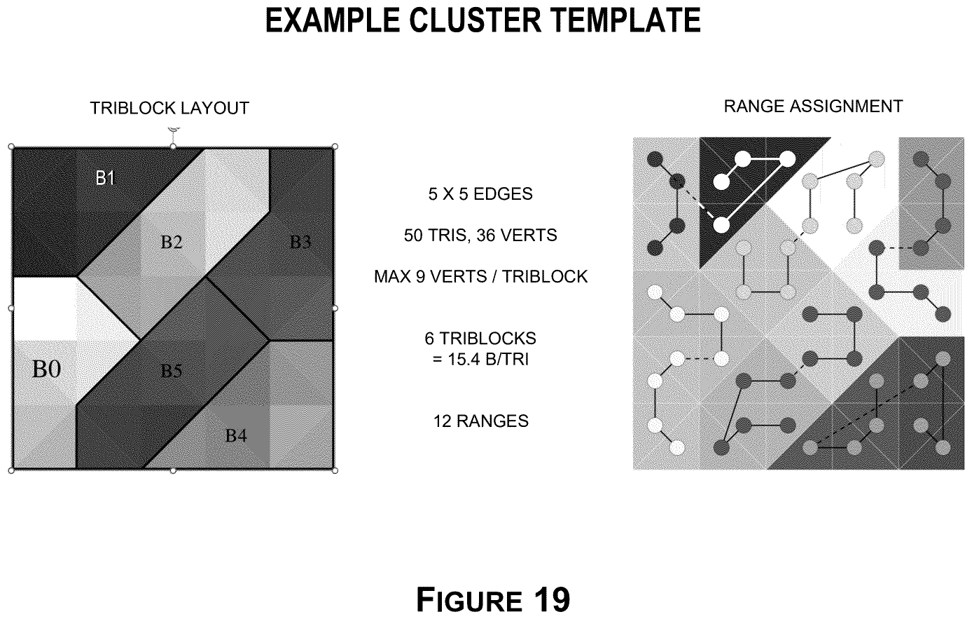

As such, the solver may iteratively optimize a triblock layout and/or range assignment for each supported pattern of triangles and a corresponding supported compression level. The solver may use the optimized triblock layout and/or range assignment for a supported pattern and compression level to generate a corresponding cluster template for that pattern and compression level, and the cluster template may be represented in any suitable manner. FIG. 19 illustrates an example cluster template for a 5×5 rectangular grid of 50 triangles and 36 vertices, using a maximum of 9 vertices per triblock. In this example, the cluster template groups the 50 triangles and corresponding vertices into 6 triblocks and 12 ranges.

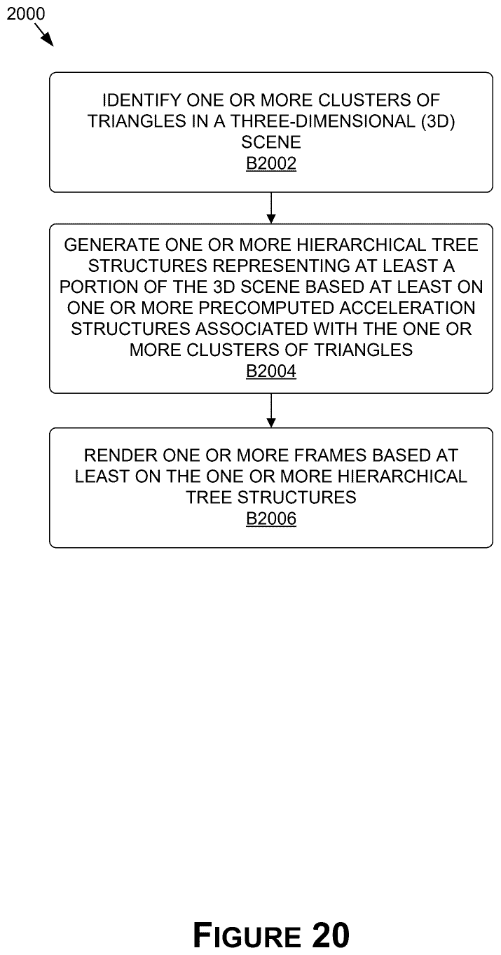

Now referring to FIGS. 20-24, each block of methods 2000-2400, described herein, comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a standalone application, a standalone service, a hosted service (standalone or in combination with another hosted service), or a plug-in to another product, to name a few. In addition, the methods are described, by way of example, with respect to the ray tracing pipeline 100 of FIG. 1 or the cluster optimization solver described with respect to FIGS. 5-19. However, this method may additionally or alternatively be executed by any one system, or any combination of systems, including, but not limited to, those described herein.

FIG. 20 is a flow diagram illustrating a method 200 of generating one or more hierarchical tree structures based at least on one or more precomputed acceleration structures associated with the one or more clusters of triangles, in accordance with some embodiments of the present disclosure. The method 2000, at block B2002, includes identifying, based at least on tessellation, one or more clusters of triangles in a three-dimensional (3D) scene. For example, with respect to the ray tracing pipeline 100 of FIG. 1, the geometry subdivision control component 120 and/or the geometry subdivision component 140 may use any known tessellation technique as a pre-processing step to increase the geometric detail of one or more 3D models (e.g., meshes) representing objects or parts of the scene and/or create smoother surfaces before ray tracing, may use the tessellation technique to identify clusters of triangles that form supported pattern(s), such as regular grids or irregular meshes, and may issue command(s) instructing the device 130 (e.g., via an API that triggers the CLAS build component 170) to build a BVH (a CLAS) over each of one or more identified clusters.

The method 2000, at block B2004, includes generating one or more hierarchical tree structures representing at least a portion of the 3D scene based at least on one or more precomputed acceleration structures associated with the one or more clusters of triangles. For example, with respect to the ray tracing pipeline 100 of FIG. 1, the CLAS build component 170 may build any number of CLASes over any number of corresponding clusters of triangles using the cluster templates 175. As such, the geometry subdivision control component 120 and/or the geometry subdivision component 140 may issue command(s) for the device 130 to build a BVH (e.g., a bottom-level acceleration structure (BLAS), a top-level acceleration structure (TLAS), etc.) over these CLAS(es), and the BVH build component 180 may use any known technique to build a BVH (e.g., top-down, bottom-up) on top of a set of clusters of triangles, but using the CLASes at the bottom level instead of building them online.

The method 2000, at block B2006, includes rendering one or more frames based at least on the one or more hierarchical tree structures. For example, with respect to the ray tracing pipeline 100 of FIG. 1, the ray tracing component 190 may use any known technique to render a frame using the BVH.

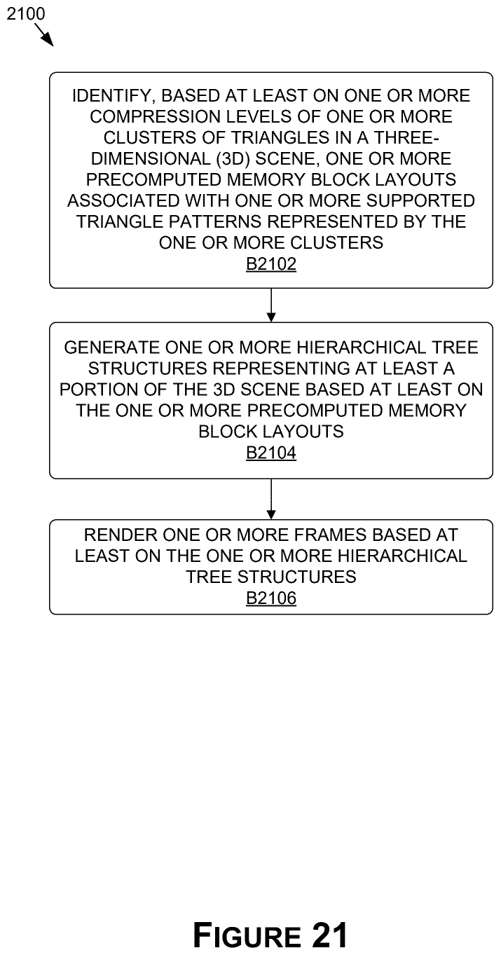

FIG. 21 is a flow diagram illustrating a method 2100 of generating one or more hierarchical tree structures based at least on one or more precomputed memory block layouts identified based at least on one or more compression levels, in accordance with some embodiments of the present disclosure. The method 2100, at block B2102, includes identifying, based at least on one or more compression levels of one or more clusters of triangles in a three-dimensional (3D) scene, one or more precomputed memory block layouts associated with one or more supported triangle patterns represented by the one or more clusters. For example, with respect to the ray tracing pipeline 100 of FIG. 1, the geometry subdivision control component 120 and/or the geometry subdivision component 140 may issue command(s) that trigger the CLAS build component 170 (or some other component of the native device code 160) to identify corresponding precomputed cluster templates 175 including precomputed memory block layouts. In some embodiments, the command(s) may identify applicable compression level, or the native device code 160 may identify one (e.g., on the fly by inspecting the vertex positions in a given cluster). As such, the native device code 160 (e.g., an API or some other component of a hardware interface software) may look up a corresponding cluster template (e.g., indexed by the number of unique bits, or the number of discarded or truncated bits).

The method 2100, at block B1104, includes generating one or more hierarchical tree structures representing at least a portion of the 3D scene based at least on the one or more precomputed memory block layouts. For example, with respect to the ray tracing pipeline 100 of FIG. 1, the CLAS build component 170 may build any number of CLASes over any number of corresponding clusters of triangles using the cluster templates 175. As such, the geometry subdivision control component 120 and/or the geometry subdivision component 140 may issue command(s) for the device 130 to build a BVH (e.g., a bottom-level acceleration structure (BLAS), a top-level acceleration structure (TLAS), etc.) over these CLAS(es), and the BVH build component 180 may use any known technique to build a BVH (e.g., top-down, bottom-up) on top of a set of clusters of triangles, but using the CLASes at the bottom level instead of building them online.

The method 2100, at block B1106, includes rendering one or more frames based at least on the one or more hierarchical tree structures. For example, with respect to the ray tracing pipeline 100 of FIG. 1, the ray tracing component 190 may use any known technique to render a frame using the BVH.

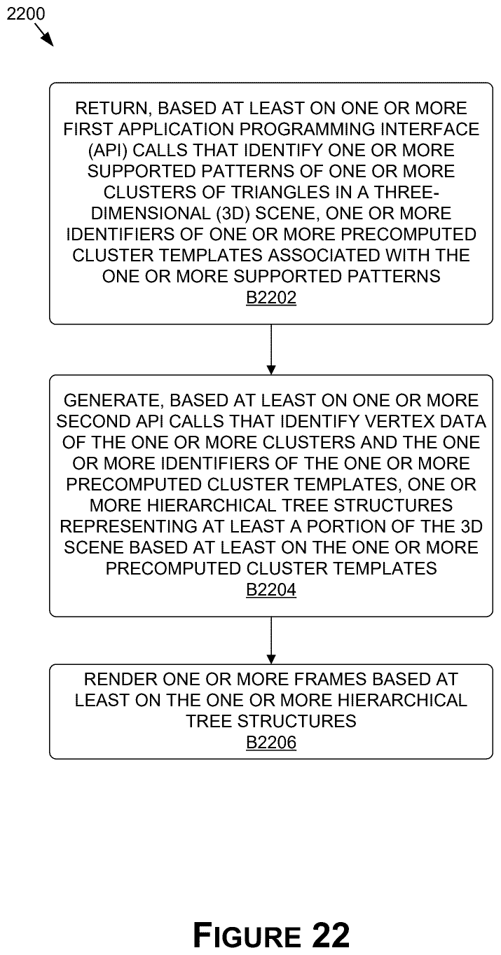

FIG. 22 is a flow diagram illustrating a method 2200 of generating one or more hierarchical tree structures based at least on one or more API calls that identify one or more precomputed cluster templates, in accordance with some embodiments of the present disclosure. The method 2200, at block B2202, includes returning, based at least on one or more first application programming interface (API) calls that identify one or more supported patterns of one or more clusters of triangles in a three-dimensional (3D) scene, one or more identifiers of one or more precomputed cluster templates associated with the one or more supported patterns. For example, with respect to the ray tracing pipeline 100 of FIG. 1, the geometry subdivision control component 120 and/or the geometry subdivision component 140 may issue one or more initial API calls (e.g., using a first type of API call) identifying a supported pattern (e.g., using an ID number or tag describing the pattern) formed by a cluster of triangles, and the API (or some other component of the hardware interface software or native device code 160) may use the identifier to look up and return a corresponding identifier for a set of one or more of the cluster templates 175 that are associated with that pattern (identifier).

The method 2200, at block B2104, includes generating, based at least on one or more second API calls that identify vertex data of the one or more clusters and the one or more identifiers of the one or more precomputed cluster templates, one or more hierarchical tree structures representing at least a portion of the 3D scene based at least on the one or more precomputed cluster templates. For example, with respect to the ray tracing pipeline 100 of FIG. 1, the geometry subdivision control component 120 and/or the geometry subdivision component 140 may allocate a corresponding amount of memory and issue one or more subsequent API calls (e.g., using a second type of API call) identifying (e.g., including the identifier for) the applicable cluster template (or set of cluster templates), a list of vertex positions in the cluster, a reference or pointer to the location of the allocated memory for the cluster, and/or a representation of the compression level of the vertex positions. The API (or some other component of the hardware interface software or native device code 160) may look up the applicable cluster template, and the CLAS build component 170 may build any number of CLASes over any number of corresponding clusters of triangles using the cluster templates 175. As such, the geometry subdivision control component 120 and/or the geometry subdivision component 140 may issue command(s) for the device 130 to build a BVH (e.g., a bottom-level acceleration structure (BLAS), a top-level acceleration structure (TLAS), etc.) over these CLAS(es), and the BVH build component 180 may use any known technique to build a BVH (e.g., top-down, bottom-up) on top of a set of clusters of triangles, but using the CLASes at the bottom level instead of building them online.

The method 2200, at block B2206, includes rendering one or more frames based at least on the one or more hierarchical tree structures. For example, with respect to the ray tracing pipeline 100 of FIG. 1, the ray tracing component 190 may use any known technique to render a frame using the BVH.

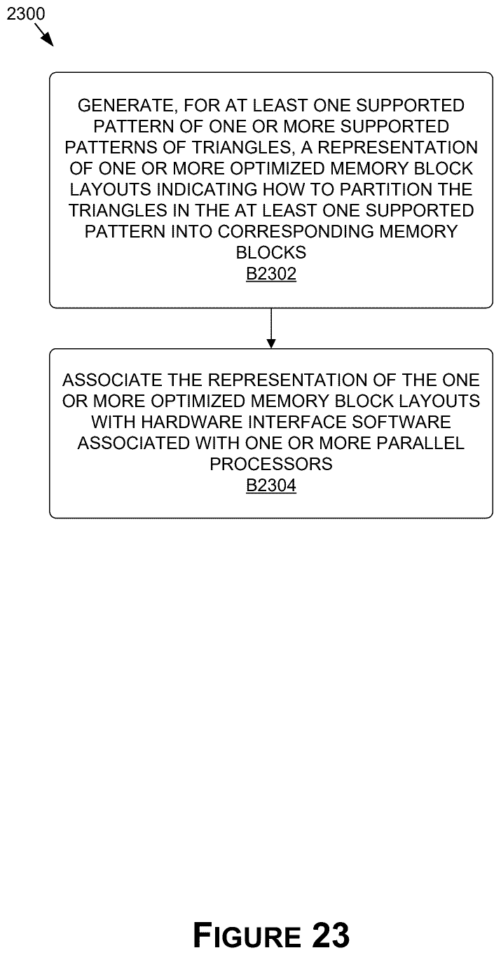

FIG. 23 is a flow diagram illustrating a method 2300 of generating one or more optimized memory block layouts, in accordance with some embodiments of the present disclosure. The method 2300, at block B2302, includes generating, for at least one supported pattern of one or more supported patterns of triangles, a representation of one or more optimized memory block layouts indicating how to partition the triangles in the at least one supported pattern into corresponding memory blocks. For example, with respect to the cluster optimization solver described with respect to FIGS. 5-13, the solver may generate and evaluate any number of candidate triblock layouts, and may track one or more optimized triblock layouts for each designated pattern and corresponding compression level. For example, the solver may iteratively generate candidate triblock layouts using different strategies in a stochastic process (e.g., that uses some random or probabilistic decision making), running in a loop for a designated number of iterations to generate different candidate triblock layouts. As such, the solver may track and identify the triblock layout that results in the lowest cost as the optimized triblock layout for a given pattern of triangles and corresponding compression level.

The method 2300, at block B2304, includes associating the representation of the one or more optimized memory block layouts with hardware interface software associated with one or more parallel processors. For example, with respect to the cluster optimization solver described with respect to FIGS. 5-13, the solver may use an optimized triblock layout for a supported pattern and compression level to generate a corresponding cluster template for that pattern and compression level, and the cluster template may be represented in any suitable manner.

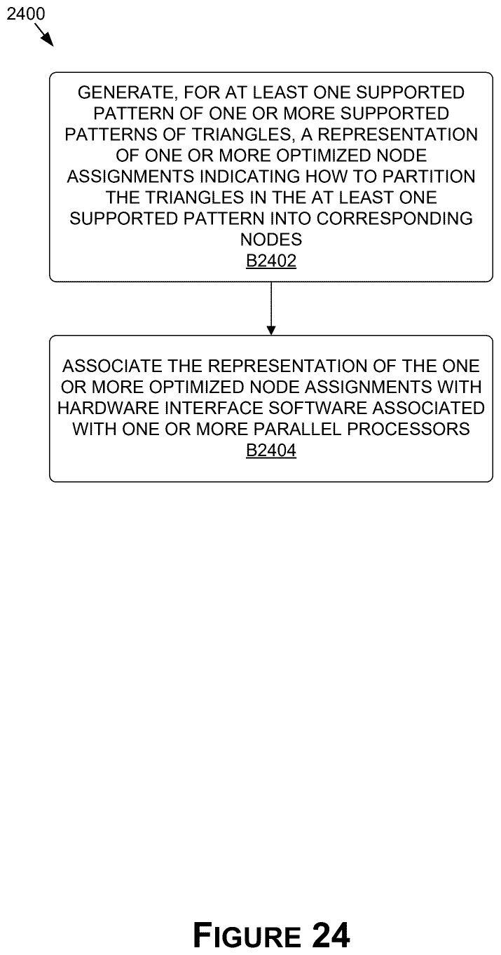

FIG. 24 is a flow diagram illustrating a method 2400 of generating one or more optimized node assignments, in accordance with some embodiments of the present disclosure. The method 2400, at block B2402, includes generating, for at least one supported pattern of one or more supported patterns of triangles, a representation of one or more optimized node assignments indicating how to partition the triangles in the at least one supported pattern into corresponding nodes of a hierarchical tree structure. For example, with respect to the cluster optimization solver described with respect to FIGS. 14-19, the solver may iteratively generate candidate node (range) assignments using different strategies (e.g., triblock orderings, costs, etc.) in a stochastic process (e.g., that uses some random or probabilistic decision making), for example, running in a loop for a designated number of iterations to generate different candidate range assignments. The solver may track and identify the candidate range assignment that results in the lowest cost as the optimized range assignment for a given optimized triblock layout.

The method 2400, at block B4104, includes associating the representation of the one or more optimized node assignments with hardware interface software associated with one or more parallel processors. For example, with respect to the cluster optimization solver described with respect to FIGS. 14-19, the solver may use node (range) assignment for a supported pattern and compression level to generate a corresponding cluster template for that pattern and compression level, and the cluster template may be represented in any suitable manner.

The systems and methods described herein may be used for a variety of purposes, by way of example and without limitation, for machine control, machine locomotion, machine driving, synthetic data generation, model training, perception, augmented reality, virtual reality, mixed reality, robotics, security and surveillance, simulation and digital twinning, autonomous or semi-autonomous machine applications, deep learning, environment simulation, data center processing, conversational AI, light transport simulation (e.g., ray-tracing, path tracing, etc.), generative AI applications, language model applications (e.g., large language models (LLMs), vision language models (VLMs), etc.), collaborative content creation for 3D assets, cloud computing and/or any other suitable applications.

For example, the present techniques (e.g., the ray tracing pipeline 100 of FIG. 1, some portion thereof, etc.) may be used in various robotics implementations (e.g., by a robot navigating a surface or objects in a warehouse), may be used within a simulation such as NVIDIA DRIVE Sim™ (e.g., using virtual sensors and/or ray-tracing to generate simulated input data, using real and/or simulated input data to generate simulated ground truth data, using real and/or simulated data to train or validate a neural network such as those described herein or a classical machine learning model, etc.), and/or otherwise. Generally, a simulation may be used to create simulated datasets that replicate various real-world conditions (e.g., that may be difficult or dangerous to observe in the real world), and training or validating a neural network or classical machine learning model within a simulation may expose these models to a range of (e.g., rare or dangerous) scenarios in a controlled and safe environment.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medial systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems for performing generative AI operations, systems implemented at least partially in a data center, systems for performing conversational AI operations, systems implementing one or more language models—such as one or more large language models (LLMs), one or more vision language models (VLMs), one or more multi-modal language models, etc., systems for hosting real-time streaming applications, system for presenting one or more of virtual reality content, augmented reality content, or mixed reality content, systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples—such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs—such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

### Parallel Processing Architecture

FIG. 25 illustrates a parallel processing unit (PPU) 2500, in accordance with an embodiment. In an embodiment, the PPU 2500 is a multi-threaded processor that is implemented on one or more integrated circuit devices. The PPU 2500 is a latency hiding architecture designed to process many threads in parallel. A thread (e.g., a thread of execution) is an instantiation of a set of instructions configured to be executed by the PPU 2500. In an embodiment, the PPU 2500 is a graphics processing unit (GPU) configured to implement a graphics rendering pipeline for processing three-dimensional (3D) graphics data in order to generate two-dimensional (2D) image data for display on a display device such as a liquid crystal display (LCD) device. Additionally or alternatively, the PPU 2500 may be utilized for general-purpose computations. While certain embodiments focus on features of the example parallel processing unit described herein, this is meant simply as an example, and other processors may be implemented within the scope of the present disclosure.

One or more instances of the PPU 2500 may be configured to accelerate thousands of High Performance Computing (HPC), data center, and/or machine learning applications. The PPU 2500 may be configured to accelerate numerous deep learning systems and/or other applications, such as autonomous vehicle platforms, deep learning, high-accuracy speech, image, and text recognition systems, intelligent video analytics, molecular simulations, drug discovery, disease diagnosis, weather forecasting, big data analytics, astronomy, molecular dynamics simulation, financial modeling, robotics, factory automation, real-time language translation, online search optimizations, and personalized user recommendations, to name a few examples.

As shown in FIG. 25, the PPU 2500 includes an Input/Output (I/O) unit 2505, a front end unit 2515, a scheduler unit 2520, a work distribution unit 2525, a hub 2530, a crossbar (Xbar) 2570, one or more general processing clusters (GPCs) 2550, and one or more partition units 2580. The PPU 2500 may be connected to a host processor or other PPUs 2500 via one or more high-speed NVLink 2510 interconnect. The PPU 2500 may be connected to a host processor or other peripheral devices via an interconnect 2502. The PPU 2500 may also be connected to a local memory comprising any number of memory devices (e.g., memory 2504). In an embodiment, the local memory may comprise a number of dynamic random access memory (DRAM) devices. The DRAM devices may be configured as a high-bandwidth memory (HBM) subsystem, with multiple DRAM dies stacked within each device.

The NVLink 2510 interconnect enables systems to scale and include one or more PPUs 2500 combined with one or more CPUs, supports cache coherence between the PPUs 2500 and CPUs, and CPU mastering. Data and/or commands may be transmitted by the NVLink 2510 through the hub 2530 to/from other units of the PPU 2500 such as one or more copy engines, a video encoder, a video decoder, a power management unit, etc. (not explicitly shown). The NVLink 2510 is described in more detail in conjunction with FIG. 27B.

The I/O unit 2505 is configured to transmit and receive communications (e.g., commands, data, etc.) from a host processor (not shown) over the interconnect 2502. The I/O unit 2505 may communicate with the host processor directly via the interconnect 2502 and/or through one or more intermediate devices such as a memory bridge. In an embodiment, the I/O unit 2505 may communicate with one or more other processors such as one or more PPUs 2500 via the interconnect 2502. In an embodiment, the I/O unit 2505 implements a Peripheral Component Interconnect Express (PCIe) interface for communications over a PCIe bus and the interconnect 2502 is a PCIe bus. In alternative embodiments, the I/O unit 2505 may implement other types of well-known interfaces for communicating with external devices.

The I/O unit 2505 decodes packets received via the interconnect 2502. In an embodiment, the packets represent commands configured to cause the PPU 2500 to perform various operations. The I/O unit 2505 transmits the decoded commands to various other units of the PPU 2500 as the commands may specify. For example, some commands may be transmitted to the front end unit 2515. Other commands may additionally or alternatively be transmitted to the hub 2530 or other units of the PPU 2500 such as one or more copy engines, a video encoder, a video decoder, a power management unit, etc. (not explicitly shown). In other words, the I/O unit 2505 may route communications between and among the various logical units of the PPU 2500.

In an embodiment, a program executed by the host processor may encode a command stream in a buffer that provides workloads to the PPU 2500 for processing. A workload may comprise several instructions and data to be processed by those instructions. The buffer is a region in a memory that is accessible (e.g., read/write) by both the host processor and the PPU 2500. For example, the I/O unit 2505 may be configured to access the buffer in a system memory connected to the interconnect 2502 via memory requests transmitted over the interconnect 2502. In an embodiment, the host processor writes the command stream to the buffer and then transmits a pointer to the start of the command stream to the PPU 2500. The front end unit 2515 may receive pointers to one or more command streams. As such, the front end unit 2515 may manage the one or more streams, reading commands from the streams and forwarding commands to the various units of the PPU 2500.

The front end unit 2515 may be coupled to a scheduler unit 2520 that configures the various GPCs 2550 to process tasks defined by the one or more streams. The scheduler unit 2520 is configured to track state information related to the various tasks managed by the scheduler unit 2520. The state may indicate which GPC 2550 a task is assigned to, whether the task is active or inactive, a priority level associated with the task, and so forth. The scheduler unit 2520 manages the execution of a plurality of tasks on the one or more GPCs 2550.

Continuing with the embodiment illustrated in FIG. 25, the scheduler unit 2520 may be coupled to a work distribution unit 2525 that is configured to dispatch tasks for execution on the GPCs 2550. The work distribution unit 2525 may track a number of scheduled tasks received from the scheduler unit 2520. In an embodiment, the work distribution unit 2525 manages a pending task pool and an active task pool for each of the GPCs 2550. The pending task pool may comprise a number of slots (e.g., 32 slots) that contain tasks assigned to be processed by a particular GPC 2550. The active task pool may comprise a number of slots (e.g., 4 slots) for tasks that are actively being processed by the GPCs 2550. As a GPC 2550 finishes the execution of a task, that task may be evicted from the active task pool for the GPC 2550 and one of the other tasks from the pending task pool may be selected and scheduled for execution on the GPC 2550. If an active task has been idle on the GPC 2550, such as while waiting for a data dependency to be resolved, then the active task may be evicted from the GPC 2550 and returned to the pending task pool while another task in the pending task pool is selected and scheduled for execution on the GPC 2550.

The work distribution unit 2525 may communicate with the one or more GPCs 2550 via XBar 2570. The XBar 2570 may comprise an interconnect network that couples many of the units of the PPU 2500 to other units of the PPU 2500. For example, the XBar 2570 may be configured to couple the work distribution unit 2525 to a particular GPC 2550. Although not shown explicitly, one or more other units of the PPU 2500 may also be connected to the XBar 2570 via the hub 2530.

The tasks may be managed by the scheduler unit 2520 and dispatched to a GPC 2550 by the work distribution unit 2525. The GPC 2550 may be configured to process the tasks and generate results. The results may be consumed by other tasks within the GPC 2550, routed to a different GPC 2550 via the XBar 2570, or stored in the memory 2504. The results may be written to the memory 2504 via the partition units 2580, which may implement a memory interface for reading and writing data to/from the memory 2504. The results may be transmitted to another PPU 2500 or CPU via the NVLink 2510. In an embodiment, the PPU 2500 includes a number U of partition units 2580 that is equal to the number of separate and distinct memory 2504 devices coupled to the PPU 2500. A partition unit 2580 will be described in more detail in conjunction with FIG. 26B.

In an embodiment, a host processor executes a driver kernel that implements an application programming interface (API) that enables one or more applications executing on the host processor to schedule operations for execution on the PPU 2500. In an embodiment, multiple compute applications are simultaneously executed by the PPU 2500 and the PPU 2500 provides isolation, quality of service (QOS), and independent address spaces for the multiple compute applications. An application may generate instructions (e.g., API calls) that cause the driver kernel to generate one or more tasks for execution by the PPU 2500. The driver kernel may output tasks to one or more streams being processed by the PPU 2500. Each task may comprise one or more groups of related threads, referred to herein as a warp. In an embodiment, a warp comprises 32 related threads that may be executed in parallel. Cooperating threads may refer to a plurality of threads including instructions to perform the task and that may exchange data through shared memory. Threads and cooperating threads are described in more detail in conjunction with FIG. 27A.

FIG. 26A illustrates a GPC 2550 of the PPU 2500 of FIG. 25, in accordance with an embodiment. As shown in FIG. 26A, each GPC 2550 includes a number of hardware units for processing tasks. In an embodiment, each GPC 2550 includes a pipeline manager 2610, a pre-raster operations unit (PROP) 2615, a raster engine 2625, a work distribution crossbar (WDX) 2680, a memory management unit (MMU) 2690, and one or more Data Processing Clusters (DPCs) 2620. It will be appreciated that the GPC 2550 of FIG. 26A may include other hardware units in lieu of or in addition to the units shown in FIG. 26A.

In an embodiment, the operation of the GPC 2550 is controlled by the pipeline manager 2610. The pipeline manager 2610 manages the configuration of the one or more DPCs 2620 for processing tasks allocated to the GPC 2550. In an embodiment, the pipeline manager 2610 may configure at least one of the one or more DPCs 2620 to implement at least a portion of a graphics rendering pipeline. For example, a DPC 2620 may be configured to execute a vertex shader program on the programmable streaming multiprocessor (SM) 2640. The pipeline manager 2610 may also be configured to route packets received from the work distribution unit 2525 to the appropriate logical units within the GPC 2550. For example, some packets may be routed to fixed function hardware units in the PROP 2615 and/or raster engine 2625 while other packets may be routed to the DPCs 2620 for processing by the primitive engine 2635 or the SM 2640. In an embodiment, the pipeline manager 2610 may configure at least one of the one or more DPCs 2620 to implement a neural network model and/or a computing pipeline.

The PROP unit 2615 may be configured to route data generated by the raster engine 2625 and the DPCs 2620 to a Raster Operations (ROP) unit, described in more detail in conjunction with FIG. 26B. In some embodiments, the PROP unit 2615 is configured to perform optimizations for color blending, organize pixel data, perform address translations, and/or other tasks.

The raster engine 2625 includes a number of fixed function hardware units configured to perform various raster operations. In an embodiment, the raster engine 2625 includes a setup engine, a coarse raster engine, a culling engine, a clipping engine, a fine raster engine, and/or a tile coalescing engine. The setup engine may receive transformed vertices and generate plane equations associated with the geometric primitive defined by the vertices. The plane equations may be transmitted to the coarse raster engine to generate coverage information (e.g., an x,y coverage mask for a tile) for the primitive. The output of the coarse raster engine may be transmitted to the culling engine where fragments associated with the primitive that fail a z-test may be culled, and transmitted to a clipping engine where fragments lying outside a viewing frustum may be clipped. Those fragments that survive clipping and culling may be passed to the fine raster engine to generate attributes for the pixel fragments based on the plane equations generated by the setup engine. The output of the raster engine 2625 may comprise fragments to be processed, for example, by a fragment shader implemented within a DPC 2620.

Each DPC 2620 included in the GPC 2550 may include an M-Pipe Controller (MPC) 2630, a primitive engine 2635, and one or more SMs 2640. The MPC 2630 may control the operation of the DPC 2620, routing packets received from the pipeline manager 2610 to the appropriate units in the DPC 2620. For example, packets associated with a vertex may be routed to the primitive engine 2635, which may be configured to fetch vertex attributes associated with the vertex from the memory 2504. In contrast, packets associated with a shader program may be transmitted to the SM 2640.

The SM 2640 comprises a programmable streaming processor that is configured to process tasks represented by a number of threads. Each SM 2640 is multi-threaded and configured to execute a plurality of threads (e.g., 32 threads) from a particular group of threads concurrently. In an embodiment, the SM 2640 implements a SIMD (Single-Instruction, Multiple-Data) architecture where each thread in a group of threads (e.g., a warp) is configured to process a different set of data based on the same set of instructions. All threads in the group of threads execute the same instructions. In another embodiment, the SM 2640 implements a SIMT (Single-Instruction, Multiple Thread) architecture where each thread in a group of threads is configured to process a different set of data based on the same set of instructions, but where individual threads in the group of threads are allowed to diverge during execution. In an embodiment, a program counter, call stack, and execution state is maintained for each warp, enabling concurrency between warps and serial execution within warps when threads within the warp diverge. In another embodiment, a program counter, call stack, and execution state is maintained for each individual thread, enabling equal concurrency between all threads, within and between warps. When execution state is maintained for each individual thread, threads executing the same instructions may be converged and executed in parallel for maximum efficiency. The SM 2640 will be described in more detail below in conjunction with FIG. 27A.

The MMU 2690 provides an interface between the GPC 2550 and the partition unit 2580. The MMU 2690 may provide translation of virtual addresses into physical addresses, memory protection, and arbitration of memory requests. In an embodiment, the MMU 2690 provides one or more translation lookaside buffers (TLBs) for performing translation of virtual addresses into physical addresses in the memory 2504.

FIG. 26B illustrates a memory partition unit 2580 of the PPU 2500 of FIG. 25, in accordance with an embodiment. As shown in FIG. 26B, the memory partition unit 2580 includes a Raster Operations (ROP) unit 2650, a level two (L2) cache 2660, and a memory interface 2670. The memory interface 2670 is coupled to the memory 2504. Memory interface 2670 may implement 32, 64, 128, 1024-bit data buses, or other types of data buses, for high-speed data transfer. In an embodiment, the PPU 2500 incorporates U memory interfaces 2670, one memory interface 2670 per pair of partition units 2580, where each pair of partition units 2580 is connected to a corresponding memory device (e.g., memory 2504). For example, PPU 2500 may be connected to up to Y memory devices, such as high bandwidth memory stacks or graphics double-data-rate, version 5, synchronous dynamic random access memory, or other types of persistent storage.

In an embodiment, the memory interface 2670 implements an HBM2 memory interface and Y equals half U. In an embodiment, the HBM2 memory stacks are located on the same physical package as the PPU 2500, providing substantial power and area savings compared with conventional GDDR5 SDRAM systems. In an embodiment, each HBM2 stack includes four memory dies and Y equals 4, with HBM2 stack including two 128-bit channels per die for a total of 8 channels and a data bus width of 1024 bits.

In an embodiment, the memory 2504 supports Single-Error Correcting Double-Error Detecting (SECDED) Error Correction Code (ECC) to protect data. ECC provides higher reliability for compute applications that are sensitive to data corruption. Reliability is especially important in large-scale cluster computing environments where PPUs 2500 process very large datasets and/or run applications for extended periods.

In an embodiment, the PPU 2500 implements a multi-level memory hierarchy. In an embodiment, the memory partition unit 2580 supports a unified memory to provide a single unified virtual address space for CPU and PPU 2500 memory, enabling data sharing between virtual memory systems. In an embodiment, the frequency of accesses by a PPU 2500 to memory located on other processors is traced to ensure that memory pages are moved to the physical memory of the PPU 2500 that is accessing the pages more frequently. In an embodiment, the NVLink 2510 supports address translation services allowing the PPU 2500 to directly access a CPU's page tables and providing full access to CPU memory by the PPU 2500.

In an embodiment, copy engines transfer data between multiple PPUs 2500 or between PPUs 2500 and CPUs. The copy engines may generate page faults for addresses that are not mapped into the page tables. The memory partition unit 2580 may then service the page faults, mapping the addresses into the page table, after which the copy engine may perform the transfer. In a conventional system, memory may be pinned (e.g., non-pageable) for multiple copy engine operations between multiple processors, substantially reducing the available memory. With hardware page faulting, addresses may be passed to the copy engines independent of whether the memory pages are in use, and the copying process may occur seamlessly.

Data from the memory 2504 or other system memory may be fetched by the memory partition unit 2580 and stored in the L2 cache 2660, which is located on-chip and is shared between the various GPCs 2550. As shown, each memory partition unit 2580 includes a portion of the L2 cache 2660 associated with a corresponding memory device (e.g., memory 2504). Lower level caches may be implemented in various units within the GPCs 2550. For example, each of the SMs 2640 may implement a level one (L1) cache. The L1 cache is private memory that is dedicated to a particular SM 2640. Data from the L2 cache 2660 may be fetched and stored in each of the L1 caches for processing in the functional units of the SMs 2640. The L2 cache 2660 is coupled to the memory interface 2670 and the XBar 2570.

The ROP unit 2650 may perform graphics raster operations related to pixel color, such as color compression, pixel blending, and/or the like. The ROP unit 2650 may implements depth testing in conjunction with the raster engine 2625, receiving a depth for a sample location associated with a pixel fragment from the culling engine of the raster engine 2625. The depth may be tested against a corresponding depth in a depth buffer for a sample location associated with the fragment. If the fragment passes the depth test for the sample location, the ROP unit 2650 may update the depth buffer and transmit a result of the depth test to the raster engine 2625. It will be appreciated that the number of partition units 2580 may be different than the number of GPCs 2550 and, therefore, each ROP unit 2650 may be coupled to each of the GPCs 2550. The ROP unit 2650 may track packets received from the different GPCs 2550 and determine to which GPC 2550 a result generated by the ROP unit 2650 is routed through the Xbar 2570. Although the ROP unit 2650 is included within the memory partition unit 2580 in FIG. 26B, in some embodiments, the ROP unit 2650 may be outside of the memory partition unit 2580. For example, the ROP unit 2650 may reside in the GPC 2550 or another unit.

FIG. 27A illustrates the streaming multi-processor 2640 of FIG. 26A, in accordance with an embodiment. As shown in FIG. 27A, the SM 2640 includes an instruction cache 2705, one or more scheduler units 2710, a register file 2720, one or more processing cores 2750, one or more special function units (SFUs) 2752, one or more load/store units (LSUs) 2754, an interconnect network 2780, a shared memory/L1 cache 2770.

As described above, the work distribution unit 2525 dispatches tasks for execution on the GPCs 2550 of the PPU 2500. The tasks are allocated to a particular DPC 2620 within a GPC 2550 and, if the task is associated with a shader program, the task may be allocated to an SM 2640. The scheduler unit 2710 may receive the tasks from the work distribution unit 2525 and manage instruction scheduling for one or more thread blocks assigned to the SM 2640. The scheduler unit 2710 may schedule thread blocks for execution as warps of parallel threads, where each thread block may be allocated at least one warp. In an embodiment, each warp executes 32 threads. The scheduler unit 2710 may manage a plurality of different thread blocks, allocating the warps to the different thread blocks and then dispatching instructions from the plurality of different cooperative groups to the various functional units (e.g., cores 2750, SFUs 2752, and LSUs 2754) during each clock cycle.

Cooperative Groups is a programming model for organizing groups of communicating threads that allows developers to express the granularity at which threads are communicating, enabling the expression of richer, more efficient parallel decompositions. Cooperative launch APIs support synchronization amongst thread blocks for the execution of parallel algorithms. Conventional programming models provide a single, simple construct for synchronizing cooperating threads: a barrier across all threads of a thread block (e.g., the syncthreads( ) function). However, programmers would often like to define groups of threads at smaller than thread block granularities and synchronize within the defined groups to enable greater performance, design flexibility, and software reuse in the form of collective group-wide function interfaces.

Cooperative Groups enables programmers to define groups of threads explicitly at sub-block (e.g., as small as a single thread) and multi-block granularities, and to perform collective operations such as synchronization on the threads in a cooperative group. The programming model supports clean composition across software boundaries, so that libraries and utility functions can synchronize safely within their local context without having to make assumptions about convergence. Cooperative Groups primitives enable new patterns of cooperative parallelism, including producer-consumer parallelism, opportunistic parallelism, and global synchronization across an entire grid of thread blocks.

A dispatch unit 2715 may be configured to transmit instructions to one or more of the functional units. In the embodiment, the scheduler unit 2710 includes two dispatch units 2715 that enable two different instructions from the same warp to be dispatched during each clock cycle. In alternative embodiments, each scheduler unit 2710 may include a single dispatch unit 2715 or additional dispatch units 2715.

Each SM 2640 may include a register file 2720 that provides a set of registers for the functional units of the SM 2640. In an embodiment, the register file 2720 is divided between each of the functional units such that each functional unit is allocated a dedicated portion of the register file 2720. In some embodiments, the register file 2720 is divided between the different warps being executed by the SM 2640. The register file 2720 provides temporary storage for operands connected to the data paths of the functional units.

Each SM 2640 may comprise L processing cores 2750. In an embodiment, the SM 2640 includes a large number (e.g., 128, etc.) of distinct processing cores 2750. Each core 2750 may include a fully-pipelined, single-precision, double-precision, and/or mixed precision processing unit that includes a floating point arithmetic logic unit and an integer arithmetic logic unit. In an embodiment, the floating point arithmetic logic units implement the IEEE 754-2008 standard for floating point arithmetic. In an embodiment, the cores 2750 include 64 single-precision (32-bit) floating point cores, 64 integer cores, 32 double-precision (64-bit) floating point cores, and 8 tensor cores.

Tensor cores configured to perform matrix operations, and, in an embodiment, one or more tensor cores are included in the cores 2750. In particular, the tensor cores may be configured to perform deep learning matrix arithmetic, such as convolution operations for neural network training and inferencing. In an embodiment, each tensor core operates on a 4×4 matrix and performs a matrix multiply and accumulate operation D=A×B+C, where A, B, C, and D are 4×4 matrices.

In an embodiment, the matrix multiply inputs A and B are 16-bit floating point matrices, while the accumulation matrices C and D may be 16-bit floating point or 32-bit floating point matrices. Tensor Cores may operate on 16-bit floating point input data with 32-bit floating point accumulation. The 16-bit floating point multiply requires 64 operations and results in a full precision product that is then accumulated using 32-bit floating point addition with the other intermediate products for a 4×4×4 matrix multiply. In practice, Tensor Cores are often used to perform much larger two-dimensional or higher dimensional matrix operations, built up from these smaller elements. An API, such as CUDA C++ API, may expose specialized matrix load, matrix multiply and accumulate, and/or matrix store operations to efficiently use Tensor Cores from a CUDA-C++ program. At the CUDA level, the warp-level interface may assume 16×16 size matrices spanning all 32 threads of the warp.

Each SM 2640 may comprise M SFUs 2752 that perform special functions (e.g., attribute evaluation, reciprocal square root, and the like). In an embodiment, the SFUs 2752 may include a tree traversal unit (TTU) configured to traverse a hierarchical tree data structure. In an embodiment, the SFUs 2752 may include texture unit configured to perform texture map filtering operations. In an embodiment, the texture units are configured to load texture maps (e.g., a 2D array of texels) from the memory 2504 and sample the texture maps to produce sampled texture values for use in shader programs executed by the SM 2640. In an embodiment, the texture maps are stored in the shared memory/L1 cache 2770. The texture units may implement texture operations such as filtering operations using mip-maps (e.g., texture maps of varying levels of detail). In an embodiment, each SM 2540 includes two texture units.

Each SM 2640 may comprise N LSUs 2754 that implement load and store operations between the shared memory/L1 cache 2770 and the register file 2720. Each SM 2640 may include an interconnect network 2780 that connects each of the functional units to the register file 2720 and the LSU 2754 to the register file 2720, shared memory/L1 cache 2770. In an embodiment, the interconnect network 2780 is a crossbar that can be configured to connect any of the functional units to any of the registers in the register file 2720 and connect the LSUs 2754 to the register file and memory locations in shared memory/L1 cache 2770.

The shared memory/L1 cache 2770 may be an array of on-chip memory that allows for data storage and communication between the SM 2640 and the primitive engine 2635 and between threads in the SM 2640. In an embodiment, the shared memory/L1 cache 2770 comprises 128 KB of storage capacity and is in the path from the SM 2640 to the partition unit 2580. The shared memory/L1 cache 2770 can be used to cache reads and writes. One or more of the shared memory/L1 cache 2770, L2 cache 2660, and memory 2504 may be backing stores.

Combining data cache and shared memory functionality into a single memory block may provide the best overall performance for both types of memory accesses. The capacity may be usable as a cache by programs that do not use shared memory. For example, if shared memory is configured to use half of the capacity, texture and load/store operations may use the remaining capacity. Integration within the shared memory/L1 cache 2770 may enable the shared memory/L1 cache 2770 to function as a high-throughput conduit for streaming data while simultaneously providing high-bandwidth and low-latency access to frequently reused data.

When configured for general purpose parallel computation, a simpler configuration may be used compared with graphics processing. For example, the fixed function graphics processing units shown in FIG. 25 may be bypassed, creating a much simpler programming model. In such a general purpose parallel computation configuration, the work distribution unit 2525 may assign and distribute blocks of threads directly to the DPCs 2620. The threads in a block may execute the same program, using a unique thread ID in the calculation to ensure each thread generates unique results, using the SM 2640 to execute the program and perform calculations, shared memory/L1 cache 2770 to communicate between threads, and the LSU 2754 to read and write global memory through the shared memory/L1 cache 2770 and the memory partition unit 2580. When configured for general purpose parallel computation, the SM 2640 may write commands that the scheduler unit 2520 can use to launch new work on the DPCs 2620.

The PPU 2500 may be included in a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, and/or other devices. In an embodiment, the PPU 2500 is embodied on a single semiconductor substrate. In another embodiment, the PPU 2500 is included in a system-on-a-chip (SoC) along with one or more other devices such as additional PPUs 2500, the memory, a reduced instruction set computer (RISC) CPU, a memory management unit (MMU), a digital-to-analog converter (DAC), and/or others.

In an embodiment, the PPU 2500 may be included on a graphics card that includes one or more memory devices (e.g., memory 2504). The graphics card may be configured to interface with a PCIe slot on a motherboard of a desktop computer. In some embodiments, the PPU 2500 may be an integrated graphics processing unit (iGPU) or parallel processor included in the chipset of the motherboard.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes may be deployed in data centers, research facilities, and/or supercomputers to solve ever larger problems. As the number of processing devices within the high-performance systems increases, the communication and data transfer mechanisms may need to scale to support the increased bandwidth.

FIG. 27B is a conceptual diagram of a processing system 2700 implemented using the PPU 2500 of FIG. 25, in accordance with an embodiment. The processing system 2700 includes a CPU 2730, switch 2732, and multiple PPUs 2500 each and respective memories 2504. The NVLink 2510 may provide high-speed communication links between each of the PPUs 2500. Although a particular number of NVLink 2510 and interconnect 2502 connections are illustrated in FIG. 27B, the number of connections to each PPU 2500 and the CPU 2730 may vary. The switch 2732 may interface between the interconnect 2502 and the CPU 2730. The PPUs 2500, memories 2504, and NVLinks 2510 may be situated on a single semiconductor platform to form a parallel processing module 2725. In an embodiment, the switch 2732 supports two or more protocols to interface between various different connections and/or links.

In another embodiment (not shown), the NVLink 2510 provides one or more high-speed communication links between each of the PPUs 2500 and the CPU 2730 and the switch 2732 interfaces between the interconnect 2502 and each of the PPUs 2500. The PPUs 2500, memories 2504, and the interconnect 2502 may be situated on a single semiconductor platform to form a parallel processing module 2725. In some embodiments (not shown), the interconnect 2502 provides one or more communication links between each of the PPUs 2500 and the CPU 2730, and the switch 2732 interfaces between each of the PPUs 2500 using the NVLink 2510 to provide one or more high-speed communication links between the PPUs 2500. In some embodiments (not shown), the NVLink 2510 provides one or more high-speed communication links between the PPUs 2500 and the CPU 2730 through the switch 2732. In some embodiments (not shown), the interconnect 2502 provides one or more communication links between each of the PPUs 2500 directly. One or more of the NVLink 2510 high-speed communication links may be implemented as a physical NVLink interconnect or either an on-chip or on-die interconnect using the same protocol as the NVLink 2510.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may be situated separately or in various combinations of semiconductor platforms per the desires of the designer. In some embodiments, the parallel processing module 2725 may be implemented as a circuit board substrate and each of the PPUs 2500 and/or memories 2504 may be packaged devices. In an embodiment, the CPU 2730, switch 2732, and the parallel processing module 2725 are situated on a single semiconductor platform.

In an embodiment, the signaling rate of each NVLink 2510 is 20 to 25 Gigabits/second and each PPU 2500 includes six NVLink 2510 interfaces (as shown in FIG. 27B, five NVLink 2510 interfaces are included for each PPU 2500). Each NVLink 2510 may provide a particular data transfer rate (e.g., 25 Gigabytes/second) in each direction, with six links providing 2500 Gigabytes/second. The NVLinks 2510 may be used exclusively for PPU-to-PPU communication as shown in FIG. 27B, or some combination of PPU-to-PPU and PPU-to-CPU, when the CPU 2730 also includes one or more NVLink 2510 interfaces.

In an embodiment, the NVLink 2510 allows direct load/store/atomic access from the CPU 2730 to each PPU's 2500 memory 2504. In an embodiment, the NVLink 2510 supports coherency operations, allowing data read from the memories 2504 to be stored in the cache hierarchy of the CPU 2730, reducing cache access latency for the CPU 2730. In an embodiment, the NVLink 2510 includes support for Address Translation Services (ATS), allowing the PPU 2500 to directly access page tables within the CPU 2730. One or more of the NVLinks 2510 may be configured to operate in a low-power mode.

FIG. 27C illustrates an exemplary system 2765 in which the processing system of FIG. 27B may be implemented, in accordance with some embodiments of the present disclosure. More specifically, FIG. 27C illustrates a system 2765 comprising at least one central processing unit 2730 that is connected to a communication bus 2775. The communication bus 2775 may be implemented using any suitable protocol, such as PCI (Peripheral Component Interconnect), PCI-Express, AGP (Accelerated Graphics Port), HyperTransport, or any other bus or point-to-point communication protocol(s). The system 2765 includes a main memory 2740. Control logic (software) and data may be stored in the main memory 2740, which may take the form of random access memory (RAM).

Continuing with the example implementation illustrated in FIG. 27C, the system 2765 includes input devices 2760, the parallel processing system 2725, and display devices 2745, e.g. a conventional CRT (cathode ray tube), LCD (liquid crystal display), LED (light emitting diode), plasma display, and/or others. User input may be received from the input devices 2760, e.g., keyboard, mouse, touchpad, microphone, etc. Each of the foregoing modules and/or devices may be situated on a single semiconductor platform to form the system 2765. In some embodiments, the various modules may be situated separately or in various combinations of semiconductor platforms.

In some embodiments, the system 2765 may be coupled to a network (e.g., a telecommunications network, local area network (LAN), wireless network, wide area network (WAN) such as the Internet, peer-to-peer network, cable network, etc.) through a network interface 2735 for communication purposes.

The system 2765 may include a secondary storage (not shown), which may include a hard disk drive and/or a removable storage drive, representing a floppy disk drive, a magnetic tape drive, a compact disk drive, digital versatile disk (DVD) drive, recording device, universal serial bus (USB) flash memory, and/or others. The removable storage drive may read from and/or write to a removable storage unit in a well-known manner.

Computer programs, or computer control logic algorithms, may be stored in the main memory 2740 and/or the secondary storage. Such computer programs, when executed, enable the system 2765 to perform various functions. The main memory 2740, the storage, and/or any other storage are possible examples of computer-readable media.

The architecture and/or functionality of the various previous figures may be implemented in the context of a general computer system, a circuit board system, a game console system dedicated for entertainment purposes, an application-specific system, and/or any other desired system. For example, the system 2765 may take the form of a desktop computer, a laptop computer, a tablet computer, servers, supercomputers, a smart-phone (e.g., a wireless, hand-held device), personal digital assistant (PDA), a digital camera, a vehicle, a head mounted display, a hand-held electronic device, a mobile phone device, a television, workstation, game consoles, embedded system, and/or any other device.

### Graphics Processing Pipeline

In an embodiment, the PPU 2500 comprises a graphics processing unit (GPU). The PPU 2500 may be configured to receive commands that specify shader programs for processing graphics data. Graphics data may be defined as a set of primitives such as points, lines, triangles, quads, triangle strips, and/or the like. Typically, a primitive includes data that specifies a number of vertices for the primitive (e.g., in a model-space coordinate system) as well as attributes associated with each vertex of the primitive. The PPU 2500 may be configured to process the graphics primitives to generate a frame buffer (e.g., pixel data for each of the pixels of the display).

An application may write model data for a scene (e.g., a collection of vertices and attributes) to a memory such as a system memory or memory 2504. The model data may define each of the objects that may be visible on a display. The application may then make an API call to the driver kernel that requests the model data to be rendered and displayed. The driver kernel may read the model data and write commands to the one or more streams to perform operations to process the model data. The commands may reference different shader programs to be implemented on the SMs 2640 of the PPU 2500 including one or more of a vertex shader, hull shader, domain shader, geometry shader, and a pixel shader. For example, one or more of the SMs 2640 may be configured to execute a vertex shader program that processes a number of vertices defined by the model data. In an embodiment, the different SMs 2640 may be configured to execute different shader programs concurrently. For example, a first subset of SMs 2640 may be configured to execute a vertex shader program while a second subset of SMs 2640 may be configured to execute a pixel shader program. The first subset of SMs 2640 may process vertex data to produce processed vertex data and write the processed vertex data to the L2 cache 2660 and/or the memory 2504. After the processed vertex data is rasterized (e.g., transformed from three-dimensional data into two-dimensional data in screen space) to produce fragment data, the second subset of SMs 2640 may execute a pixel shader to produce processed fragment data, which may then be blended with other processed fragment data and written to the frame buffer in memory 2504. The vertex shader program and pixel shader program may execute concurrently, processing different data from the same scene in a pipelined fashion until all of the model data for the scene has been rendered to the frame buffer. Then, the contents of the frame buffer may be transmitted to a display controller for display on a display device.

### Machine Learning

Deep neural networks (DNNs) developed on processors, such as the PPU 2500 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system may be trained in object recognition and classification to identify objects and classify those objects.

At the simplest level, neurons in the human brain look at various inputs that are received, importance levels are assigned to each of these inputs, and output is passed on to other neurons to act upon. An artificial neuron or perceptron is the most basic model of a neural network. In one example, a perceptron may receive one or more inputs that represent various features of an object that the perceptron is being trained to recognize and classify, and each of these features may be assigned a certain weight based on the importance of that feature in defining the shape of an object.

A deep neural network (DNN) model includes multiple layers of many connected nodes (e.g., perceptrons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer may assemble the lines to look for higher level patterns such as wheels, windshields, and mirrors. The next layer may identify a type of vehicle, and the final few layers may generate a label for the input image, identifying the model of a specific automobile brand.

Once the DNN is trained, it may be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label may be analyzed, and the weights may be adjusted for each feature during a backward propagation phase until the DNN correctly labels the input and other inputs in a training dataset. Training complex neural networks requires massive amounts of parallel computing performance, including floating-point multiplications and additions that may be supported by the PPU 2500.

Whether during training, testing, or inference, neural networks rely heavily on matrix math operations, and complex multi-layered networks require tremendous amounts of floating-point performance and bandwidth for both efficiency and speed. In some embodiments (e.g., with thousands of processing cores, optimized for matrix math operations, delivering tens to hundreds of TFLOPS of performance), the PPU 2500 may be a computing platform capable of supporting deep neural network-based artificial intelligence and machine learning applications.

### Example Computing Device

FIG. 28 is a block diagram of an example computing device(s) 2800 suitable for use in implementing some embodiments of the present disclosure. Computing device 2800 may include an interconnect system 2802 that directly or indirectly couples the following devices: memory 2804, one or more central processing units (CPUs) 2806, one or more graphics processing units (GPUs) 2808, a communication interface 2810, input/output (I/O) ports 2812, input/output components 2814, a power supply 2816, one or more presentation components 2818 (e.g., display(s)), and one or more logic units 2820. In at least one embodiment, the computing device(s) 2800 may comprise one or more virtual machines (VMs), and/or any of the components thereof may comprise virtual components (e.g., virtual hardware components). For non-limiting examples, one or more of the GPUs 2808 may comprise one or more vGPUs, one or more of the CPUs 2806 may comprise one or more vCPUs, and/or one or more of the logic units 2820 may comprise one or more virtual logic units. As such, a computing device(s) 2800 may include discrete components (e.g., a full GPU dedicated to the computing device 2800), virtual components (e.g., a portion of a GPU dedicated to the computing device 2800), or a combination thereof.

Although the various blocks of FIG. 28 are shown as connected via the interconnect system 2802 with lines, this is not intended to be limiting and is for clarity only. For example, in some embodiments, a presentation component 2818, such as a display device, may be considered an I/O component 2814 (e.g., if the display is a touch screen). As another example, the CPUs 2806 and/or GPUs 2808 may include memory (e.g., the memory 2804 may be representative of a storage device in addition to the memory of the GPUs 2808, the CPUs 2806, and/or other components). As such, the computing device of FIG. 28 is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 28.

The interconnect system 2802 may represent one or more links or busses, such as an address bus, a data bus, a control bus, or a combination thereof. The interconnect system 2802 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, and/or another type of bus or link. In some embodiments, there are direct connections between components. As an example, the CPU 2806 may be directly connected to the memory 2804. Further, the CPU 2806 may be directly connected to the GPU 2808. Where there is direct, or point-to-point connection between components, the interconnect system 2802 may include a PCIe link to carry out the connection. In these examples, a PCI bus need not be included in the computing device 2800.

The memory 2804 may include any of a variety of computer-readable media. The computer-readable media may be any available media that may be accessed by the computing device 2800. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the memory 2804 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by computing device 2800. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

The CPU(s) 2806 may be configured to execute at least some of the computer-readable instructions to control one or more components of the computing device 2800 to perform one or more of the methods and/or processes described herein. The CPU(s) 2806 may each include one or more cores (e.g., one, two, four, eight, twenty-eight, seventy-two, etc.) that are capable of handling a multitude of software threads simultaneously. The CPU(s) 2806 may include any type of processor, and may include different types of processors depending on the type of computing device 2800 implemented (e.g., processors with fewer cores for mobile devices and processors with more cores for servers). For example, depending on the type of computing device 2800, the processor may be an Advanced RISC Machines (ARM) processor implemented using Reduced Instruction Set Computing (RISC) or an x86 processor implemented using Complex Instruction Set Computing (CISC). The computing device 2800 may include one or more CPUs 2806 in addition to one or more microprocessors or supplementary co-processors, such as math co-processors.

In addition to or alternatively from the CPU(s) 2806, the GPU(s) 2808 may be configured to execute at least some of the computer-readable instructions to control one or more components of the computing device 2800 to perform one or more of the methods and/or processes described herein. One or more of the GPU(s) 2808 may be an integrated GPU (e.g., with one or more of the CPU(s) 2806 and/or one or more of the GPU(s) 2808 may be a discrete GPU. In embodiments, one or more of the GPU(s) 2808 may be a coprocessor of one or more of the CPU(s) 2806. The GPU(s) 2808 may be used by the computing device 2800 to render graphics (e.g., 3D graphics) or perform general purpose computations. For example, the GPU(s) 2808 may be used for General-Purpose computing on GPUs (GPGPU). The GPU(s) 2808 may include hundreds or thousands of cores that are capable of handling hundreds or thousands of software threads simultaneously. The GPU(s) 2808 may generate pixel data for output images in response to rendering commands (e.g., rendering commands from the CPU(s) 2806 received via a host interface). The GPU(s) 2808 may include graphics memory, such as display memory, for storing pixel data or any other suitable data, such as GPGPU data. The display memory may be included as part of the memory 2804. The GPU(s) 2808 may include two or more GPUs operating in parallel (e.g., via a link). The link may directly connect the GPUs (e.g., using NVLINK) or may connect the GPUs through a switch (e.g., using NVSwitch). When combined together, each GPU 2808 may generate pixel data or GPGPU data for different portions of an output or for different outputs (e.g., a first GPU for a first image and a second GPU for a second image). Each GPU may include its own memory, or may share memory with other GPUs.

In addition to or alternatively from the CPU(s) 2806 and/or the GPU(s) 2808, the logic unit(s) 2820 may be configured to execute at least some of the computer-readable instructions to control one or more components of the computing device 2800 to perform one or more of the methods and/or processes described herein. In embodiments, the CPU(s) 2806, the GPU(s) 2808, and/or the logic unit(s) 2820 may discretely or jointly perform any combination of the methods, processes and/or portions thereof. One or more of the logic units 2820 may be part of and/or integrated in one or more of the CPU(s) 2806 and/or the GPU(s) 2808 and/or one or more of the logic units 2820 may be discrete components or otherwise external to the CPU(s) 2806 and/or the GPU(s) 2808. In embodiments, one or more of the logic units 2820 may be a coprocessor of one or more of the CPU(s) 2806 and/or one or more of the GPU(s) 2808.

Examples of the logic unit(s) 2820 include one or more processing cores and/or components thereof, such as Data Processing Units (DPUs), Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMS), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The communication interface 2810 may include one or more receivers, transmitters, and/or transceivers that allow the computing device 2800 to communicate with other computing devices via an electronic communication network, included wired and/or wireless communications. The communication interface 2810 may include components and functionality to allow communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet. In one or more embodiments, logic unit(s) 2820 and/or communication interface 2810 may include one or more data processing units (DPUs) to transmit data received over a network and/or through interconnect system 2802 directly to (e.g., a memory of) one or more GPU(s) 2808.

The I/O ports 2812 may allow the computing device 2800 to be logically coupled to other devices including the I/O components 2814, the presentation component(s) 2818, and/or other components, some of which may be built in to (e.g., integrated in) the computing device 2800. Illustrative I/O components 2814 include a microphone, mouse, keyboard, joystick, game pad, game controller, satellite dish, scanner, printer, wireless device, etc. The I/O components 2814 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the computing device 2800. The computing device 2800 may be include depth cameras, such as stereoscopic camera systems, infrared camera systems, RGB camera systems, touchscreen technology, and combinations of these, for gesture detection and recognition. Additionally, the computing device 2800 may include accelerometers or gyroscopes (e.g., as part of an inertia measurement unit (IMU)) that allow detection of motion. In some examples, the output of the accelerometers or gyroscopes may be used by the computing device 2800 to render immersive augmented reality or virtual reality.

The power supply 2816 may include a hard-wired power supply, a battery power supply, or a combination thereof. The power supply 2816 may provide power to the computing device 2800 to allow the components of the computing device 2800 to operate.

The presentation component(s) 2818 may include a display (e.g., a monitor, a touch screen, a television screen, a heads-up-display (HUD), other display types, or a combination thereof), speakers, and/or other presentation components. The presentation component(s) 2818 may receive data from other components (e.g., the GPU(s) 2808, the CPU(s) 2806, DPUs, etc.), and output the data (e.g., as an image, video, sound, etc.).

### Example Data Center

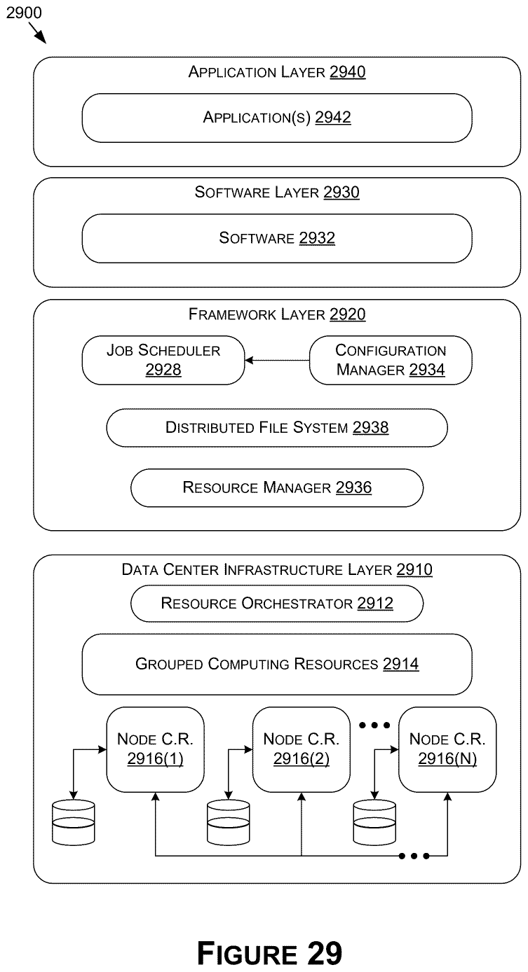

FIG. 29 illustrates an example data center 2900 that may be used in at least one embodiments of the present disclosure. The data center 2900 may include a data center infrastructure layer 2910, a framework layer 2920, a software layer 2930, and/or an application layer 2940.

As shown in FIG. 29, the data center infrastructure layer 2910 may include a resource orchestrator 2912, grouped computing resources 2914, and node computing resources (“node C.R.s”) 2916(1)-2916(N), where “N” represents any whole, positive integer. In at least one embodiment, node C.R.s 2916(1)-2916(N) may include, but are not limited to, any number of central processing units (CPUs) or other processors (including DPUs, accelerators, field programmable gate arrays (FPGAs), graphics processors or graphics processing units (GPUs), etc.), memory devices (e.g., dynamic read-only memory), storage devices (e.g., solid state or disk drives), network input/output (NW I/O) devices, network switches, virtual machines (VMs), power modules, and/or cooling modules, etc. In some embodiments, one or more node C.R.s from among node C.R.s 2916(1)-2916(N) may correspond to a server having one or more of the above-mentioned computing resources. In addition, in some embodiments, the node C.R.s 2916(1)-29161 (N) may include one or more virtual components, such as vGPUs, vCPUs, and/or the like, and/or one or more of the node C.R.s 2916(1)-2916(N) may correspond to a virtual machine (VM).

In at least one embodiment, grouped computing resources 2914 may include separate groupings of node C.R.s 2916 housed within one or more racks (not shown), or many racks housed in data centers at various geographical locations (also not shown). Separate groupings of node C.R.s 2916 within grouped computing resources 2914 may include grouped compute, network, memory or storage resources that may be configured or allocated to support one or more workloads. In at least one embodiment, several node C.R.s 2916 including CPUs, GPUs, DPUs, and/or other processors may be grouped within one or more racks to provide compute resources to support one or more workloads. The one or more racks may also include any number of power modules, cooling modules, and/or network switches, in any combination.

The resource orchestrator 2912 may configure or otherwise control one or more node C.R.s 2916(1)-2916(N) and/or grouped computing resources 2914. In at least one embodiment, resource orchestrator 2912 may include a software design infrastructure (SDI) management entity for the data center 2900. The resource orchestrator 2912 may include hardware, software, or some combination thereof.

In at least one embodiment, as shown in FIG. 29, framework layer 2920 may include a job scheduler 2928, a configuration manager 2934, a resource manager 2936, and/or a distributed file system 2938. The framework layer 2920 may include a framework to support software 2932 of software layer 2930 and/or one or more application(s) 2942 of application layer 2940. The software 2932 or application(s) 2942 may respectively include web-based service software or applications, such as those provided by Amazon Web Services, Google Cloud and Microsoft Azure. The framework layer 2920 may be, but is not limited to, a type of free and open-source software web application framework such as Apache Spark™ (hereinafter “Spark”) that may use distributed file system 2938 for large-scale data processing (e.g., “big data”). In at least one embodiment, job scheduler 2928 may include a Spark driver to facilitate scheduling of workloads supported by various layers of data center 2900. The configuration manager 2934 may be capable of configuring different layers such as software layer 2930 and framework layer 2920 including Spark and distributed file system 2938 for supporting large-scale data processing. The resource manager 2936 may be capable of managing clustered or grouped computing resources mapped to or allocated for support of distributed file system 2938 and job scheduler 2928. In at least one embodiment, clustered or grouped computing resources may include grouped computing resource 2914 at data center infrastructure layer 2910. The resource manager 2936 may coordinate with resource orchestrator 2912 to manage these mapped or allocated computing resources.

In at least one embodiment, software 2932 included in software layer 2930 may include software used by at least portions of node C.R.s 2916(1)-2916(N), grouped computing resources 2914, and/or distributed file system 2938 of framework layer 2920. One or more types of software may include, but are not limited to, Internet web page search software, e-mail virus scan software, database software, and streaming video content software.

In at least one embodiment, application(s) 2942 included in application layer 2940 may include one or more types of applications used by at least portions of node C.R.s 2916(1)-2916(N), grouped computing resources 2914, and/or distributed file system 2938 of framework layer 2920. One or more types of applications may include, but are not limited to, any number of a genomics application, a cognitive compute, and a machine learning application, including training or inferencing software, machine learning framework software (e.g., PyTorch, TensorFlow, Caffe, etc.), and/or other machine learning applications used in conjunction with one or more embodiments.

In at least one embodiment, any of configuration manager 2934, resource manager 2936, and resource orchestrator 2912 may implement any number and type of self-modifying actions based on any amount and type of data acquired in any technically feasible fashion. Self-modifying actions may relieve a data center operator of data center 2900 from making possibly bad configuration decisions and possibly avoiding underutilized and/or poor performing portions of a data center.

The data center 2900 may include tools, services, software or other resources to train one or more machine learning models or predict or infer information using one or more machine learning models according to one or more embodiments described herein. For example, a machine learning model(s) may be trained by calculating weight parameters according to a neural network architecture using software and/or computing resources described above with respect to the data center 2900. In at least one embodiment, trained or deployed machine learning models corresponding to one or more neural networks may be used to infer or predict information using resources described above with respect to the data center 2900 by using weight parameters calculated through one or more training techniques, such as but not limited to those described herein.

In at least one embodiment, the data center 2900 may use CPUs, application-specific integrated circuits (ASICs), GPUs, FPGAs, and/or other hardware (or virtual compute resources corresponding thereto) to perform training and/or inferencing using above-described resources. Moreover, one or more software and/or hardware resources described above may be configured as a service to allow users to train or performing inferencing of information, such as image recognition, speech recognition, or other artificial intelligence services.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of any known computing device(s). In addition, where backend devices (e.g., servers, NAS, etc.) are implemented, the backend devices may be included as part of a data center 2900, an example of which is described in more detail herein with respect to FIG. 29.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment- and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may be implemented using any known computing device(s). By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

The disclosure may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The disclosure may be practiced in a variety of system configurations, including hand-held devices, consumer electronics, general-purpose computers, more specialty computing devices, etc. The disclosure may also be practiced in distributed computing environments where tasks are performed by remote-processing devices that are linked through a communications network.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in the appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. Term “connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. Use of term “set” (e.g., “a set of items”) or “subset,” unless otherwise noted or contradicted by context, is to be construed as a nonempty collection comprising one or more members. Further, unless otherwise noted or contradicted by context, term “subset” of a corresponding set does not necessarily denote a proper subset of corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in an illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B, and at least one of C each to be present. In addition, unless otherwise noted or contradicted by context, term “plurality” indicates a state of being plural (e.g., “a plurality of items” indicates multiple items). A plurality is at least two items, but can be more when so indicated either explicitly or by context. Further, unless stated otherwise or otherwise clear from context, phrase “based on” means “based at least in part on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. A set of non-transitory computer-readable storage media, in at least one embodiment, comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that allow performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

Unless specifically stated otherwise, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, term “processor” may refer to any device or portion of a device that processes electronic data from registers and/or memory and transform that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. Terms “system” and “method” are used herein interchangeably as far as system may embody one or more methods and methods may be considered a system.

In the present document, references may be made to obtaining, acquiring, receiving, or inputting analog or digital data into a subsystem, computer system, or computer-implemented machine. Obtaining, acquiring, receiving, or inputting analog and digital data can be accomplished in a variety of ways such as by receiving data as a parameter of a function call or a call to an application programming interface. In some implementations, process of obtaining, acquiring, receiving, or inputting analog or digital data can be accomplished by transferring data via a serial or parallel interface. In another implementation, process of obtaining, acquiring, receiving, or inputting analog or digital data can be accomplished by transferring data via a computer network from providing entity to acquiring entity. References may also be made to providing, outputting, transmitting, sending, or presenting analog or digital data. In various examples, process of providing, outputting, transmitting, sending, or presenting analog or digital data can be accomplished by transferring data as an input or output parameter of a function call, a parameter of an application programming interface or interprocess communication mechanism.

Although the discussion above sets forth example implementations of described techniques, other architectures may be used to implement described functionality, and are intended to be within scope of this disclosure. Furthermore, although specific distributions of responsibilities are defined above for purposes of discussion, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims. The subject matter of the present disclosure is described with specificity herein to meet statutory requirements. However, the description itself is not intended to limit the scope of this disclosure. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

### Example Literal Support

The disclosure of this application also includes the following numbered clauses:
Clause 1. One or more processors comprising processing circuitry to generate, for at least one supported pattern of one or more supported patterns of triangles, a representation of one or more optimized memory block layouts indicating a partitioning of the triangles in the at least one supported pattern into corresponding memory blocks.
Clause 2. The one or more processors of clause 1, wherein the processing circuitry is further to associate the representation of the one or more optimized memory block layouts with hardware interface software associated with one or more parallel processors.
Clause 3. The one or more processors of clause 1 or 2, wherein the processing circuitry is further to embed the representation of the one or more optimized memory block layouts into driver code as static data.
Clause 4. The one or more processors of clause 1 or 2, wherein the one or more supported patterns of triangles comprise at least one of one or more regular grids or one or more irregular meshes.
Clause 5. The one or more processors of clause 1 or 2, wherein the representation of the one or more optimized memory block layouts indicates a partitioning of the triangles of the at least one supported pattern into the corresponding memory blocks based at least on one or more lists of vertex indices.
Clause 6. The one or more processors of clause 1 or 2, wherein the representation of the one or more optimized memory block layouts indicates a partitioning of the triangles of the at least one supported pattern into the corresponding memory blocks based at least on one or more lists of divisions referencing one or more lists of vertex indices.
Clause 7. The one or more processors of clause 1 or 2, wherein the processing circuitry is further to evaluate one or more candidate memory block layouts of the triangles of the at least one supported pattern based on at least one of i) minimizing a number of memory blocks used, or ii) averaging areas of bounding boxes of candidate triangle block patterns rotated to a plurality of angles.
Clause 8. The one or more processors of clause 1 or 2, wherein the processing circuitry is further to generate the one or more optimized memory block layouts based at least on sequentially filling up triangle blocks using a triangle ordering that prioritizes spatial coherence of the triangles.
Clause 9. The one or more processors of clause 1 or 2, wherein the processing circuitry is further to generate the one or more optimized memory block layouts based at least on tiling one or more regular grids with one or more designated triangle block shapes based on at least one of symmetry or tessellation.
Clause 10. The one or more processors of clause 1 or 2, wherein the processing circuitry is further to generate the one or more optimized memory block layouts based at least on tiling one or more irregular meshes.
Clause 11. The one or more processors of clause 1 or 2, wherein the processing circuitry is further to generate the one or more optimized memory block layouts based at least on adjusting at least one of one or more triangle assignments or one or more triangle block boundaries from one or more previously generated memory block layouts.
Clause 12. The one or more processors of clause 1 or 2, wherein one or more optimized memory block layouts for at least a first supported pattern of the triangles comprise an optimized memory block layout for each of a plurality of supported levels of compression of vertex positions.
Clause 13. The one or more processors of clause 1 or 2, wherein the one or more parallel processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 14. A system comprising one or more processors to bundle, with hardware interface software associated with one or more parallel processors, a representation of one or more optimized memory block layouts for at least one supported pattern of one or more supported patterns of triangles, the one or more optimized memory block layouts identifying a grouping of the triangles of the at least one supported pattern into corresponding memory blocks.
Clause 15. The system of clause 14, wherein the one or more processors are further to embed the representation of the one or more optimized memory block layouts into driver code as static data.
Clause 16. The system of clause 14, wherein the representation of the one or more optimized memory block layouts indicates a partitioning of the triangles of the at least one supported pattern into the corresponding memory blocks based at least on one or more lists of vertex indices.
Clause 17. The system of clause 14, wherein the representation of the one or more optimized memory block layouts indicates a partitioning of the triangles of the at least one supported pattern into the corresponding memory blocks based at least on one or more lists of divisions referencing one or more lists of vertex indices.
Clause 18. The system of clause 14, wherein the one or more parallel processors are further to evaluate one or more candidate memory block layouts of the triangles of the at least one supported pattern based on at least one of i) minimizing a number of memory blocks used, or ii) averaging areas of bounding boxes of candidate triangle block patterns rotated to a plurality of angles.
Clause 19. The system of clause 14, wherein the one or more parallel processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 20. A method comprising packaging, with hardware interface software associated with one or more parallel processors, a representation of one or more optimized triangle block layouts for at least one supported pattern of one or more supported patterns of triangles, the one or more optimized triangle block layouts identifying a grouping of the triangles of the at least one supported pattern into corresponding memory blocks.
Clause 21. The method of clause 20, wherein the one or more parallel processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 22. One or more processors comprising processing circuitry to generate, for at least one supported pattern of one or more supported patterns of triangles, a representation of one or more optimized node assignments that partitions the triangles in the at least one supported pattern into corresponding nodes of a hierarchical tree structure.
Clause 23. The one or more processors of clause 22, wherein the processing circuitry is further to associate the representation of the one or more optimized node assignments with hardware interface software associated with one or more parallel processors.
Clause 24. The one or more processors of clause 22 or 23, wherein the processing circuitry is further to embed the representation of the one or more optimized node assignments into driver code as static data.
Clause 25. The one or more processors of clause 22 or 23, wherein the one or more supported patterns of triangles comprise at least one of one or more regular grids or one or more irregular meshes.
Clause 26. The one or more processors of clause 22 or 23, wherein the representation of the one or more optimized node assignments partitions the triangles of the at least one supported pattern into the corresponding nodes of the hierarchical tree structure based at least on one or more lists of vertex indices.
Clause 27. The one or more processors of clause 22 or 23, wherein the representation of the one or more optimized node assignments indicates a partitioning of the triangles of the at least one supported pattern into the corresponding nodes of the hierarchical tree structure based at least on one or more lists of divisions referencing one or more lists of vertex indices.
Clause 28. The one or more processors of clause 22 or 23, wherein the processing circuitry is further to evaluate one or more candidate node assignments of the triangles in the at least one supported pattern based on an estimated time cost of traversal.
Clause 29. The one or more processors of clause 22 or 23, wherein the processing circuitry is further to generate the one or more optimized node assignments based at least on a comparison of an amount of memory blocks used by at least one optimized memory block layout to an amount of available nodes in the hierarchical tree structure.
Clause 30. The one or more processors of clause 22 or 23, wherein the processing circuitry is further to generate the one or more optimized node assignments based at least on assigning one memory block per node and splitting at least one memory block across multiple nodes based at least on an estimated time cost of traversal.
Clause 31. The one or more processors of clause 22 or 23, wherein the processing circuitry is further to generate at least one of the one or more optimized node assignments assigning one memory block per node based at least on a determination that an amount of memory blocks used by at least one corresponding optimized memory block layout equals an amount of available nodes in the hierarchical tree structure.
Clause 32. The one or more processors of clause 22 or 23, wherein the processing circuitry is further to generate the one or more optimized node assignments based at least on evaluating one or more candidate range assignments that divide an ordered list of memory blocks into available nodes of the hierarchical tree structure.
Clause 33. The one or more processors of clause 22 or 23, wherein one or more optimized node assignments for at least a first supported pattern of the triangles comprise an optimized node assignment for each of a plurality of supported levels of compression of vertex positions.
Clause 34. The one or more processors of clause 22 or 23, wherein the one or more parallel processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 35. A system comprising one or more processors to bundle, with hardware interface software associated with one or more parallel processors, a representation of one or more optimized node assignments for at least one supported pattern of one or more supported patterns of triangles, the one or more optimized node assignments identifying a grouping of the triangles of the at least one supported pattern into corresponding nodes of a hierarchical tree structure.
Clause 36. The system of clause 35, wherein the one or more processors are further to embed the representation of the one or more optimized node assignments into driver code as static data.
Clause 37. The system of clause 35, wherein the one or more supported patterns of triangles comprise at least one of one or more regular grids or one or more irregular meshes.
Clause 38. The system of clause 35, wherein the representation of the one or more optimized node assignments indicates a partitioning of the triangles of the at least one supported pattern into the corresponding nodes of the hierarchical tree structure based at least on one or more lists of vertex indices.
Clause 39. The system of clause 35, wherein the representation of the one or more optimized node assignments indicates a partitioning of the triangles of the at least one supported pattern into the corresponding nodes of the hierarchical tree structure based at least on one or more lists of divisions referencing one or more lists of vertex indices.
Clause 40. The system of clause 35, wherein the one or more parallel processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 41. A method comprising packaging, with hardware interface software associated with one or more parallel processors, a representation of one or more optimized range assignments for at least one supported pattern of one or more supported patterns of triangles, the one or more optimized range assignments identifying a grouping of the triangles of the at least one supported pattern into corresponding ranges of a hierarchical tree structure.
Clause 42. The method of clause 41, wherein the one or more parallel processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 43. One or more processors comprising processing circuitry to identify, based at least on tessellation, one or more clusters of triangles in a three-dimensional (3D) scene.
Clause 44. The one or more processors of clause 43, wherein the processing circuitry is further to generate one or more hierarchical tree structures representing at least a portion of the 3D scene based at least on one or more precomputed acceleration structures associated with the one or more clusters of triangles.
Clause 45. The one or more processors of clause 43 or 44, wherein the processing circuitry is further to render one or more frames based at least on the one or more hierarchical tree structures.
Clause 46. The one or more processors of clause 43, 44 or 45, wherein the one or more precomputed acceleration structures represent one or more optimized memory block layouts indicating a partition of the one or more supported triangle patterns into corresponding memory blocks.
Clause 47. The one or more processors of clause 43, 44 or 45, wherein the one or more precomputed acceleration structures represent one or more optimized node assignments indicating the partition of the one or more supported triangle patterns into corresponding nodes of at least a portion of one or more hierarchical tree structures.
Clause 48. The one or more processors of clause 43, 44 or 45, wherein the one or more clusters identified based at least on the tessellation correspond to one or more supported triangle patterns associated with the one or more precomputed acceleration structures.
Clause 49. The one or more processors of clause 43, 44 or 45, wherein the processing circuitry is further to look up, based at least on identifying one or more supported triangle patterns represented by the one or more clusters of triangles, one or more cluster templates comprising the one or more precomputed acceleration structures.
Clause 50. The one or more processors of clause 43, 44 or 45, wherein the processing circuitry is further to copy the one or more precomputed acceleration structures representing one or more precomputed memory block layouts into allocated memory for the one or more clusters, and to copy one or more vertex positions of the one or more clusters into the one or more precomputed memory block layouts.
Clause 51. The one or more processors of clause 43, 44 or 45, wherein the processing circuitry is to copy, into allocated memory for the one or more clusters, the one or more precomputed acceleration structures representing one or more precomputed node assignments that indicate a partitioning of the triangles of the one or more clusters into one or more leaf nodes in the one or more hierarchical tree structures.
Clause 52. The one or more processors of clause 43, 44 or 45, wherein the processing circuitry is further to write one or more parent nodes in the one or more hierarchical tree structures over the triangles assigned to one or more leaf nodes based at least on one or more precomputed node assignments represented by the one or more precomputed acceleration structures.
Clause 53. The one or more processors of clause 43, 44 or 45, wherein the processing circuitry is further to write one or more parent nodes in the one or more hierarchical tree structures based at least on one or more precomputed lists of vertex indices associated with the triangles assigned to one or more leaf nodes.
Clause 54. The one or more processors of clause 43, 44 or 45, wherein the processing circuitry is further to build one or more hierarchical sub-tree structures over the one or more clusters of triangles using one or more corresponding cluster templates represented by the one or more precomputed acceleration structures, and to build the one or more hierarchical tree structures over the one or more hierarchical sub-tree structures.
Clause 55. The one or more processors of clause 43, 44 or 45, wherein the one or more hierarchical tree structures comprise at least one of one or more bottom-level acceleration structures representing one or more object meshes in the 3D scene or one or more top-level acceleration structures representing the 3D scene.
Clause 56. The one or more processors of clause 43, 44 or 45, wherein the one or more one or more precomputed acceleration structures are embedded as static data in hardware interface software associated with the one or more processors.
Clause 57. The one or more processors of clause 43, 44 or 45, wherein the one or more processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 58. A system comprising one or more parallel processors to generate one or more hierarchical tree structures representing at least a portion of a three-dimensional (3D) scene based at least on one or more precomputed acceleration structures associated with one or more supported triangle patterns of one or more clusters of triangles in the 3D scene.
Clause 59. The system of clause 58, wherein the one or more precomputed acceleration structures represent one or more optimized memory block layouts indicating a partitioning of the one or more supported triangle patterns into corresponding memory blocks.
Clause 60. The system of clause 58, wherein the one or more precomputed acceleration structures represent one or more optimized node assignments indicating a partitioning of the one or more supported triangle patterns into corresponding nodes of at least a portion of one or more hierarchical tree structures.
Clause 61. The system of clause 58, wherein the one or more parallel processors are further to look up, based at least on identifying the one or more supported triangle patterns of the one or more clusters of triangles, one or more cluster templates comprising the one or more precomputed acceleration structures.
Clause 62. The system of clause 58, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 63. A method comprising building one or more hierarchical tree structures over at least a portion of a three-dimensional (3D) scene based at least on one or more precomputed acceleration structures associated with one or more supported triangle patterns of one or more clusters of triangles in the 3D scene.
Clause 64. The method of clause 63, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 65. One or more parallel processors comprising processing circuitry to identify, based at least on one or more compression levels of one or more clusters of triangles in a three-dimensional (3D) scene, one or more precomputed memory block layouts associated with one or more supported triangle patterns represented by the one or more clusters.
Clause 66. The one or more parallel processors of clause 65, wherein the processing circuitry is further to generate one or more hierarchical tree structures representing at least a portion of the 3D scene based at least on the one or more precomputed memory block layouts.
Clause 67. The one or more parallel processors of clause 65 or 66, wherein the processing circuitry is further to render one or more frames based at least on the one or more hierarchical tree structures.
Clause 68. The one or more parallel processors of clause 65, 66 or 67, wherein the processing circuitry is further to receive specification of at least one of the one or more compression levels of the one or more clusters of triangles via an application programming interface (API) call.
Clause 69. The one or more parallel processors of clause 65, 66 or 67, wherein the processing circuitry is further to determine at least one of the one or more compression levels based at least on examining positions of vertices in the one or more clusters of triangles.
Clause 70. The one or more parallel processors of clause 65, 66 or 67, wherein the processing circuitry is further to determine at least one of the one or more compression levels based at least on identifying a number of unique bits used in the one or more clusters of triangles.
Clause 71. The one or more parallel processors of clause 65, 66 or 67, wherein the processing circuitry is further to look up the one or more precomputed memory block layouts based at least on one or more identifiers of the one or more supported triangle patterns and the one or more compression levels associated with the one or more clusters.
Clause 72. The one or more parallel processors of clause 65, 66 or 67, wherein the one or more precomputed memory block layouts associated with the one or more supported triangle patterns comprise multiple precomputed memory block layouts indexed based at least on a representation of level of compression.
Clause 73. The one or more parallel processors of clause 65, 66 or 67, wherein the processing circuitry is further to identify the one or more precomputed memory block layouts associated with the one or more supported triangle patterns based at least on identifying which of a plurality of precomputed memory blocks are the one or more most compressed layouts the one or more clusters would fit into.
Clause 74. The one or more parallel processors of clause 65, 66 or 67, wherein the processing circuitry is further to identify the one or more precomputed memory block layouts associated with the one or more supported triangle patterns based at least on sequentially testing successively more compressed precomputed memory block layouts.
Clause 75. The one or more parallel processors of clause 65, 66 or 67, wherein the processing circuitry is further to copy the one or more precomputed memory block layouts into allocated memory for the one or more clusters, and to copy one or more vertex positions of the one or more clusters into the one or more precomputed memory block layouts.
Clause 76. The one or more parallel processors of clause 65, 66 or 67, wherein the processing circuitry is further to copy the one or more precomputed memory block layouts into allocated memory for the one or more clusters, and to transcode one or more vertex positions of the one or more clusters into the one or more precomputed memory block layouts based at least on one or more corresponding compression levels of the one or more compression levels.
Clause 77. The one or more parallel processors of clause 65, 66 or 67, wherein the processing circuitry is further to copy the one or more precomputed memory block layouts into allocated memory for the one or more clusters, and to transcode one or more vertex positions of the one or more clusters into the one or more precomputed memory block layouts based at least on discarding one or more non-unique bits identified from the one or more clusters.
Clause 78. The one or more parallel processors of clause 65, 66 or 67, wherein the one or more parallel processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 79. A system comprising one or more parallel processors to generate one or more hierarchical tree structures representing at least a portion of a three-dimensional (3D) scene based at least on one or more precomputed memory block layouts that indicate a grouping of one or more supported patterns of triangles into corresponding memory blocks using one or more compression levels.
Clause 80. The system of clause 79, wherein the one or more parallel processors are further to receive specification of at least one of the one or more compression levels of one or more clusters of triangles associated with the one or more supported patterns of triangles via an application programming interface (API) call.
Clause 81. The system of clause 79, wherein the one or more parallel processors are further to determine at least one of the one or more compression levels based at least on examining positions of vertices in one or more clusters of triangles associated with the one or more supported patterns of triangles.
Clause 82. The system of clause 79, wherein the one or more parallel processors are further to determine at least one of the one or more compression levels based at least on identifying a number of unique bits used in one or more clusters of triangles associated with the one or more supported patterns of triangles.
Clause 83. The system of clause 79, wherein the one or more parallel processors are further to look up the one or more precomputed memory block layouts based at least on one or more identifiers of the one or more supported patterns of triangles and the one or more compression levels associated with one or more clusters of triangles corresponding to the one or more supported patterns of triangles.
Clause 84. The system of clause 79, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 85. A method comprising building one or more hierarchical tree structures over at least a portion of a three-dimensional (3D) scene based at least on one or more precomputed memory block layouts that indicate a grouping of one or more supported patterns of triangles into corresponding memory blocks using one or more compression levels.
Clause 86. The method of clause 85, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 87. One or more parallel processors comprising processing circuitry to return, based at least on one or more first application programming interface (API) calls that identify one or more supported patterns of one or more clusters of triangles in a three-dimensional (3D) scene, one or more identifiers of one or more precomputed cluster templates associated with the one or more supported patterns.
Clause 88. The one or more parallel processors of clause 87, wherein the processing circuitry is further to generate, based at least on one or more second API calls that identify vertex data of the one or more clusters and the one or more identifiers of the one or more precomputed cluster templates, one or more hierarchical tree structures representing at least a portion of the 3D scene based at least on the one or more precomputed cluster templates.
Clause 89. The one or more parallel processors of clause 87 or 88, wherein the processing circuitry is further to render one or more frames based at least on the one or more hierarchical tree structures.
Clause 90. The one or parallel more processors of clause 87, 88 or 89, wherein the one or more first API calls identify the one or more supported patterns of one or more clusters of triangles based on at least one of one or more corresponding identifiers of the one or more supported patterns or one or more corresponding tags describing the one or more supported patterns.
Clause 91. The one or more parallel processors of clause 87, 88 or 89, wherein the processing circuitry is further to return, based at least on the one or more first API calls, a representation of an amount of memory associated with storing the one or more supported patterns of the one or more clusters of triangles.
Clause 92. The one or more parallel processors of clause 87, 88 or 89, wherein the processing circuitry is further to return, based at least on the one or more first API calls, a representation of a maximum amount of memory associated with using the one or more precomputed cluster templates corresponding to at least one of the one or more supported patterns of the one or more clusters of triangles.
Clause 93. The one or more parallel processors of clause 87, 88 or 89, wherein the processing circuitry is further to return, based at least on the one or more first API calls identifying a compression level for at least one cluster of the one or more clusters, a representation of an amount of memory associated with using a corresponding one of the one or more precomputed cluster templates associated with the compression level.
Clause 94. The one or more parallel processors of clause 87, 88 or 89, wherein the processing circuitry is further to return, based at least on the one or more first API calls identifying a bounding box for at least one cluster of the one or more clusters, a representation of an amount of memory associated with using a corresponding one of the one or more precomputed cluster templates associated with a minimum compression level determined based at least on the bounding box.
Clause 95. The one or more parallel processors of clause 87, 88 or 89, wherein the one or more second API calls further identify one or more locations of allocated memory sized based at least on a representation of an amount of memory that is associated with storing the one or more supported patterns of the one or more clusters of triangles and was returned in response to the one or more first API calls.
Clause 96. The one or more parallel processors of clause 87, 88 or 89, wherein the processing circuitry is further to look up, based at least on the one or more second API calls identifying a compression level for at least one cluster of the one or more clusters, a corresponding one of the one or more precomputed cluster templates associated with the compression level.
Clause 97. The one or more parallel processors of clause 87, 88 or 89, wherein the processing circuitry is further to build one or more hierarchical sub-tree structures over the one or more clusters of triangles using the one or more precomputed cluster templates, and to build the one or more hierarchical tree structures over the one or more hierarchical sub-tree structures.
Clause 98. The one or more parallel processors of clause 87, 88 or 89, wherein the one or more hierarchical tree structures comprise at least one of one or more bottom-level acceleration structures representing one or more object meshes in the 3D scene or one or more top-level acceleration structures representing the 3D scene.
Clause 99. The one or more parallel processors of clause 87, 88 or 89, wherein the processing circuitry is further to receive at least one of the one or more first API calls or the one or more second API calls via an API of hardware interface software associated with the one or more parallel processors.
Clause 100. The one or more parallel processors of clause 87, 88 or 89, wherein the one or more parallel processors are comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 101. A system comprising one or more parallel processors to generate, based at least on one or more application programming interface (API) calls that identify one or more supported triangle patterns of one or more clusters of triangles in a three-dimensional (3D) scene, one or more hierarchical tree structures representing at least a portion of the 3D scene based at least on one or more precomputed cluster templates associated with the one or more supported triangle patterns.
Clause 102. The system of clause 101, wherein the one or more API calls include a first type of API call that identifies the one or more supported triangle patterns and returns one or more identifiers of the one or more precomputed cluster templates associated with the one or more supported triangle patterns.
Clause 103. The system of clause 101, wherein the one or more API calls include a second type of API call that associates one or more identifiers of the one or more precomputed cluster templates with corresponding vertex data of the one or more clusters of triangles.
Clause 104. The system of clause 101, wherein the one or more API calls identify the one or more supported triangle patterns based on at least one of one or more corresponding identifiers of the one or more supported triangle patterns or one or more corresponding tags describing the one or more supported triangle patterns.
Clause 105. The system of clause 101, wherein the one or more parallel processors are further to return, based at least on the one or more API calls, a representation of an amount of memory associated with storing the one or more supported triangle patterns of the one or more clusters of triangles.
Clause 106. The system of clause 101, wherein the system is comprised in at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).
Clause 107. A method comprising building, based at least on one or more application programming interface (API) calls that identify one or more supported triangle patterns of one or more clusters of triangles in a three-dimensional (3D) scene, one or more hierarchical tree structures over least a portion of the 3D scene based at least on one or more precomputed cluster templates associated with the one or more supported triangle patterns.
Clause 108. The method of clause 107, wherein the method is performed by at least one of: a control system for an autonomous or semi-autonomous machine; a perception system for an autonomous or semi-autonomous machine; a system for performing simulation operations; a system for performing digital twin operations; a system for performing light transport simulation; a system for performing collaborative content creation for 3D assets; a system for performing deep learning operations; a system for performing remote operations; a system for performing real-time streaming; a system for generating or presenting one or more of augmented reality content, virtual reality content, or mixed reality content; a system implemented using an edge device; a system implemented using a robot; a system for performing conversational AI operations; a system implementing one or more language models; a system implementing one or more large language models (LLMs); a system implementing one or more vision language models (VLMs); a system implementing one or more multi-modal language models; a system for generating synthetic data; a system for generating synthetic data using AI; a system for performing one or more generative AI operations; a system incorporating one or more virtual machines (VMs); a system implemented at least partially in a data center; a system implemented at least partially using cloud computing resources; a system using or deploying one or more inference microservices; a system that incorporates one or more machine learning models deployed in a service or microservice along with an OS-level virtualization package (e.g., a container).

What is claimed is:

1. One or more parallel processors comprising processing circuitry to:
identify, based at least on one or more compression levels of one or more clusters of triangles in a three-dimensional (3D) scene, one or more precomputed memory block layouts associated with one or more supported triangle patterns represented by the one or more clusters;
generate one or more hierarchical tree structures representing at least a portion of the 3D scene based at least on the one or more precomputed memory block layouts; and
render one or more frames based at least on the one or more hierarchical tree structures.

2. The one or more parallel processors of claim 1, wherein the processing circuitry is further to receive specification of at least one of the one or more compression levels of the one or more clusters of triangles via an application programming interface (API) call.

3. The one or more parallel processors of claim 1, wherein the processing circuitry is further to determine at least one of the one or more compression levels based at least on examining positions of vertices in the one or more clusters of triangles.

4. The one or more parallel processors of claim 1, wherein the processing circuitry is further to determine at least one of the one or more compression levels based at least on identifying a number of unique bits used in the one or more clusters of triangles.

5. The one or more parallel processors of claim 1, wherein the processing circuitry is further to look up the one or more precomputed memory block layouts based at least on one or more identifiers of the one or more supported triangle patterns and the one or more compression levels associated with the one or more clusters.

6. The one or more parallel processors of claim 1, wherein the one or more precomputed memory block layouts associated with the one or more supported triangle patterns comprise multiple precomputed memory block layouts indexed based at least on a representation of level of compression.

7. The one or more parallel processors of claim 1, wherein the processing circuitry is further to identify the one or more precomputed memory block layouts associated with the one or more supported triangle patterns based at least on identifying which of a plurality of precomputed memory blocks are the one or more most compressed layouts the one or more clusters would fit into.

8. The one or more parallel processors of claim 1, wherein the processing circuitry is further to identify the one or more precomputed memory block layouts associated with the one or more supported triangle patterns based at least on sequentially testing successively more compressed precomputed memory block layouts.

9. The one or more parallel processors of claim 1, wherein the processing circuitry is further to copy the one or more precomputed memory block layouts into allocated memory for the one or more clusters, and to copy one or more vertex positions of the one or more clusters into the one or more precomputed memory block layouts.

10. The one or more parallel processors of claim 1, wherein the processing circuitry is further to copy the one or more precomputed memory block layouts into allocated memory for the one or more clusters, and to transcode one or more vertex positions of the one or more clusters into the one or more precomputed memory block layouts based at least on one or more corresponding compression levels of the one or more compression levels.

11. The one or more parallel processors of claim 1, wherein the processing circuitry is further to copy the one or more precomputed memory block layouts into allocated memory for the one or more clusters, and to transcode one or more vertex positions of the one or more clusters into the one or more precomputed memory block layouts based at least on discarding one or more non-unique bits identified from the one or more clusters.

12. The one or more parallel processors of claim 1, wherein the one or more parallel processors are comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices;
a system that incorporates one or more machine learning models deployed in a service or microservice along with an OS-level virtualization package (e.g., a container).

13. A system comprising one or more parallel processors to generate one or more hierarchical tree structures representing at least a portion of a three-dimensional (3D) scene based at least on one or more precomputed memory block layouts that indicate a grouping of one or more supported patterns of triangles into corresponding memory blocks using one or more compression levels.

14. The system of claim 13, wherein the one or more parallel processors are further to receive specification of at least one of the one or more compression levels of one or more clusters of triangles associated with the one or more supported patterns of triangles via an application programming interface (API) call.

15. The system of claim 13, wherein the one or more parallel processors are further to determine at least one of the one or more compression levels based at least on examining positions of vertices in one or more clusters of triangles associated with the one or more supported patterns of triangles.

16. The system of claim 13, wherein the one or more parallel processors are further to determine at least one of the one or more compression levels based at least on identifying a number of unique bits used in one or more clusters of triangles associated with the one or more supported patterns of triangles.

17. The system of claim 13, wherein the one or more parallel processors are further to look up the one or more precomputed memory block layouts based at least on one or more identifiers of the one or more supported patterns of triangles and the one or more compression levels associated with one or more clusters of triangles corresponding to the one or more supported patterns of triangles.

18. The system of claim 13, wherein the system is comprised in at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices;
a system that incorporates one or more machine learning models deployed in a service or microservice along with an OS-level virtualization package (e.g., a container).

19. A method comprising:
building one or more hierarchical tree structures over at least a portion of a three-dimensional (3D) scene based at least on one or more precomputed memory block layouts that indicate a grouping of one or more supported patterns of triangles into corresponding memory blocks using one or more compression levels.

20. The method of claim 19, wherein the method is performed by at least one of:
a control system for an autonomous or semi-autonomous machine;
a perception system for an autonomous or semi-autonomous machine;
a system for performing simulation operations;
a system for performing digital twin operations;
a system for performing light transport simulation;
a system for performing collaborative content creation for 3D assets;
a system for performing deep learning operations;
a system for performing remote operations;
a system for performing real-time streaming;
a system for generating or presenting one or more of augmented reality content, virtual reality content, or mixed reality content;
a system implemented using an edge device;
a system implemented using a robot;
a system for performing conversational AI operations;
a system implementing one or more language models;
a system implementing one or more large language models (LLMs);
a system implementing one or more vision language models (VLMs);
a system implementing one or more multi-modal language models;
a system for generating synthetic data;
a system for generating synthetic data using AI;
a system for performing one or more generative AI operations;
a system incorporating one or more virtual machines (VMs);
a system implemented at least partially in a data center;
a system implemented at least partially using cloud computing resources;
a system using or deploying one or more inference microservices;
a system that incorporates one or more machine learning models deployed in a service or microservice along with an OS-level virtualization package (e.g., a container).
